(19) United States
(12) Patent Application Publication
(10) Pub. No.: US 2024/0282320 A1
(43) Pub. Date: Aug. 22, 2024

(54) SPACING-BASED AUDIO SOURCE GROUP PROCESSING

(71) Applicant: QUALCOMM Incorporated, San Diego, CA (US)

(72) Inventor: Isaac Garcia MUNOZ, San Diego, CA (US)

(21) Appl. No.: 18/583,311

(22) Filed: Feb. 21, 2024

Related U.S. Application Data
(60) Provisional application No. 63/486,294, filed on Feb. 22, 2023.

(51) Int. Cl. G10L 19/008; G10L 19/002

(52) U.S. Cl. CPC G10L 19/008; G10L 19/002

(57) ABSTRACT

A device includes one or more processors configured, during an audio decoding operation, to obtain a set of audio streams associated with a set of audio sources. The one or more processors are also configured to obtain group assignment information indicating that particular audio sources in the set of audio sources are assigned to a particular audio source group. The particular audio source group is associated with a source spacing condition. The one or more processors are further configured to render, based on a rendering mode assigned to the particular audio source group, particular audio streams that are associated with the particular audio sources.

### I. Cross-Reference to Related Applications

The present application claims priority from Provisional Patent Application No. 63/486,294 filed Feb. 22, 2023, entitled “SPACING-BASED AUDIO SOURCE GROUP PROCESSING,” the content of which is incorporated herein by reference in its entirety.

### II. FIELD

The present disclosure is generally related to processing spatial audio from multiple sources.

### III. Description of Related Art

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

One application of such devices includes providing wireless immersive audio to a user. As an example, a headphone device worn by a user can receive streaming audio data from a remote server for playback to the user. Conventional multi-source spatial audio systems are often designed to use a relatively high complexity rendering of audio streams from multiple audio sources with the goal of ensuring that a worst-case performance of the headphone device still results in an acceptable quality of the immersive audio that is provided to the user. However, the use of a single rendering mode for all rendered audio streams, independently of the positions of the audio sources, can result in inefficiencies due to the use of high-complexity audio processing for arrangements of audio sources in which lower-complexity processing could instead be used without perceptibly affecting (or with acceptably minor effect on) the quality of the resulting audio output.

### IV. Summary

According to one implementation of the present disclosure, a device includes one or more processors configured, during an audio decoding operation, to obtain a set of audio streams associated with a set of audio sources. The one or more processors are also configured to obtain group assignment information indicating that particular audio sources in the set of audio sources are assigned to a particular audio source group. The particular audio source group is associated with a source spacing condition. The one or more processors are further configured to render, based on a rendering mode assigned to the particular audio source group, particular audio streams that are associated with the particular audio sources.

According to another implementation of the present disclosure, a method includes, during an audio decoding operation, obtaining, at a device, a set of audio streams associated with a set of audio sources. The method also includes obtaining, at the device, group assignment information indicating that particular audio sources in the set of audio sources are assigned to a particular audio source group. The particular audio source group is associated with a source spacing condition. The method further includes rendering, based on a rendering mode assigned to the particular audio source group, particular audio streams that are associated with the particular audio sources.

According to another implementation of the present disclosure, a non-transitory computer-readable medium stores instructions that, when executed by one or more processors, cause the one or more processors to, during an audio decoding operation, obtain a set of audio streams associated with a set of audio sources. The instructions, when executed by the one or more processors, also cause the one or more processors to obtain group assignment information indicating that particular audio sources in the set of audio sources are assigned to a particular audio source group. The particular audio source group is associated with a source spacing condition. The instructions, when executed by the one or more processors, further cause the one or more processors to render, based on a rendering mode assigned to the particular audio source group, particular audio streams that are associated with the particular audio sources.

According to another implementation of the present disclosure, an apparatus includes means for obtaining a set of audio streams associated with a set of audio sources. The apparatus also includes means for obtaining group assignment information indicating that particular audio sources in the set of audio sources are assigned to a particular audio source group. The particular audio source group is associated with a source spacing condition. The apparatus further includes means for rendering, based on a rendering mode assigned to the particular audio source group, particular audio streams that are associated with the particular audio sources.

According to another implementation of the present disclosure, a device includes one or more processors configured, during an audio encoding operation, to obtain a set of audio streams associated with a set of audio sources. The one or more processors are also configured to obtain group assignment information indicating that particular audio sources in the set of audio sources are assigned to a particular audio source group. The particular audio source group is associated with a source spacing condition. The one or more processors are further configured to generate output data that includes the group assignment information and an encoded version of the set of audio streams.

According to another implementation of the present disclosure, a method includes, during an audio encoding operation, obtaining, at a device, a set of audio streams associated with a set of audio sources. The method also includes obtaining, at the device, group assignment information indicating that particular audio sources in the set of audio sources are assigned to a particular audio source group. The particular audio source group is associated with a source spacing condition. The method further includes generating, at the device, output data that includes the group assignment information and an encoded version of the set of audio streams.

According to another implementation of the present disclosure, a non-transitory computer-readable medium stores instructions that, when executed by one or more processors, cause the one or more processors to, during an audio encoding operation, obtain a set of audio streams associated with a set of audio sources. The instructions, when executed by the one or more processors, also cause the one or more processors to obtain group assignment information indicating that particular audio sources in the set of audio sources are assigned to a particular audio source group. The particular audio source group is associated with a source spacing condition. The instructions, when executed by the one or more processors, further cause the one or more processors to generate output data that includes the group assignment information and an encoded version of the set of audio streams.

According to another implementation of the present disclosure, an apparatus includes means for obtaining a set of audio streams associated with a set of audio sources. The apparatus also includes means for obtaining group assignment information indicating that particular audio sources in the set of audio sources are assigned to a particular audio source group. The particular audio source group is associated with a source spacing condition. The apparatus further includes means for generating output data that includes the group assignment information and an encoded version of the set of audio streams.

Other implementations, advantages, and features of the present disclosure will become apparent after review of the entire application, including the following sections: Brief Description of the Drawings, Detailed Description, and the Claims.

### V. Brief Description of the Drawings

FIG. 1 is a diagram illustrating an example of an implementation of a system for performing spacing-based audio source group processing, in accordance with some examples of the present disclosure.

FIG. 2A is a diagram illustrating an example of an implementation of a system for performing spacing-based audio source group processing, in accordance with some examples of the present disclosure.

FIG. 2B is a diagram illustrating an example of an implementation of a system for performing spacing-based audio source group processing, in accordance with some examples of the present disclosure.

FIG. 2C is a diagram illustrating an example of an implementation of a system for performing spacing-based audio source group processing, in accordance with some examples of the present disclosure.

FIG. 2D is a diagram illustrating an example of an implementation of a system for performing spacing-based audio source group processing, in accordance with some examples of the present disclosure.

FIG. 3 is a block diagram illustrating an implementation of operations of a system for performing spacing-based audio source group processing, in accordance with some examples of the present disclosure.

FIG. 4 is a block diagram illustrating an implementation of operations of a system for performing spacing-based audio source group processing, in accordance with some examples of the present disclosure.

FIG. 5 is a block diagram of an illustrative aspect of components of a device operable to perform spacing-based audio source group processing, in accordance with some examples of the present disclosure.

FIG. 6 is a block diagram of an illustrative aspect of components of a device operable to perform spacing-based audio source group processing including time domain interpolation, in accordance with some examples of the present disclosure.

FIG. 7 is a conceptual diagram illustrating an example of rendering that may be performed using the components of FIG. 6, in accordance with some examples of the present disclosure.

FIG. 8 is a block diagram of an illustrative aspect of components of a device operable to perform spacing-based audio source group processing, in accordance with some examples of the present disclosure.

FIG. 9 is a diagram of an illustrative aspect of spacing-based audio source group processing including generation of sub-groups of audio sources, in accordance with some examples of the present disclosure.

FIG. 10 is a diagram of an illustrative aspect of spacing-based audio source group processing including generation of sub-groups of audio sources, in accordance with some examples of the present disclosure.

FIG. 11 is a diagram of an illustrative aspect of spacing-based audio source group processing including generation of sub-groups of audio sources, in accordance with some examples of the present disclosure.

FIG. 12A is a diagram illustrating an example of an implementation of a system for performing spacing-based audio source group processing, in accordance with some examples of the present disclosure.

FIG. 12B is a diagram illustrating an example of an implementation of a system for performing spacing-based audio source group processing, in accordance with some examples of the present disclosure.

FIG. 12C is a diagram illustrating an example of an implementation of a system for performing spacing-based audio source group processing, in accordance with some examples of the present disclosure.

FIG. 13 is a block diagram of an illustrative aspect of components of a device operable to perform spacing-based audio source group processing, in accordance with some examples of the present disclosure.

FIG. 14 is a conceptual diagram illustrating example rendering modes, in accordance with some examples of the present disclosure.

FIG. 15 is a conceptual diagram illustrating example k-means clustering techniques, in accordance with some examples of the present disclosure.

FIG. 16 is a conceptual diagram illustrating example Voronoi distance clustering techniques, in accordance with some examples of the present disclosure.

FIG. 17 is a conceptual diagram illustrating example renderer control mode selection techniques, in accordance with some examples of the present disclosure.

FIG. 18 is a block diagram of an illustrative aspect of components of a device operable to perform spacing-based audio source group processing, in accordance with some examples of the present disclosure.

FIG. 19 is a block diagram of an illustrative aspect of components of a device operable to perform spacing-based audio source group processing, in accordance with some examples of the present disclosure.

FIG. 20 illustrates an example of an integrated circuit operable to perform spacing-based audio source group processing, in accordance with some examples of the present disclosure.

FIG. 21 is a diagram of earbuds operable to perform spacing-based audio source group processing, in accordance with some examples of the present disclosure.

FIG. 22 is a diagram of a headset operable to perform spacing-based audio source group processing, in accordance with some examples of the present disclosure.

FIG. 23 is a diagram of a headset, such as a virtual reality, mixed reality, or augmented reality headset, operable to perform spacing-based audio source group processing, in accordance with some examples of the present disclosure.

FIG. 24 is a diagram of a system including a mobile device operable to perform spacing-based audio source group processing, in accordance with some examples of the present disclosure.

FIG. 25 is a diagram of a system including a wearable electronic device operable to perform spacing-based audio source group processing, in accordance with some examples of the present disclosure.

FIG. 26 is a diagram of a voice-controlled speaker system operable to perform spacing-based audio source group processing, in accordance with some examples of the present disclosure.

FIG. 27 is a diagram of an example of a vehicle operable to perform spacing-based audio source group processing, in accordance with some examples of the present disclosure.

FIG. 28 is a diagram of a particular implementation of a method of spacing-based audio source group processing, in accordance with some examples of the present disclosure.

FIG. 29 is a diagram of a particular implementation of a method of spacing-based audio source group processing, in accordance with some examples of the present disclosure.

FIG. 30 is a block diagram of a particular illustrative example of a device that is operable to perform spacing-based audio source group processing, in accordance with some examples of the present disclosure.

### VI. Detailed Description

Systems and methods for performing spacing-based audio source group processing are described that provide the ability to switch between different rendering modes based on audio stream source positions. In conventional systems in which a single rendering mode is used for all rendered audio streams independently of the positions of the audio sources, inefficiencies can arise due to the use of high-complexity audio processing for arrangements of audio sources in which lower-complexity processing could instead be used with no perceptible effect (or an acceptably small perceptible effect) on the quality of the resulting audio output. By providing the ability to switch between different rendering modes based on audio stream source positions, the disclosed systems and methods enable reduced power consumption, reduced rendering latency, or both, associated with rendering an audio scene.

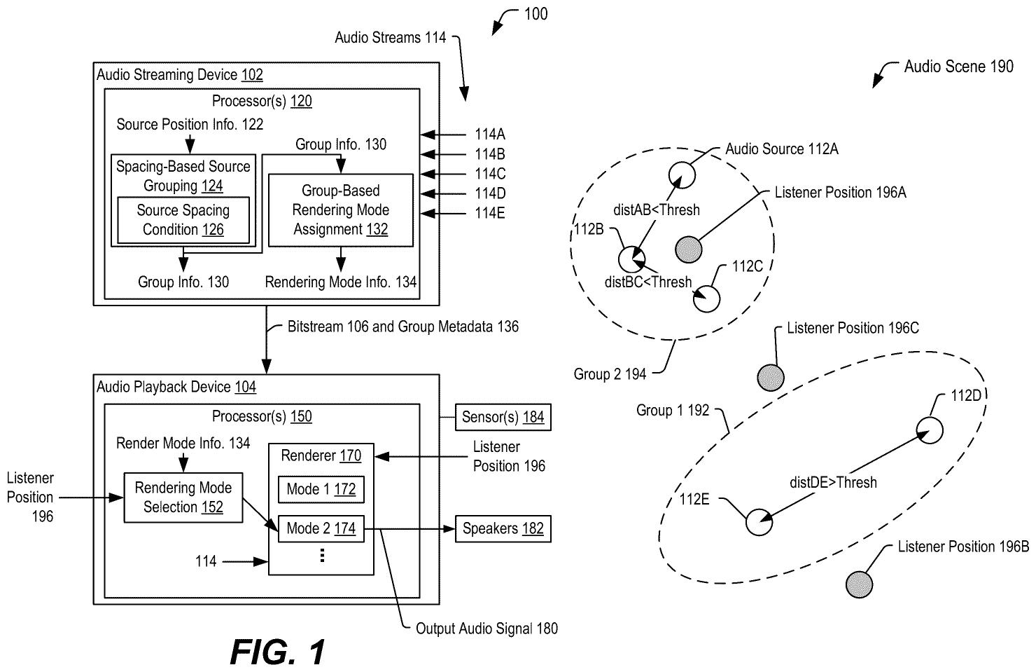

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts an audio streaming device 102 including one or more processors (“processor(s)” 120 of FIG. 1), which indicates that in some implementations the audio streaming device 102 includes a single processor 120 and in other implementations the audio streaming device 102 includes multiple processors 120. For ease of reference herein, such features are generally introduced as “one or more” features and are subsequently referred to in the singular unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple audio streams are illustrated and associated with reference numbers 114A, 114B, 114C, 114D, 114E, and 114F. When referring to a particular one of these audio streams, such as an audio stream 114A, the distinguishing letter “A” is used. However, when referring to any arbitrary one of these audio streams or to these audio streams as a group, the reference number 114 is used without a distinguishing letter.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

In general, techniques are described for coding of three dimensional (3D) sound data, such as ambisonics audio data. Ambisonics audio data may include different orders of ambisonic coefficients, e.g., first order or second order and more (which may be referred to as higher-order ambisonics (HOA) coefficients corresponding to a spherical harmonic basis function having an order greater than one). Ambisonics audio data may also include mixed order ambisonics (MOA). Thus, ambisonics audio data may include at least one ambisonic coefficient corresponding to a harmonic basis function.

The evolution of surround sound has made available many audio output formats for entertainment. Examples of such consumer surround sound formats are mostly ‘channel’ based in that they implicitly specify feeds to loudspeakers in certain geometrical coordinates. The consumer surround sound formats include the popular 5.1 format (which includes the following six channels: front left (FL), front right (FR), center or front center, back left or surround left, back right or surround right, and low frequency effects (LFE)), the growing 7.1 format, and various formats that include height speakers such as the 7.1.4 format and the 22.2 format (e.g., for use with the Ultra High Definition Television standard). Non-consumer formats can span any number of speakers (e.g., in symmetric and non-symmetric geometries) often termed ‘surround arrays.’ One example of such a sound array includes 32 loudspeakers positioned at coordinates on the corners of a truncated icosahedron.

The input to a future Moving Picture Experts Group (MPEG) encoder is optionally one of three possible formats: (i) traditional channel-based audio (as discussed above), which is meant to be played through loudspeakers at pre-specified positions; (ii) object-based audio, which involves discrete pulse-code-modulation (PCM) data for single audio objects with associated metadata containing their location coordinates (amongst other information); or (iii) scene-based audio, which involves representing the sound field using coefficients of spherical harmonic basis functions (also called “spherical harmonic coefficients” or SHC, “Higher-order Ambisonics” or HOA, and “HOA coefficients”). The future MPEG encoder may be described in more detail in a document entitled “Call for Proposals for 3D Audio,” by the International Organization for Standardization/International Electrotechnical Commission (ISO)/(IEC) JTC1/SC29/WG11/N13411, released January 2013 in Geneva, Switzerland, and available at http://mpeg.chiariglione.org/sites/default/files/files/standards/parts/docs/w13411.zip.

There are various ‘surround-sound’ channel-based formats currently available. The formats range, for example, from the 5.1 home theatre system (which has been the most successful in terms of making inroads into living rooms beyond stereo) to the 22.2 system developed by NHK (Nippon Hoso Kyokai or Japan Broadcasting Corporation). Content creators (e.g., Hollywood studios) would like to produce a soundtrack for a movie once, and not spend effort to remix it for each speaker configuration. Recently, Standards Developing Organizations have been considering ways in which to provide an encoding into a standardized bitstream and a subsequent decoding that is adaptable and agnostic to the speaker geometry (and number) and acoustic conditions at the location of the playback (involving a renderer).

To provide such flexibility for content creators, a hierarchical set of elements may be used to represent a sound field. The hierarchical set of elements may refer to a set of elements in which the elements are ordered such that a basic set of lower-ordered elements provides a full representation of the modeled sound field. As the set is extended to include higher-order elements, the representation becomes more detailed, increasing resolution.

One example of a hierarchical set of elements is a set of spherical harmonic coefficients (SHC). The following expression demonstrates a description or representation of a sound field using SHC:

$${p}_{i} ( t , {r}_{r} , {θ}_{r} , {φ}_{r} ) = {\sum }_{ω = 0}^{∞} [ 4 π {\sum }_{n = 0}^{∞} {j}_{n} ( k {r}_{r} ) {\sum }_{m = - n}^{n} {A}_{n}^{m} ( k ) {Y}_{n}^{m} ( {θ}_{r} , {φ}_{r} ) ] {e}^{j ω t}$$

The expression shows that the pressure pi at any point {rᵣ, θᵣ, φᵣ} of the sound field, at time t, can be represented uniquely by the SHC, Aₙ^{m}(k). Here,

$$k = \frac{ω}{c} ,$$

c is the speed of sound (˜343 m/s), {rᵣ, θᵣ, φᵣ} is a point of reference (or observation point), jₙ (·) is the spherical Bessel function of order n, and Yₙ^{m} (θᵣ, φᵣ) are the spherical harmonic basis functions of order n and suborder m. It can be recognized that the term in square brackets is a frequency-domain representation of the signal (i.e., S(ω, rᵣ, θᵣ, φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

A number of spherical harmonic basis functions for a particular order may be determined as: #basis functions=(n+1)\hat{ }2. For example, a tenth order (n=10) would correspond to 121 spherical harmonic basis functions (e.g., (10+1) \hat{ }2).

The SHC Aₙ^{m} (k) can either be physically acquired (e.g., recorded) by various microphone array configurations or, alternatively, they can be derived from channel-based or object-based descriptions of the sound field. The SHC represent scene-based audio, where the SHC may be input to an audio encoder to obtain encoded SHC that may promote more efficient transmission or storage. For example, a fourth-order representation involving (4+1)² (25, and hence fourth order) coefficients may be used.

As noted above, the SHC may be derived from a microphone recording using a microphone array. Various examples of how SHC may be derived from microphone arrays are described in Poletti, M., “Three-Dimensional Surround Sound Systems Based on Spherical Harmonics,” J. Audio Eng. Soc., Vol. 53, No. 11, 2005 Nov., pp. 1004-1025.

To illustrate how the SHCs may be derived from an object-based description, consider the following equation. The coefficients Aₙ^{m} (k) for the sound field corresponding to an individual audio object may be expressed as:

$${A}_{n}^{m} ( k ) = g ( ω ) ( - 4 π i k ) {h}_{n}^{( 2 )} ( k {r}_{s} ) {Y}_{n}^{m} * ( {θ}_{s} , {φ}_{s} ) ,$$

where i is \sqrt{√}−1, hₙ⁽²⁾(·) is the spherical Hankel function (of the second kind) of order n, and {rₛ, θₛ, φₛ} is the location of the object. Knowing the object source energy g(ω) as a function of frequency (e.g., using time-frequency analysis techniques, such as performing a fast Fourier transform on the PCM stream) enables conversion of each PCM object and the corresponding location into the SHC Aₙ^{m} (k). Further, it can be shown (since the above is a linear and orthogonal decomposition) that the Aₙ^{m} (k) coefficients for each object are additive. In this manner, a multitude of PCM objects can be represented by the Aₙ^{m} (k) coefficients (e.g., as a sum of the coefficient vectors for the individual objects). Essentially, the coefficients contain information about the sound field (the pressure as a function of 3D coordinates), and the above represents the transformation from individual objects to a representation of the overall sound field, in the vicinity of the observation point {rᵣ, θᵣ, φᵣ}.

Referring to FIG. 1, a system 100 includes an audio streaming device 102 and an audio playback device 104 that are each configured to perform spacing-based audio source group processing. FIG. 1 also graphically depicts an example of an audio scene 190 with a set of audio sources 112 including an audio source 112A corresponding to an audio stream 114A, an audio source 112B corresponding to an audio stream 114B, an audio source 112C corresponding to an audio stream 114C, an audio source 112D corresponding to an audio stream 114D, and an audio source 112E corresponding to an audio stream 114E. The audio scene 190 including 5 audio sources is provided as an illustrative example. In other examples, the audio scene 190 can include fewer than 5 audio sources or more than 5 audio sources.

In a particular implementation, the audio streaming device 102 corresponds to an encoder device that receives audio data from multiple audio sources, such as the set of audio streams 114, and encodes the audio data for transmission to the audio playback device 104 via a bitstream 106. In an example, the audio data encoded by the audio streaming device 102 and included in the bitstream 106 includes ambisonics data and corresponds to at least one of two-dimensional (2D) audio data that represents a 2D sound field or three-dimensional (3D) audio data that represents a 3D sound field. As used herein, “ambisonics data” includes a set of one or more ambisonics coefficients that represent a sound field. In another example, the audio data is in a traditional channel-based audio channel format, such as 5.1 surround sound format. In another example, the audio data includes audio data in an object-based format.

The audio streaming device 102 also obtains source metadata (e.g., source location and orientation data) associated with the audio sources 112, assigns the audio sources 112 to one or more groups based on one or more source spacing metrics, assigns a rendering mode to each group, and sends group metadata 136 associated with the one or more groups to the audio playback device 104. The group metadata 136 can include an indication of which audio sources are assigned to each group, the source spacing metric(s), the rendering mode(s), other data corresponding to audio source groups, or a combination thereof. In some implementations, one or more components of the group metadata 136 is transmitted to the audio playback device 104 as bits in the bitstream 106. In some examples, one or more components of the group metadata 136 can be sent to the audio playback device 104 via one or more syntax elements, such as one or more elements of a defined bitstream syntax to enable efficient storage and streaming of the group metadata 136.

The audio streaming device 102 includes one or more processors 120 that are configured to perform operations associated with audio processing. To illustrate, the one or more processors 120 are configured, during an audio encoding operation, to obtain the set of audio streams 114 associated with the set of audio sources 112. For example, the audio sources 112 can correspond to microphones that may be integrated in or coupled to the audio streaming device 102. To illustrate, in some implementations, the audio streaming device 102 includes one or more microphones that are coupled to the one or more processors 120 and configured to provide microphone data representing sound of at least one of the audio sources 112.

The one or more processors 120 are configured to obtain group assignment information 130 indicating that particular audio sources in the set of audio sources 112 are assigned to a particular audio source group, the particular audio source group associated with a source spacing condition 126. According to an aspect, the one or more processors 120 are configured to receive source position information 122 indicating the locations of each of the audio sources 112 and to perform a spacing-based source grouping 124 based on a source spacing condition 126 to generate the group assignment information 130. In an example, audio sources 112 (and/or audio streams 114 of the audio sources 112) that satisfy the source spacing condition 126 are assigned to a first group (or distributed among multiple first groups), and audio sources 112 (and/or audio streams 114 of the audio sources 112) that do not satisfy the source spacing condition 126 (or that satisfy another source spacing conditions) are assigned to a second group (or distributed among multiple second groups). The group assignment information 130 includes data that indicates which of the audio sources 112 is assigned to which of the groups. For example, each group can be represented by a data structure that includes a group identifier (“groupID”) of that group and may also include an indication of which audio sources 112 (and/or audio streams 114) are assigned to that group. In another example, the group assignment information 130 can include a value associated with each of the audio sources 112 that indicates which group, if any, the audio source 112 belongs to.

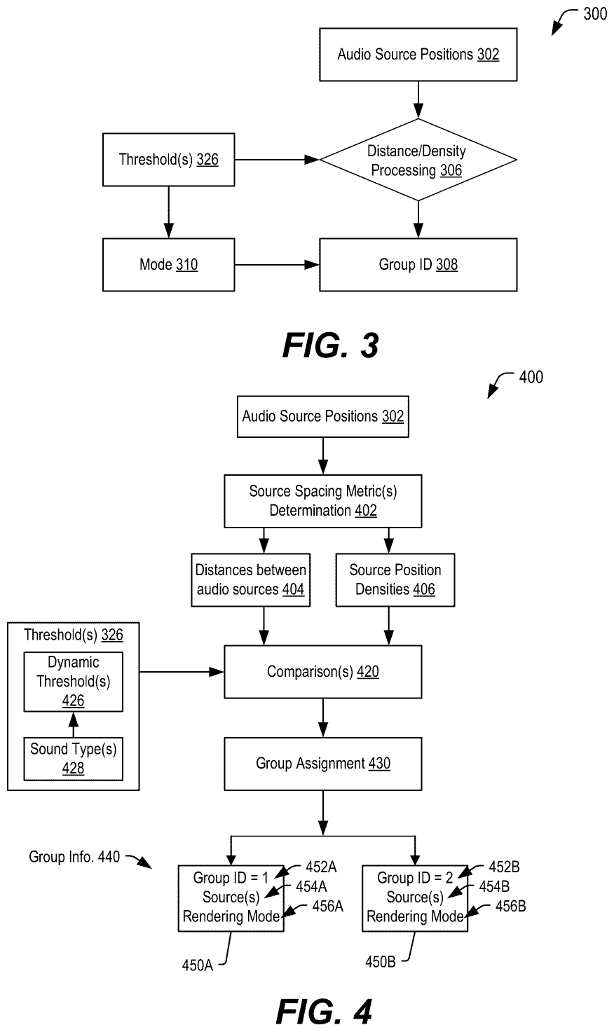

According to an aspect, the source spacing condition 126 corresponds to whether or not a source spacing metric associated with spacing between the audio sources 112 satisfies one or more thresholds, such as described further with reference to FIG. 3 and FIG. 4. In a particular example, the one or more processors 120 are configured to generate the group assignment information 130 at least partially based on comparisons of one or more source spacing metrics to a threshold. To illustrate, the one or more source spacing metrics can include distances between the audio sources 112, a source position density of particular audio sources 112, or a combination thereof, as described further with reference to FIG. 4.

In an illustrative example, referring to the audio scene 190, the audio sources 112D and 112E are assigned to a first group 192, and the audio sources 112A, 112B, and 112C are assigned to a second group 194. To illustrate, the spacing-based source grouping 124 analyzes the locations of the audio sources 112 in the source position information 122 and determines that the distance between the audio source 112A and its nearest neighbor, the audio source 112B (“distAB”), is less than a threshold distance, satisfying the source spacing condition 126, and as a result the spacing-based source grouping 124 assigns the audio sources 112A and 112B to the second group 194. Similarly, the spacing-based source grouping 124 determines that the distance between the audio source 112C and its nearest neighbor, the audio source 112B (“distBC”), is less than the threshold distance, satisfying the source spacing condition 126 and resulting in the audio source 112C being added to the second group 194.

Continuing the example, the spacing-based source grouping 124 also determines that the distance between the audio source 112D and its nearest neighbor, the audio source 112E (“distDE”) is greater than the threshold distance, which fails to satisfy the source spacing condition 126, resulting in the audio source 112D being assigned to the first group 192. Similarly, the spacing-based source grouping 124 also determines that the distance between the audio source 112E and its nearest neighbor (the audio source 112D) is greater than the threshold distance, which fails to satisfy the source spacing condition 126, and as a result the audio source 112E is added to the first group 192. The resulting group assignment information 130 indicates that the first group 192 includes the audio sources 112D and 112E (and/or the corresponding audio streams 114D and 114E, respectively), and that the second group 194 includes the audio sources 112A, 112B, and 112C (and/or the corresponding audio streams 114A, 114B, and 114C, respectively).

Although in the above example two groups are generated due to some audio sources 112 satisfying the source spacing condition 126 and other audio sources 112 not satisfying the source spacing condition 126, it should be understood that in other examples all sources in a sound scene can belong to a single group (e.g., if all of the audio sources 112 satisfy the source spacing condition 126, or if all of the audio sources 112 do not satisfy the source spacing condition 126), or the audio sources 112 can be partitioned into more than two groups, such as when additional source spacing conditions are used in the spacing-based source grouping 124 (e.g., multiple distance thresholds are used for comparison) and/or when the audio sources 112 are also grouped based on which sounds of the audio scene 190 the audio sources 112 capture, as explained further below.

The one or more processors 120 are configured to generate output data that includes the group assignment information 130 and an encoded version of the set of audio streams 114. For example, the audio streaming device 102 can include a modem that is coupled to the one or more processors 120 and configured to send the output data to a decoder device, such as by sending the group assignment information 130 and an encoded version of the audio streams 114 to the audio playback device 104 via the bitstream 106.

Optionally, in some implementations, the one or more processors 120 are also configured to determine a rendering mode for each particular audio source group and include an indication of the rendering mode in the output data. In an example, the one or more processors 120 are configured to select the rendering mode from multiple rendering modes that are supported by a decoder device, such as the audio playback device 104. For example, the multiple rendering modes can include a baseline rendering mode in which signal processing, source direction analysis, and source interpolation are performed in a frequency domain, and a low-complexity rendering mode in which distance-weighted time domain interpolation is performed. The baseline rendering mode can correspond to a first mode 172 and the low-complexity rendering mode can correspond to a second mode 174 that are supported by a renderer 170 of the audio playback device 104.

In a particular example, the one or more processors 120 perform a group-based rendering mode assignment 132 in which a rendering mode is assigned to each group based on the group assignment information 130. To illustrate, each group that includes audio sources 112 (and/or audio streams 114) that fail to satisfy the source spacing condition 126 (e.g., by having shortest distances between the included audio sources 112 that equal or exceed the threshold distance) can be assigned to a first rendering mode, and each group that includes audio sources 112 (and/or audio streams 114) that satisfy the source spacing condition 126 (e.g., by having distances between included audio sources 112 that are less than the threshold) can be assigned to a second rendering mode. In an example, the first group 192 including the audio sources 112D and 112E is assigned to the first mode 172, and the second group 194 including the audio sources 112A, 112B, and 112C is assigned to the second mode 174.

The group-based rendering mode assignment 132 generates rendering mode information 134 that indicates which rendering mode is assigned to which group. For example, the rendering mode for a group can be included as a data value in a data structure for that group. To illustrate, a first data structure for the first group 192 can include a group identifier having a value of ‘1’ indicating the first group 192 and a rendering mode indicator having a first value (e.g., a boolean value of ‘0’ when only two rendering modes are supported or an integer value of ‘1’ when more than two modes are supported) indicating the first mode 172. A second data structure for the second group 194 can include a group identifier having a value of ‘2’ indicating the second group 194 and a rendering mode indicator having a second value (e.g., a boolean value of ‘1’ or an integer value of ‘2’) indicating the second mode 174.

An illustrative, non-limiting example of a bitstream syntax associated with higher order ambisonics groups (hoaGroups) is shown in Table 1. In Table 1, a value of parameter hoaGroupLC is read from the bitstream for each hoaGroup. The hoaGroupLC parameter is boolean: a ‘0’ value indicates that a baseline rendering mode is to be used for the group, and a ‘1’ value indicates that a low-complexity rendering mode is to be used.

TABLE 1

| Syntax | No. of bits |
|---|---|
| hoaGroups( ) | |
| { | |
| hoaGroupsCount = GetCountOrIndex( ); | |
| for (int i = 0; i < hoaGoupsCount; i++) { | |
| hoaGroupId = GetID( ); | |
| hoaGroupLC; | 1 |
| ... | |
| } | |
| } | |

In another illustrative, non-limiting example, the rendering mode information 134 can include a table or list that associates each audio source 112 and/or each audio stream 114 with an associated rendering mode.

The one or more processors 120 are configured to send the rendering mode information 134, as well as the group assignment information 130, to the audio playback device 104. For example, the group metadata 136 can include the group assignment information 130 and the rendering mode information 134. In a particular example, the group metadata 136 can include a data structure for each group that includes that group's identifier, a list of the audio sources 112 and/or audio streams 114 included in the group, and an indication of a rendering mode assigned to the group.

In a particular implementation, the audio playback device 104 corresponds to a decoder device that receives the encoded audio data (e.g., the audio streams 114) from the audio streaming device 102 via the bitstream 106. The audio playback device 104 also obtains metadata associated with the audio data from the audio streaming device 102, such as the source metadata (e.g., source location and orientation data) and the group metadata 136 (e.g., the group assignment information 130, the source spacing metric(s), the rendering mode(s), or a combination thereof). In some implementations, one or more components of the group metadata 136, the source metadata, or both, is extracted from bits sent in the bitstream 106. In some examples, one or more components of the group metadata 136, the source metadata, or both, can be received from the audio streaming device 102 via one or more syntax elements.

The audio playback device 104 renders the received audio data to generate an output audio signal 180 based on a listener position 196, the group assignment information 130, and the rendering mode information 134. For example, the audio playback device 104 can select one or more of the audio sources 112 for rendering based on the listener position 196 relative to the various audio sources 112, based on types of sound represented by the various audio streams 114 (e.g., a determined by one or more classifiers at the audio streaming device 102 and/or at the audio playback device 104), or both, as described further below. The audio sources 112 that are selected can be included in one or more groups, and the audio streams 114 of the selected audio sources 112 in each group can be rendered according to the rendering mode assigned to that group.

The audio playback device 104 includes one or more processors 150 that are configured to perform operations associated with audio processing. To illustrate, the one or more processors 150 are configured, during an audio decoding operation, to obtain the set of audio streams 114 associated with the set of audio sources 112. At least one of the set of audio streams 114 is received via the bitstream 106 from an encoder device (e.g., the audio streaming device 102). In an example, the audio playback device 104 includes a modem that is coupled to the one or more processors 150 and configured to receive at least one audio stream 114 of the set of audio streams 114 via the bitstream 106 from the audio streaming device 102.

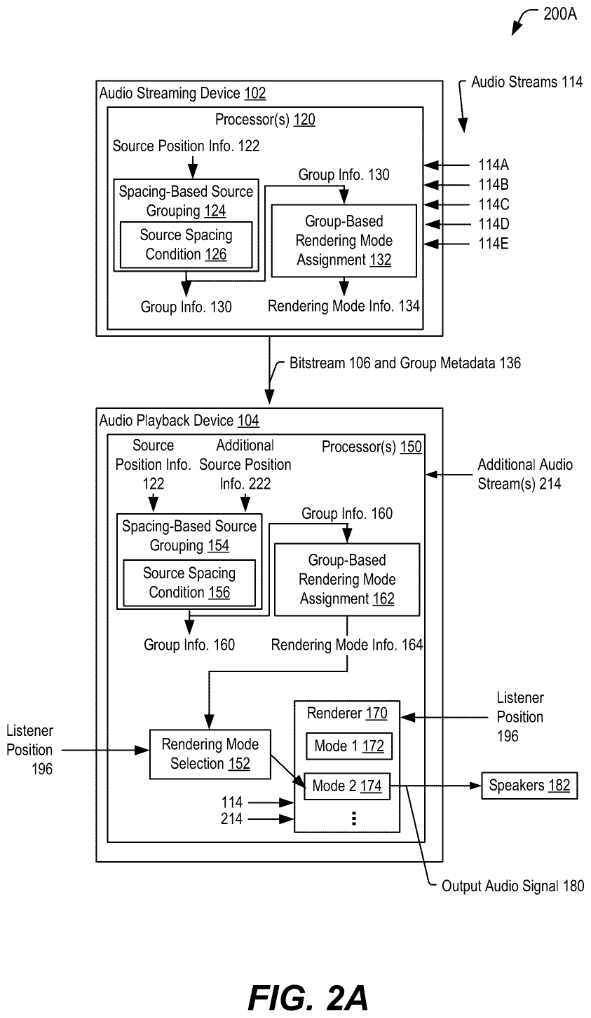

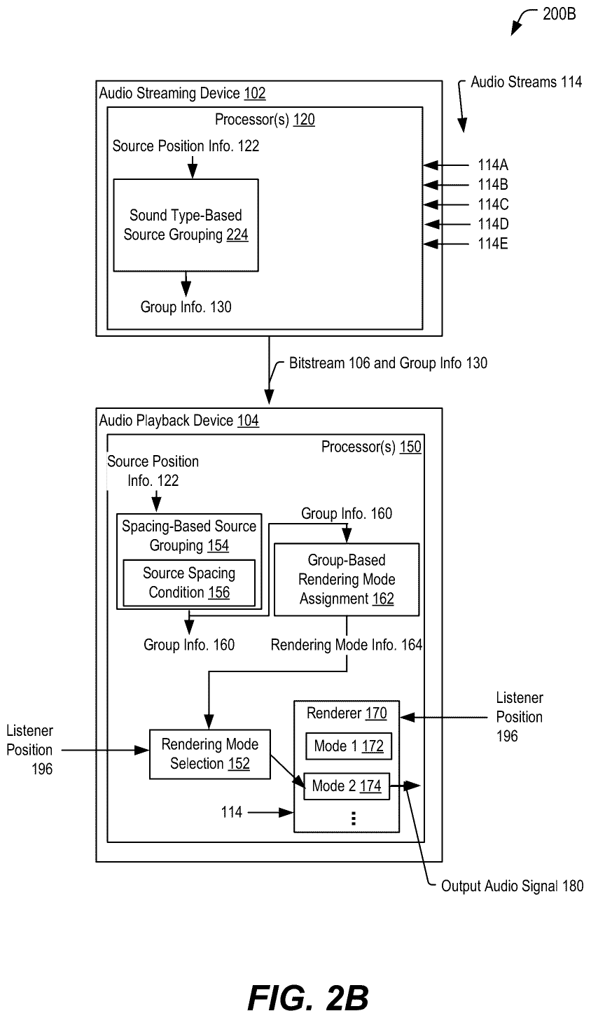

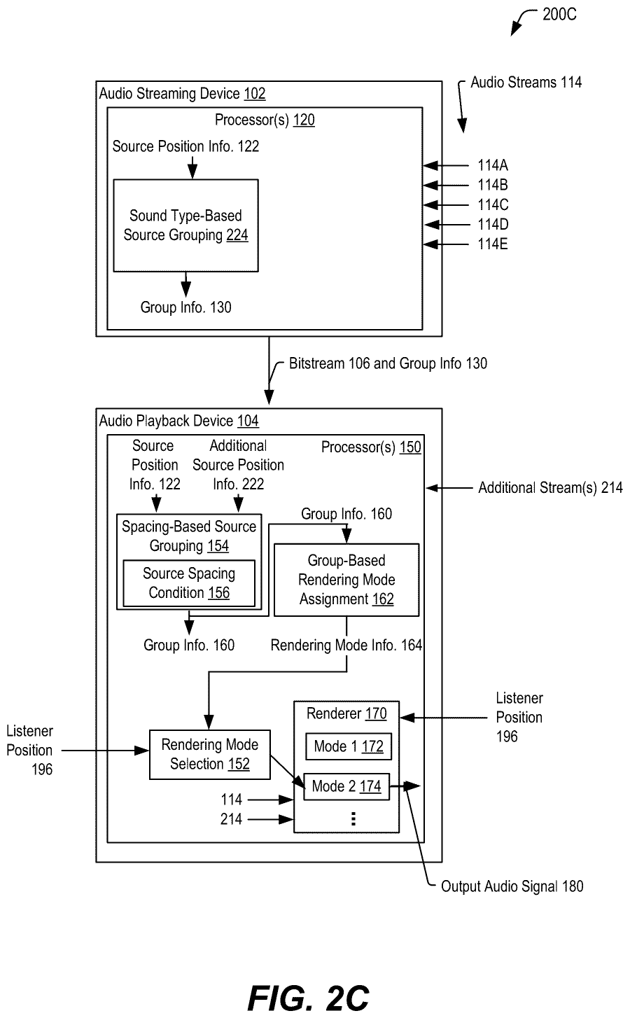

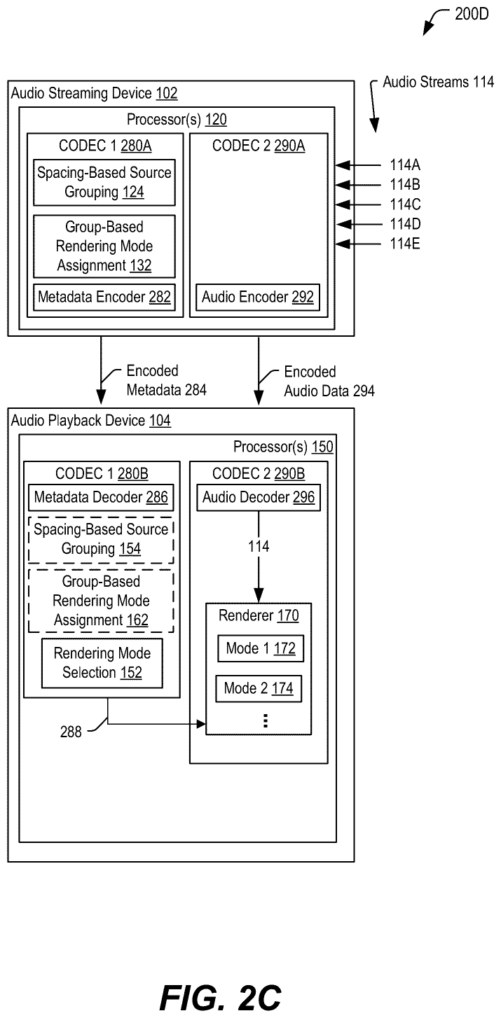

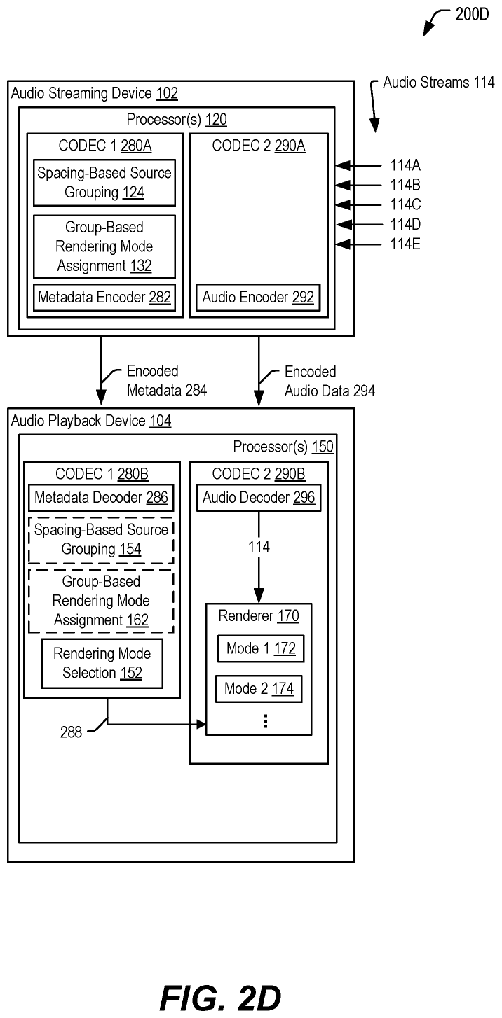

The one or more processors 150 are configured to obtain the group assignment information 130 indicating that particular audio sources in the set of audio sources 112 are assigned to a particular audio source group, the particular audio source group associated with the source spacing condition 126. The group assignment information 130 can be received via the bitstream 106 (e.g., in the group metadata 136). In some implementations, the audio playback device 104 also updates the received group assignment information 130, such as described further with reference to FIGS. 2A-2D.

The one or more processors 150 are configured to obtain a listener position 196 associated with a pose of a user of the audio playback device 104 (also referred to as a “listener”). For example, in some implementations, the audio playback device 104 corresponds to a headset that includes or is coupled to one or more sensors 184 configured to generate sensor data indicative of a movement of the audio playback device 104, a pose of the audio playback device 104, or a combination thereof. As used herein, the “pose” of the audio playback device 104 (or of the user's head) indicates a location and an orientation of the audio playback device 104 (or of the user's head), which are collectively referred to as the listener position 196. The one or more processors 150 may use the listener position 196 to select which of the audio streams 114 to render based on the listener's location, and may also use the listener position 196 during rendering to apply rotation, multi-source interpolation, or a combination thereof, based on the listener's orientation and/or location in the audio scene 190.

The one or more sensors 184 include one or more inertial sensors such as accelerometers, gyroscopes, compasses, positioning sensors (e.g., a global positioning system (GPS) receiver), magnetometers, inclinometers, optical sensors, one or more other sensors to detect acceleration, location, velocity, angular orientation, angular velocity, angular acceleration, or any combination thereof, of the audio playback device 104. In one example, the one or more sensors 184 include GPS, electronic maps, and electronic compasses that use inertial and magnetic sensor technology to determine direction, such as a 3-axis magnetometer to measure the Earth's geomagnetic field and a 3-axis accelerometer to provide, based on a direction of gravitational pull, a horizontality reference to the Earth's magnetic field vector. In some examples, the one or more sensors 184 include one or more optical sensors (e.g., cameras) to track movement, individually or in conjunction with one or more other sensors (e.g., inertial sensors).

The one or more processors 150 are configured to render, based on a rendering mode assigned to each particular audio source group, particular audio streams 114 that are associated with the particular audio sources 112 of the group. For example, the one or more processors 150 perform a rendering mode selection 152 for each group based on the rendering mode information 134, such as by reading a value of the assigned rendering mode from a data structure for the group. To illustrate, the rendering mode assigned to each particular audio source group is one of multiple rendering modes that are supported by the one or more processors 150, such as the first mode 172 and the second mode 174 supported by the renderer 170.

An indication of the selected rendering mode is provided to the renderer 170, which renders one or more of the audio streams 114 of the group based on the selected rendering mode to generate the output audio signal 180. The renderer 170 supports the first mode 172 and the second mode 174, and in some implementations further supports one or more additional rendering modes. According to a particular implementation, the first mode 172 is a baseline rendering mode in which signal processing, source direction analysis, and source interpolation are performed in a frequency domain, and the second mode 174 is a low-complexity rendering mode in which distance-weighted time domain interpolation is performed. To illustrate, the renderer 170 is configured to perform source interpolation of various audio streams 114 based on the listener position 196 in relation to the locations of the audio sources 112. As an illustrative, non-limiting example, audio signals associated with each of the audio sources 112A, 112B, and 112C can be interpolated into a single audio signal (e.g., with a corresponding interpolated source location and orientation) for rendering based on the listener position 196, such that components of the audio from audio sources 112 closer to the listener position 196 are represented more prominently in the interpolated signal than from audio sources 112 further from the listener position 196. Alternatively, audio signals associated with each of the audio sources 112D and 112E can be interpolated into a single audio signal for rendering based on the listener position 196.

The resulting output audio signal 180 is provided for playout by speakers 182. According to some aspects, the speakers 182 are earphone speakers and the output audio signal 180 corresponds to a binaural signal. For example, the renderer 170 can be configured to perform one or more sound field rotations based on orientations of the audio sources 112 and/or the interpolated audio sources and the orientation of the listener and to perform binauralization using head related transfer functions (HRTFs) to generate a realistic representation of the audio scene 190 for a user wearing earphones and based on the particular location and orientation of the listener in the audio scene 190 relative to the audio sources 112.

In some implementations, the rendering mode selection 152 also includes a determination of which specific audio streams 114 to render. Such determination may be based on the listener position 196 and may also be based on whether the audio sources 112 capture a common sound or whether some of the audio sources 112 sample a first sound while others of the audio sources 112 sample a second sound. As an illustrative example, the audio scene 190 may include a campfire and a waterfall, and the audio sources 112 may be arranged in the audio scene 190 such that all of the audio sources 112A-112E capture the sound of the waterfall, or the audio sources 112 may be arranged such that one or more of the audio sources 112 sample the sound of the campfire and one or more other audio sources 112 sample the sound of the waterfall.

In a first example in which all of the audio sources 112 capture a common sound (e.g., the waterfall), rendering for a first listener position 196A that is proximate to the audio sources 112A, 112B, and 112C and relatively far from the audio sources 112D and 112E can include rendering audio (e.g. the audio streams 114A, 114B, and 114C) from the audio sources 112A, 112B, and 112C but not rendering audio from the audio source 112D and audio source 112E. Because the audio sources 112A, 112B, and 112C are in the second group 194, rendering is performed using the second mode 174 that is assigned to the second group 194.

Continuing the first example, rendering for a second listener position 196B that is proximate to the audio sources 112D and 112E and relatively far from the audio sources 112A, 112B, and 112C can include rendering audio (e.g., the audio streams 114D, 114E) from the audio sources 112D and 112E but not rendering audio from the audio sources 112A, 112B, and 112C. Because the audio sources 112D and 112E are in the first group 192, rendering is performed using the first mode 172 that is assigned to the first group 192.

Continuing the first example, rendering for a third listener position 196C that is located roughly between the audio source 112C and the audio sources 112D and 112E can be based on whether the third listener position 196C is closer to the first group 192 or the second group 194, e.g., whether the third listener position 196C is closer to the audio source 112C than to either of the audio sources 112D and 112E. If the third listener position 196C is closer to the audio source 112C, rendering can include rendering audio from the audio sources of the second group 194 (e.g., the audio sources 112A, 112B, and 112C) using the second mode 174 assigned to the second group 194, but not rendering audio from the audio sources of the first group 192. Otherwise, if the third listener position 196C is closer to the audio source 112D or 112E than to the audio source 112C, rendering can include rendering audio from the audio sources of the first group 192 (e.g., the audio sources 112D and 112E) using the first mode 172 assigned to the first group 192, but not rendering audio from the audio sources of the second group 194.

In a second example in which the audio sources 112A, 112B, and 112C of the second group 194 sample a first sound (e.g., the waterfall) and the audio sources 112D and 112E of the first group 192 sample a second sound (e.g., the campfire), rendering is performed for audio sources 112 of both the first group 192 and the second group 194 so that both sounds are represented in the rendering of the audio scene 190, independently of whether the listener position corresponds to the first listener position 196A, the second listener position 196B, or the third listener position 196C. To generalize, according to some aspects, when the grouping of the audio sources is at least partially based on which sounds are being captured, at least one group for each of the captured sounds is selected for rendering.

Continuing the second example, rendering the first sound (e.g., the waterfall) includes rendering audio from the audio sources of the second group 194 (e.g., the audio sources 112A, 112B, and 112C) using the second mode 174 assigned to the second group 194, and rendering the second sound (e.g., the campfire) includes rendering audio from the audio sources of the first group 192 (e.g., the audio sources 112D and 112E) using the first mode 172 assigned to the first group 192. In some implementations, the renderer 170 is configured to render the second sound (e.g., the campfire) using the first mode 172 in parallel with rendering the first sound (e.g., the waterfall) using the second mode 174, and then combining (e.g., mixing) the resulting rendered audio signals to generate the output audio signal 180.

Although the above examples describe rendering audio associated with five audio sources 112 that are grouped into two groups, it should be understood that the present techniques can be used with any number of audio sources 112 that are grouped into any number of groups. According to some implementations, rendering at the audio playback device 104 can be limited to a set number of audio sources 112 per group to be rendered, such as 3 audio sources per group, as a non-limiting example. The rendering mode selection 152 can include comparing locations of each of the audio sources 112 in a group to the location of the listener to select the set number (e.g., 3) of audio sources from the group that are closest to the listener location. The rendering mode selection 152 can also select which group to render from multiple groups that capture the same sound (e.g., the waterfall) based on the listener position 196.

By performing spacing-based source grouping of the audio sources 112 and selecting a rendering mode based on which group is to be rendered, the system 100 enables selective rendering of spatial audio using a low-complexity mode with no perceptible effect (or an acceptably small perceptible effect) on the quality of the resulting audio output, while also providing reduced power consumption, reduced rendering latency, or both, at the audio playback device 104. A technical advantage of determining the spacing-based source grouping 124 and the group-based rendering mode assignment 132 at the audio streaming device 102 (e.g., a content creation server) includes reducing processing resources and power consumption that would otherwise be used by the audio playback device 104 (e.g., a mobile device or headset) to make such determinations.

Although examples included herein describe the audio streams 114 as corresponding to audio data from respective microphones, in other examples one or more of the audio streams 114 may correspond to a portion of one or more of media files, audio generated at a game engine, one or more other sources of sound information, or a combination thereof. To illustrate, the audio streaming device 102 may obtain one or more of the audio streams 114 from a storage device coupled to the one or more processors 120 or from a game engine included in the one or more processors 120. As another example, in addition to receiving the audio streams 114 via the bitstream 106, the audio playback device 104 may obtain one or more audio streams locally, such as from a microphone coupled to the audio playback device 104 as described further with reference to FIG. 2A, from a storage device coupled to the one or more processors 150, or from a game engine included in the one or more processors 150.

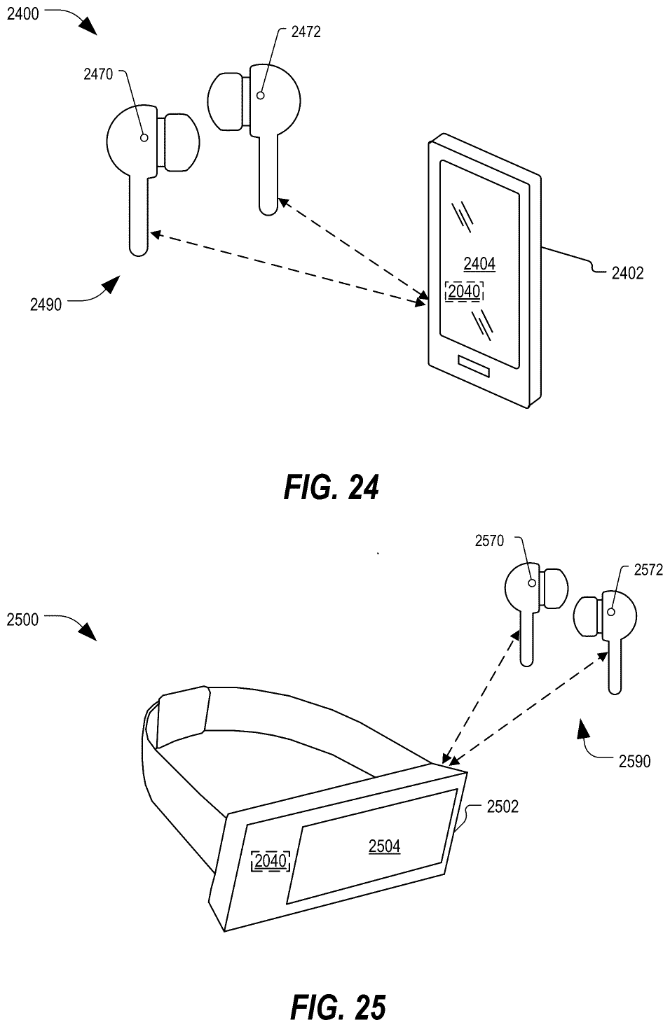

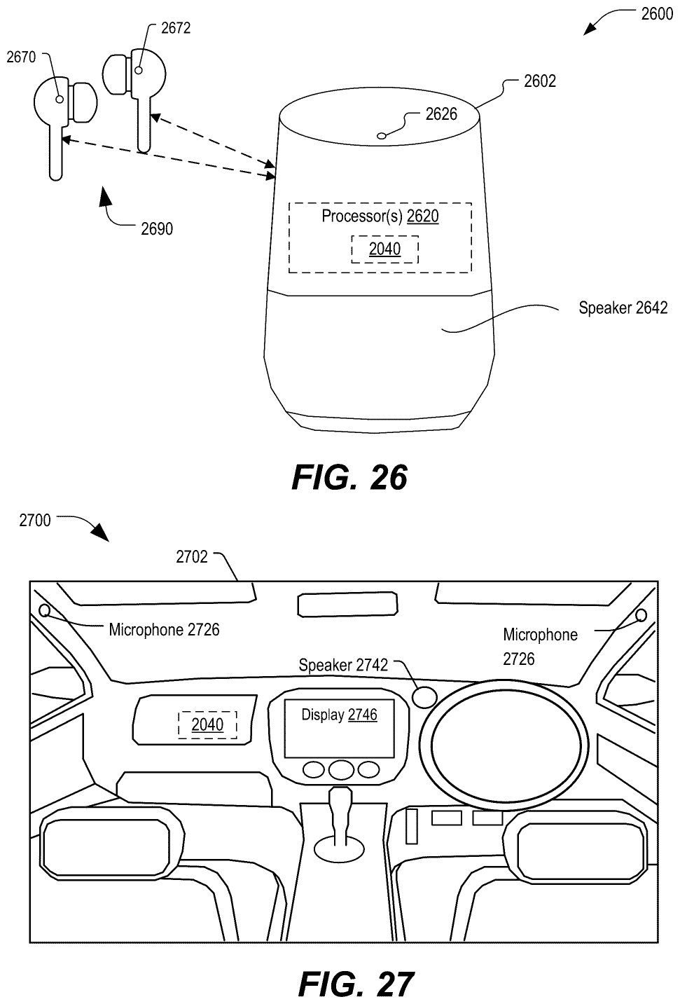

Although in some examples the audio playback device 104 is described as a headphone device for purpose of explanation, in other implementations the audio playback device 104 (and/or the audio streaming device 102) is implemented as another type of device. In some implementations, the audio playback device 104 (e.g., the one or more processors 150), the audio streaming device 102 (e.g., the one or more processors 120), or both, are integrated in a headset device, such as depicted in FIGS. 21-23. In an illustrative example, the headset device corresponds to at least one of a virtual reality headset, a mixed reality headset, or an augmented reality headset, such as described further with reference to FIG. 23. In some implementations, the audio playback device 104 (and/or the audio streaming device 102) is integrated in at least one of a mobile phone or a tablet computer device, as depicted in FIG. 24, a wearable electronic device, as depicted in FIG. 25, or a camera device. In some implementations, the audio playback device 104 (and/or the audio streaming device 102) is integrated in a wireless speaker and voice activated device, such as depicted in FIG. 26. In some implementations, the audio playback device 104 (and/or the audio streaming device 102) is integrated in a vehicle, as depicted in FIG. 27.

Although various examples described for the system 100, and also for systems depicted in the following figures, correspond to implementations in which the output audio signal 180 is a binaural output signal, in other implementations the output audio signal 180 has a format other than binaural. As an illustrative, non-limiting example, in some implementations the output audio signal 180 corresponds to an output stereo signal for playout at loudspeakers that are integrated in or coupled to the audio playback device 104 (or for transmission to another device). In other implementations, the output audio signal 180 provided by the one or more processors 150 may have one or more other formats and is not limited to binaural or stereo.

FIG. 2A depicts an example of a system 200A that includes the audio streaming device 102 and the audio playback device 104 of FIG. 1. The audio streaming device 102 includes the one or more processors 120 and operates to generate and send the bitstream 106 and the group metadata 136 (e.g., the group assignment information 130 and the rendering mode information 134) to the audio playback device 104 in a substantially similar manner as described with reference to FIG. 1. As compared to FIG. 1, the one or more processors 150 of the audio playback device 104 are configured to update the received group assignment information 130, the rendering mode information 134, or both, prior to rendering.

The one or more processors 150 are configured to receive one or more additional audio streams 214 from one or more audio sources, such as from one or more microphones included in or coupled to the audio playback device 104. As an illustrative, non-listening example, the audio scene 190 of FIG. 1 can correspond to spatial audio associated with a virtual musical performance, such as prerecorded audio of an orchestra, choir, band, etc., and the one or more additional audio streams 214 can correspond to one or more microphone or other audio feed of one or more performers (e.g., one or more singers or instrumentalists) that are performing in conjunction with the prerecorded audio, such as in a karaoke-type performance.

According to an aspect, the one or more processors 150 are configured to perform spacing-based source grouping 154 of all received audio sources based on a source spacing condition 156 in a similar manner as described for the spacing-based source grouping 124 based on the source spacing condition 126. For example, receiving the one or more additional audio streams 214 and metadata position data associated with the one or more additional audio streams 214 can trigger the one or more processors 150 to perform source regrouping and group rendering mode reassignment.

The spacing-based source grouping 154 is performed using the source position information 122 and additional source position information 222 that corresponds to the positions of the audio sources for the one or more additional audio streams 214. For example, the one or more processors 150 may perform a coordinate transformation to align a reference point (e.g., a location and orientation coordinate origin) associated with metadata position information (e.g., the additional source position information 222) for the one or more additional audio streams 214 to a reference point associated with the source position information 122 in order to determine locations and orientations of the additional sources in the reference frame of the audio scene 190. The spacing-based source grouping 154 includes determining an updated set of groups based on a source spacing condition 156. The source spacing condition 156 may match the source spacing condition 126 in some cases or may differ from the source spacing condition 126 in other cases. The spacing-based source grouping 154 updates the received group assignment information 130 to generate group assignment information 160.

In an example, the one or more processors 150 keep a list of positions of all the audio stream sources in the scene and take in parameters to determine the source spacing condition 156, such as one or more thresholds in either proximity (e.g., in units of meters) or density (e.g., in units of sources/m² or sources/m³). At initialization, or whenever audio streams are added or removed, the one or more processors 150 perform the spacing-based source grouping 154 to create group(s) from the audio streams based on the threshold(s) and also perform a group-based rendering mode assignment 162 to designate a rendering mode to each group. The resulting rendering mode information 164 is used to perform the rendering mode selection 152 to select a rendering mode for rendering audio streams (e.g., one or more of the audio streams 114, one or more of the one or more additional audio streams 214, or a combination thereof) of the various groups at the renderer 170.

In some implementations, the spacing-based source grouping 154 results in the one or more additional audio streams 214 being included in the same group(s) as the audio streams 114. In other implementations, the spacing-based source grouping 154 results in one or more new groups (e.g., groups not identified in the group assignment information 130) that include one or more of the additional audio streams 214 and that do not include any of the audio streams 114. In such cases, the renderer 170 can generate a first rendered audio signal associated with the set of audio sources 112 and can generate a second rendered audio signal associated with a microphone input (e.g., the one or more additional audio streams 214). The renderer 170 can combine the first rendered audio signal with the second rendered audio signal to generate a combined signal and can binauralize the combined signal to generate the output audio signal 180 as a binaural output signal. The output audio signal 180 is provided to the one or more speakers 182, which play out the binaural output signal.

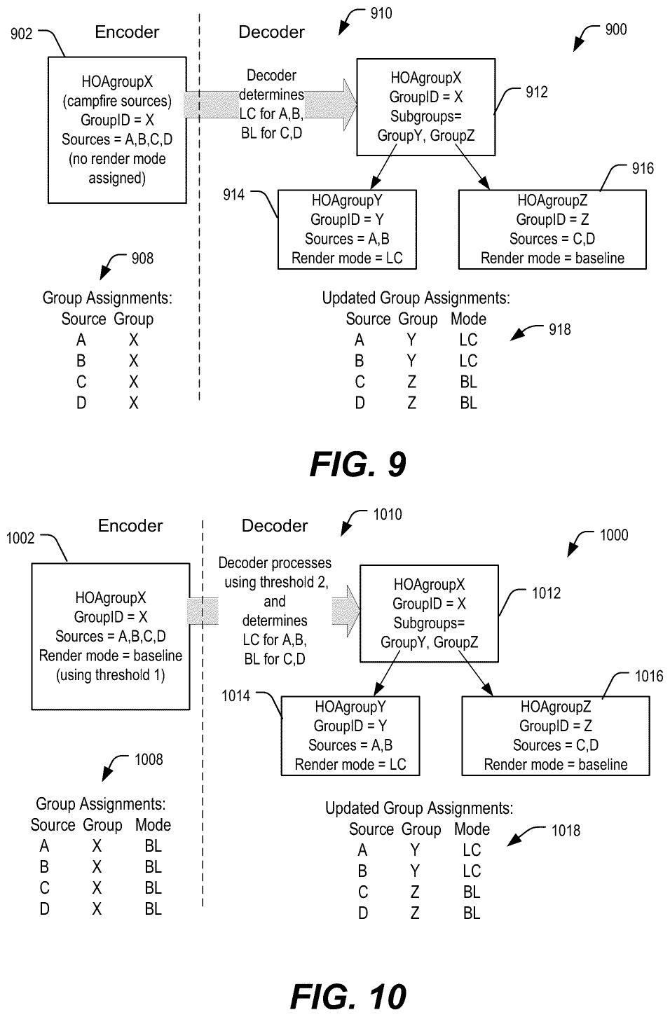

A technical advantage of performing the spacing-based source grouping 154 and the group-based rendering mode assignment 162 at the audio playback device 104 can include dynamic reconfiguration at the audio playback device 104 when new audio sources are defined that were not available during initialization, such as when the one or more additional audio streams 214 are received at the audio playback device 104. In addition, the audio playback device 104 can dynamically reconfigure when audio sources are removed. The rendering mode information 164 and the group-based rendering mode assignment 162 also provide the ability to assign sub-groups different rendering modes, such as described further with reference to FIGS. 9-11.

FIG. 2B depicts an example of a system 200B that includes a particular implementation of the audio streaming device 102 and the audio playback device 104. As illustrated, the audio streaming device 102 omits the spacing-based source grouping 124 and the group-based rendering mode assignment 132 and instead performs sound type-based source grouping 224 of the audio sources 112 (and/or the audio streams 114), such as by assigning audio sources 112 that sample a campfire in the audio scene 190 into a first group and assigning audio sources 112 that sample a waterfall in the audio scene 190 into a second group. The resulting bitstream 106 and group assignment information 130 is provided to the audio playback device 104.

The audio playback device 104 is configured to perform the spacing-based source grouping 154 of FIG. 2A to generate sub-groups of the groups indicated in the group assignment information 130 based on the source position information 122. For example, when the group assignment information 130 specifies a first group of audio sources that sample sound of a campfire and a second group of audio sources that sample sound of a waterfall, the spacing-based source grouping 154 can generate sub-groups of the audio sources in the first group based on the source spacing condition 156 and the source position information 122, and can also generate sub-groups of the audio sources in the second group based on the source spacing condition 156 and the source position information 122. Thus, the one or more processors 150 of the audio playback device 104 are configured to update the received group assignment information 130 to generate the group assignment information 160 prior to rendering. The one or more processors 150 can also perform the group-based rendering mode assignment 162 using the group assignment information 160 to generate rendering mode information 164, which is used to select rendering modes for audio sources in the various groups during rendering.

As a result, the audio playback device 104 can provide the power savings and rendering latency improvements associated with using different rendering modes based on source spacing conditions, as described above, even when used to playback audio from a streaming device that does not support, or that has disabled or bypassed, the spacing-based source grouping 124 and the group-based rendering mode assignment 132 of FIG. 1 and FIG. 2A.

FIG. 2C depicts an example of a system 200C that includes the audio streaming device 102 and the audio playback device 104 of FIG. 2B, and where the audio playback device 104 also receives the one or more additional audio streams 214 of FIG. 2A. The audio playback device 104 is configured to perform the spacing-based source grouping 154 (e.g., including the sub-grouping as described in FIG. 2B) based on the group assignment information 130 and the source position information 122, and further based on the additional source position information 222 associated with the one or more additional audio streams 214.

FIG. 2D depicts an example of a system 200D in which the audio streaming device 102 implements a first codec 280A and a second codec 290A, and the audio playback device 104 implements a first codec 280B and a second codec 290B. The first codec 280A corresponds to a metadata codec that performs the spacing-based source grouping 124 and the group-based rendering mode assignment 132 and encodes the resulting audio source metadata (e.g., the group assignment information 130, the rendering mode information 134, source spacing metric(s), source spacing thresholds, etc.) at a metadata encoder 282 to generate encoded metadata 284. The second codec 290A corresponds to an audio codec that encodes the audio streams 114 at an audio encoder 292 to generate encoded audio data 294 (e.g., encoded audio streams). In some implementations, the encoded metadata 284 and the encoded audio data 294 are sent to the audio playback device 104 as separate bitstreams. In other implementations, the encoded metadata 284 and the encoded audio data 294 are sent to the audio playback device 104 as a combined bitstream.

At the audio playback device 104, the first codec 280B includes a metadata decoder 286 configured to decode the encoded metadata 284. Optionally, the first codec 280B may also be configured to perform the spacing-based source grouping 154 and the group-based rendering mode assignment 162 as described above. The first codec 280 provides a metadata output 288 (e.g., including the rendering mode selection 152 associated with one or more groups of sources, or the group assignment information 130 and the rendering mode information 134) to the second codec 290B.

The second codec 290B may include an audio decoder 296 configured to decode the encoded audio data 294 to generate a decoded version of the audio streams 114 and includes the renderer 170. The renderer 170 generates rendered audio data (e.g., the output audio signal 180) based on the decoded version of the audio streams 114 and the metadata output 288 of the first codec 280B.

Thus, FIG. 2D illustrates a system in which the group assignment information 130 is included in a metadata output of a first encoder (the metadata encoder 282) and where an encoded version of the set of audio streams 114 (the encoded audio data 294) is included in a bitstream output of a second encoder (the audio encoder 292). The metadata output of the first encoder may further include an indication of a rendering mode for one or more audio source groups (e.g., the rendering mode information 134).

The first codecs 280A, 280B can support one or more types of metadata encoding formats and may correspond to an MPEG-type metadata codec (e.g., MPEG-I) or a Spatial Audio Metadata Injector-type codec (e.g., Spatial Media Metadata Injector v2.1), as illustrative, non-limiting examples. The second codecs 290A, 290B can support one or more types of audio encoding formats and may correspond to a Moving Picture Experts Group (MPEG)-type audio codec (e.g., MPEG-H) and/or may support one or more different audio encoding formats or specification such as: AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB) G.723.1, G.726, G.728, G.729, G.729.1, GSM-FR, HE-AAC, ILBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, or Windows Media Audio (WMA). Although FIG. 2D illustrates separate audio and metadata codecs, in other implementations audio and metadata encoding/decoding can be performed by a codec that supports combined audio and metadata delivery formats, such as an Audio Definition Model (ADM)-type format.

FIG. 3 depicts an example of operations 300 that can be performed at the audio streaming device 102 (e.g., the spacing-based source grouping 124), at the audio playback device 104 (e.g., the spacing-based source grouping 154), or both. The operations 300 include generating a list of audio source positions 302 of all of the audio sources in the audio scene, such as the audio sources 112, the one or more additional audio streams 214, or both. The operations 300 also include obtaining one or more thresholds 326, such as in either proximity (meters) or density (sources/m² or sources/m³).

The operations 300 include performing distance and/or density processing 306 based on the audio source positions 302 and the one or more thresholds 326 to create group(s) from the audio streams based on the threshold(s) 326. For example, the distance and/or density processing may result in generation of group assignment information (e.g., the group assignment information 130 or the group assignment information 160) at least partially based on comparisons of one or more source spacing metrics to one or more of the threshold(s) 326. The one or more source spacing metrics can include distances between the particular audio sources or a source position density of the particular audio sources.

The generated groups may be assigned group IDs 308, and a rendering mode 310 may be designated to each group(s) based on whether the audio sources of the group satisfy the threshold(s) 326. In some implementations there can be a single group in the audio scene, in which case the threshold 326 is used to set the rendering mode 310. The rendering mode 310 can be indicated using a boolean data value if only two rendering modes are available, or can be indicated using a value having another data format, such as an integer data value, if more than two modes are available.

In an illustrative, non-limiting example, a distance threshold can have a value of 2 meters (m). In an arrangement of four audio sources that are set 10 meters equidistance apart from each other, a group may be created from the four audio sources and may be assigned to a relatively high-complexity baseline rendering mode, such as the first mode 172. In another illustrative, non-limiting example in which the threshold is 2 meters and four audio sources are arranged 1 meter equidistance apart from each other, a group may be created from the four audio sources and assigned to a relatively low-complexity rendering mode, such as the second mode 174.

FIG. 4 depicts another example of operations 400 that can be performed at the audio streaming device 102 (e.g., the spacing-based source grouping 124), at the audio playback device 104 (e.g., the spacing-based source grouping 154), or both.

The operations 400 include generating a list of the audio source positions 302, as described in FIG. 3, and performing a source spacing metric(s) determination 402. For example, the source spacing metric(s) can include distances 404 between the particular audio sources, one or more source position densities 406 of the particular audio sources, or both.

The operations 400 include obtaining the one or more thresholds 326, such as in either proximity (meters) or density (sources/m² or sources/m³). The threshold(s) 326 can include one or more dynamic thresholds 426. For example, a dynamic threshold 426 may have a value that is selected based on one or more sound types 428 associated with particular audio sources (e.g., a type of sound sampled by one or more of the audio sources), such as a first threshold value for speech and a second threshold value for music.

The operations 400 include performing one or more comparisons 420 of one or more of the source spacing metrics (e.g., the distances 404, the source position densities 406, or both) to one or more thresholds 326, and performing group assignment 430 at least partially based on the results of the comparisons 420.

An output of the group assignment 430 can be represented as group information 440 that includes a group data structure for each identified group, such as a first group data structure 450A and a second group data structure 450B. The first group data structure 450A includes a first group ID 452A for a first group and optionally includes a list of sources 454A assigned to the first group, an indication of a rendering mode 456A assigned to the first group, or both. The second group data structure 450B includes a second group ID 452B and optionally includes a list of sources 454B assigned to the second group, an indication of a rendering mode 456B assigned to the second group, or both.

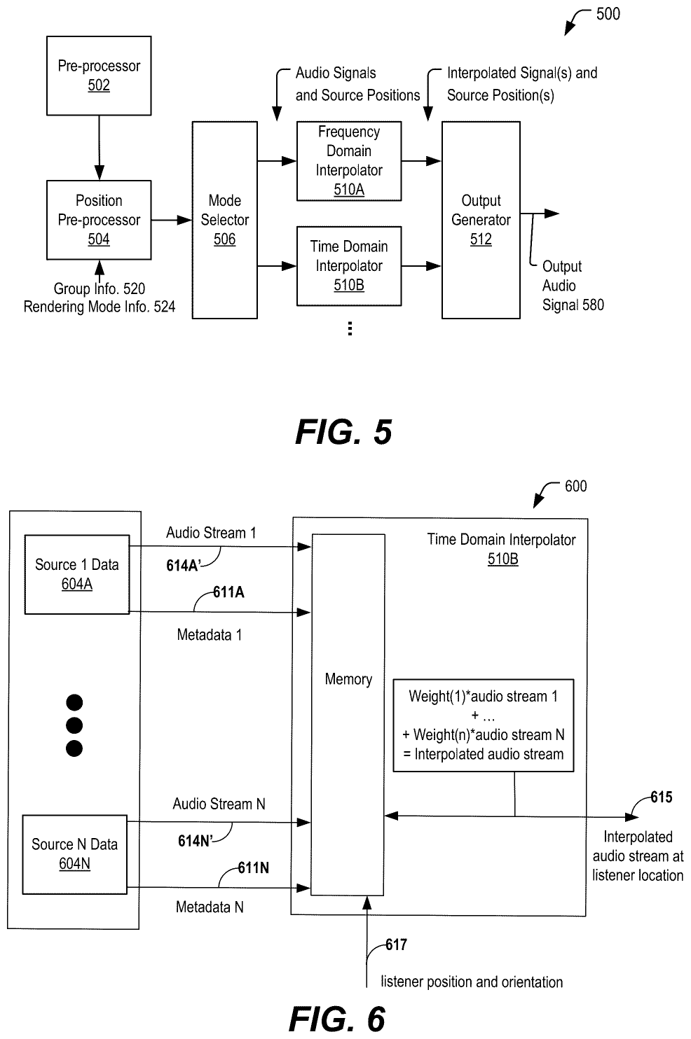

FIG. 5 depicts an example of components 500 that may be implemented in the one or more processors 150, such as in the renderer 170. The components 500 include a pre-processor 502, a position pre-processor 504, a mode selector 506, multiple interpolators including a frequency domain interpolator 510A and a time domain interpolator 510B, and an output generator 512.

The pre-processor 502 can be configured to perform operations such as generating a representation of audio source locations (e.g., based on the source position information 122), such as via triangulation of the source space that generates a set of triangles having an audio source at each triangle vertex. The pre-processor 502 can also generate head related transfer functions (HRTFs), obtain conversion parameters, such as an ambisonics to binaural conversion matrix, etc.

The position pre-processor 504 can be configured to determine interpolation weights, such as based on the listener position 196 and the audio source positions, to control signal and spatial metadata interpolation. The position pre-processor 504 may determine a location of the listener relative to the representation of the audio source locations (e.g., identify which triangle of the set of triangles the listener is located in) and may determine which audio sources are to be used for signal interpolation. The position pre-processor 504 can identify one or more audio sources for rendering based on the listener's position, the audio source positions, and audio source group information 520 (e.g., the group assignment information 130 or the group assignment information 160), and may determine which rendering mode to use for each group of audio sources based on rendering mode information 524 (e.g., the rendering mode information 134 or the rendering mode information 164).

The mode selector 506 receives an indication of selected audio sources to render and which rendering mode is to be used for the selected audio sources and provides audio signals and source positions to the frequency domain interpolator 510A when one or more of the selected audio sources are to be rendered using frequency domain interpolation (e.g., the first mode 172), to the time domain interpolator 510B when one or more of the selected audio sources are to be rendered using time domain interpolation (e.g., the second mode 174), or both.

In a particular implementation, the frequency domain interpolator 510A is configured to interpolate the received audio signals and source positions in a time-frequency domain (e.g., using a short-time Fourier transform of one or more frames or sub-frames of the audio signals) that includes performing interpolations for each of multiple frequency bins to generate an interpolated signal and source position.

In a particular implementation, the time domain interpolator 510B is configured to interpolate the received audio signals and source positions in a time domain, such as described further with reference to FIG. 6, to generate an interpolated signal and source position.

The output generator 512 is configured to receive interpolated signals and source positions from one or more of the interpolators 510 and to process the interpolated signals and source positions to generate an output audio signal 580 (e.g., the output audio signal 180). In an illustrative, non-limiting example, the output generator 512 can be configured to apply one or more rotation operations based on an orientation of each interpolated signal and the listener's orientation; to binauralize the signals using the HRTFs; if multiple interpolated signals are received, to combine the signals (e.g., after binauralization); to perform one or more other operations; or any combination thereof, to generate the output audio signal 580.

FIG. 6 depicts an example of components 600 associated with audio rendering according to a low-complexity rendering mode in which distance-weighted time domain interpolation is performed.

In the example of FIG. 6, the time domain interpolator 510B receives audio data 604 from multiple audio sources, including audio data 604A-604N from audio sources 1-N, respectively. The audio data 604 includes ambisonic audio streams 614′ (shown as “ambisonic streams 614′”), which were captured by one or more microphones (which may represent clusters or arrays of microphones). The signals output by the one or more microphones may undergo a conversion from the microphone format to the HOA format, resulting in the ambisonic audio streams 614′.

The time domain interpolator 510B may also receive audio metadata 611A-611N (“audio metadata 611”), which may include a microphone location identifying a location of a corresponding microphone that captured the corresponding one of the audio streams 614′. The one or more microphones may provide the microphone location, an operator of the one or more microphones may enter the microphone locations, a device coupled to the microphone (e.g., the audio streaming device 102 or a content capture device) may specify the microphone location, or some combination of the foregoing. The audio streaming device 102 may specify the audio metadata 611 as part of the bitstream 106. In any event, the time domain interpolator 510B may parse the audio metadata 611 from the bitstream 106.

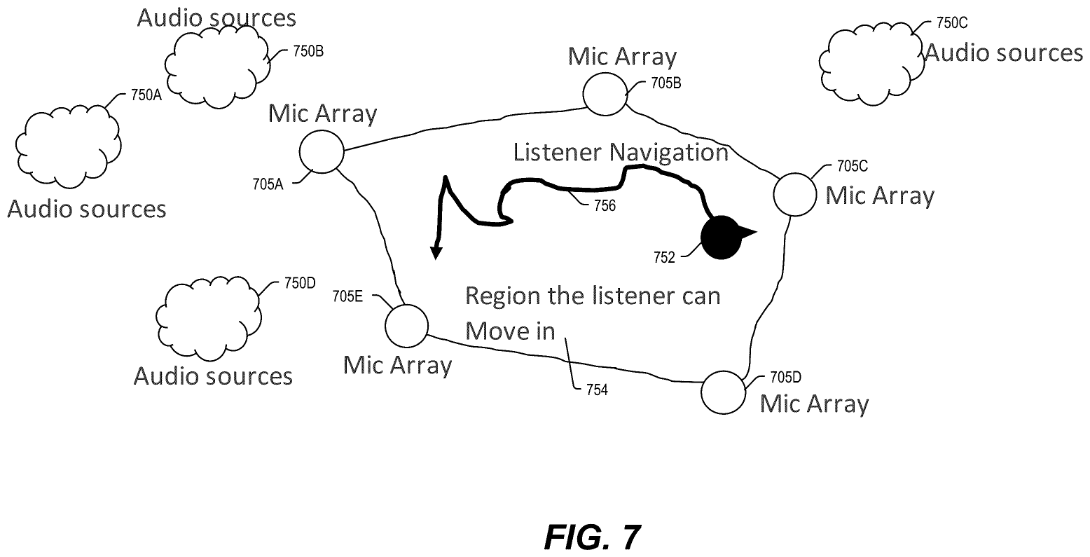

The time domain interpolator 510B may also obtain a listener location 617 (e.g., the listener position 196) that identifies a location of a listener, such as that shown in the example of FIG. 7. The audio metadata may specify a location and an orientation of the microphone, or only a microphone location. Further, the listener location 617 may include a listener position (or, in other words, location) and an orientation, or only a listener location. Referring briefly back to FIG. 1, the audio playback device 104 may interface with the sensor(s) 184 to obtain the listener location 617. The sensor(s) 184 may represent any device capable of tracking the listener, and may include one or more of a global positioning system (GPS) device, a camera, a sonar device, an ultrasonic device, an infrared emitting and receiving device, or any other type of device capable of obtaining the listener location 617.

The time domain interpolator 510B may next perform interpolation, based on the one or more microphone locations and the listener location 617, with respect to the audio streams 614′ to obtain an interpolated audio stream 615. The audio streams 614′ may be stored in a memory of the time domain interpolator 510B. To perform the interpolation, the time domain interpolator 510B may read the audio streams 614′ from the memory and determine, based on the one or more microphone locations and the listener location 617 (which may also be stored in the memory), a weight for each of the audio streams (which are shown as Weight(1) . . . Weight(n)).

To determine the weights, the time domain interpolator 510B may calculate each weight as a ratio of inverse distance to the listener location 617 for the corresponding one of the audio streams 614′ by the total inverse distance from all of the other audio streams 614′, except for the edge cases when the listener is at the same location as one of the one or more microphones as represented in the virtual world. That is to say, it may be possible for a listener to navigate a virtual world, or a real world location represented on a display of a device, which has the same location as where one of the one or more microphones captured the audio streams 614′. When the listener is at the same location as one of the one or more microphones, the time domain interpolator 510B may calculate the weight for the one of the audio streams 614′ captured by the one of the one or more microphones at which the listener is at the same location as one of the one or more microphones, and the weights for the remaining audio streams 614′ are set to zero.

Otherwise, the time domain interpolator 510B may calculate each weight as follows:
Weight(n)=(1/(distance of mic n to the listener position))/(1/(distance of mic 1 to the listener position)+ . . . +1/(distance of mic n to the listener position)),

In the above, the listener position refers to the listener location 617, Weight(n) refers to the weight for the audio stream 614N′, and the distance of mic <number> to the listener position refers to the absolute value of the difference between the corresponding microphone location and the listener location 617.

The time domain interpolator 510B may next multiply the weight by the corresponding one of the audio streams 614′ to obtain one or more weighted audio streams, which the time domain interpolator 510B may add together to obtain the interpolated audio stream 615. The foregoing may be denoted mathematically by the following equation:
Weight(1)*audio stream 1+ . . . + Weight(n)*audio stream n=Interpolated audio stream,
where Weight(<number>) denotes the weight for the corresponding audio stream <number>, and the interpolated audio stream refers to the interpolated audio stream 615. The interpolated audio stream may be stored in the memory of the time domain interpolator 510B and may also be available to be played out by loudspeakers (e.g., a VR or AR device or a headset worn by the listener). The interpolation equation represents the weighted average ambisonic audio shown in the example of FIG. 6. It should be noted that it may be possible in some configuration to interpolate non-ambisonic audio streams; however, there may be a loss of audio quality or resolution if the interpolation is not performed on ambisonic audio data.

In some examples, the time domain interpolator 510B may determine the foregoing weights on a frame-by-frame basis. In other examples, the time domain interpolator 510B may determine the foregoing weights on a more frequent basis (e.g., some sub-frame basis) or on a more infrequent basis (e.g., after some set number of frames). In some examples, the time domain interpolator 510B may only calculate the weights responsive to detection of some change in the listener location and/or orientation or responsive to some other characteristics of the underlying ambisonic audio streams (which may enable and disable various aspects of the interpolation techniques described in this disclosure).

In some examples, the above techniques may only be enabled with respect to the audio streams 614′ having certain characteristics. For example, the time domain interpolator 510B may only interpolate the audio streams 614′ when audio sources represented by the audio streams 614′ are located at locations different than the one or more microphones. More information regarding this aspect of the techniques is provided below with respect to FIG. 7.

FIG. 7 is a diagram illustrating, in more detail, how the audio playback device 104 may perform various aspects of the techniques described in this disclosure. As shown in FIG. 7, the listener 752 may progress within the area 754 defined by the microphones (shown as “mic arrays”) 705A-705E. In some examples, the one or more microphones (including when the one or more microphones represent clusters or, in other words, arrays of microphones) may be positioned at a distance from one another that is greater than five feet. In any event, the time domain interpolator 510B (referring to FIG. 6) may perform the interpolation when sound sources 750A-750D (“sound sources 750” or “audio sources 750” as shown in FIG. 7) are outside of the area 754 defined by the microphones 705A-705E given mathematical constraints imposed by the equations discussed above.

Returning to the example of FIG. 7, the listener 752 may enter or otherwise issue one or more navigational commands (potentially by walking or through use of a controller or other interface device, including smart phones, etc.) to navigate within the area 754 (along the line 756). A tracking device (such as the sensor(s) 184) may receive these navigational commands and generate the listener location 617.

As the listener 752 starts navigating from the starting location, the time domain interpolator 510B may generate the interpolated audio stream 615 to heavily weight the audio stream 614C′ captured by the microphone 705C, and assign relatively less weight to the audio stream 614B′ captured by the microphone 705B and the audio stream 614D′ captured by the microphone 705D, and still relatively less weight (and possibly no weight) to the audio streams 614A′ and 615E′ captured by the respective microphones 705A and 705E.

As the listener 752 navigates along the line 756 next to the location of the microphone 705B, the time domain interpolator 510B may assign more weight to the audio stream 614B′, relatively less weight to the audio stream 614C′ and yet less weight (and possibly no weight) to the audio streams 614A′, 614D′, and 614E′. As the listener 752 navigates (where the notch indicates the direction in which the listener 752 is moving) closer to the location of the microphone 705E toward the end of the line 756, the time domain interpolator 510B may assign more weight to the audio stream 614E′, relatively less weight to the audio stream 614A′, and yet relatively less weight (and possibly no weight) to the audio streams 614B′, 614C′, and 614D′.

In this respect, the time domain interpolator 510B may perform interpolation based on changes to the listener location 617 based on navigational commands issued by the listener 752 to assign varying weights over time to the audio streams 614A′-614E′. The changing listener location 617 may result in different emphasis within the interpolated audio stream 615, thereby promoting better auditory localization within the area 754.

Although not described in the examples set forth above, the techniques may also adapt to changes in the location of the microphones. In other words, the microphones may be manipulated during recording, changing locations and orientations. In some implementations, one or more of the microphones 705 may represent microphones of one or more wearable devices, such as VR or AR headsets. Because the above noted equations are only concerned with differences between the microphone locations and the listener location 617, the time domain interpolator 510B may continue to perform the interpolation even though the microphones have been manipulated to change location and/or orientation.

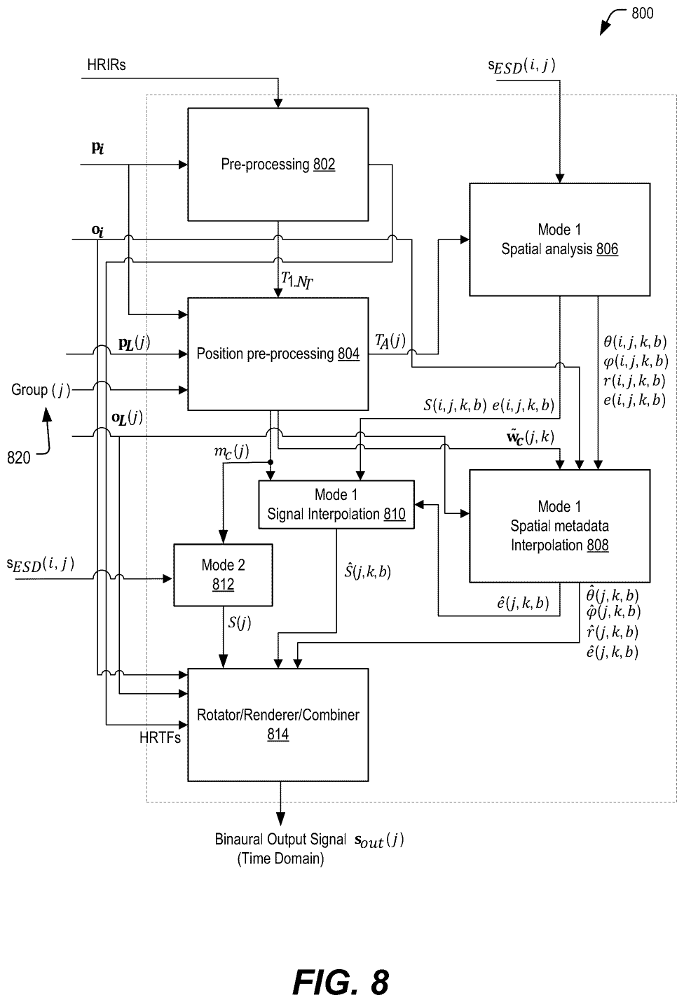

FIG. 8 depicts an example of components 800 that may be implemented in the renderer 170, including a pre-processing module 802, a position pre-processing module 804, a Mode 1 spatial analysis module 806, a Mode 1 spatial metadata interpolation module 808, a Mode 1 signal interpolation module 810, a Mode 2 module 812, and a rotator/renderer/combiner module 814. In a particular implementation, the components are configured to generate a binaural output signal sₒᵤₜ(j) based on processing ambisonics representations of audio signals.

The pre-processing module 802 is configured to receive head-related impulse response information (HRIRs) and audio source position information pi (where boldface lettering indicates a vector, and where i is an audio source index), such as (x, y, z) coordinates of the location of each audio source in an audio scene. The pre-processing module 802 is configured to generate HRTFs and a representation of the audio source locations as a set of triangles T_{1 . . . NT} (where N_{T} denotes the number of triangles) having an audio source at each triangle vertex. In a particular implementation, the pre-processing module 802 corresponds to the pre-processor 502 of FIG. 5.

The position pre-processing module 804 is configured to receive the representation of the audio source locations T_{1 . . . NT}, the audio source position information pᵢ, listener position information p_{L}(j) (e.g., x, y, z coordinates) that indicates a listener location for a frame j of the audio data to be rendered, and group information Group(j) 820. For example, the group information 820 can include or correspond to the group information 520, the rendering mode information 524, or both. The position pre-processing module 804 is configured to generate an indication of the location of the listener relative to the audio sources, such as an active triangle T_{A}(j), of the set of triangles, that includes the listener location; an audio source selection indication m_{C}(j) (e.g., an index of a chosen HOA source for signal interpolation); and spatial metadata interpolation weights \tilde{w}_{c}(j, k) (e.g., chosen spatial metadata interpolation weights for a subframe k of frame j). In a particular implementation, the position pre-processing module 804 corresponds to the position pre-processor 504 and the mode selector 506 of FIG. 5.

The Mode 1 spatial analysis module 806, the Mode 1 spatial metadata interpolation module 808, and the Mode 1 signal interpolation module 810 are associated with rendering according to a first mode (Mode 1) corresponding to a baseline rendering mode in which signal processing, source direction analysis, and source interpolation are performed in a frequency domain. The Mode 2 module 812 is associated with rendering according to a second mode (Mode 2) corresponding to a low-complexity rendering mode in which distance-weighted time domain interpolation is performed. In a particular implementation, Mode 1 corresponds to the first mode 172 and Mode 2 corresponds to the second mode 174 of FIG. 1. Selection of Mode 1 or Mode 2 as the rendering mode is performed by the position pre-processing module 804. In the case of a single group of audio sources, the associated audio stream signals and metadata are routed for processing to either the Mode 1 modules 806-810 or to the Mode 2 module 812. In some implementations, module(s) of unused modes are deactivated, reducing power consumption associated with rendering. In the case of multiple groups of audio sources, the position pre-processing module 804 routes the corresponding audio signals and metadata to the corresponding mode rendering modules. In some implementations, the position pre-processing module 804 is further configured to break up the defined groups into sub-groups based on threshold(s) and assign a rendering mode to each sub-group, such described previously with reference to the spacing-based source grouping 154 and the group-based rendering mode assignment 162 and as explained in further detail with reference to FIGS. 9-11.

For Mode 1 processing, the Mode 1 spatial analysis module 806 receives the audio signals of the audio streams, illustrated s_{ESD}(i,j) (e.g., an equivalent spatial domain representation of the signals for each source i and frame j) and also receives the indication of the location of the active triangle T_{A}(j) that includes the listener. The Mode 1 spatial analysis module 806 can convert the input audio signals to an HOA format and generates orientation information for the HOA sources (e.g., θ(i, j, k, b) representing an azimuth parameter for HOA source i for sub-frame k of frame j and frequency bin b, and φ(i, j, k, b) representing an elevation parameter) and energy information (e.g., r(i, j, k, b) representing a direct-to-total energy ratio parameters and e(i, j, k, b) representing an energy value). The Mode 1 spatial analysis module 806 also generates a frequency domain representation of the input audio, such as S(i, j, k, b) representing a time-frequency domain signal of HOA source i.

The Mode 1 spatial metadata interpolation module 808 performs spatial metadata interpolation based on source orientation information oi, listener orientation information oi, the HOA source orientation information and energy information from the Mode 1 spatial analysis module 806, and the spatial metadata interpolation weights from the position pre-processing module 804. The Mode 1 spatial metadata interpolation module 808 generates energy and orientation information including \tilde{e} (i, j, b) representing an average (over sub-frames) energy for HOA source i and audio frame j for frequency band b, \tilde{θ}(i, j, b) representing an azimuth parameter for HOA source i for frame j and frequency bin b, @(i, j, b) representing an elevation parameter for HOA source i for frame j and frequency bin b, and ř(i, j, b) representing an direct-to-total energy ratio parameter for HOA source i for frame j and frequency bin b.

The Mode 1 signal interpolation module 810 receives energy information (e.g., \tilde{e}(i, j, b)) from the mode 1 spatial metadata interpolation module 808, energy information (e.g., e(i, j, k, b)) and a frequency domain representation of the input audio (e.g., S(i, j, k, b)) from the Mode 1 spatial analysis module 806. And the audio source selection indication m_{C}(j) from the position pre-processing module 804. The Mode 1 signal interpolation module 810 generates an interpolated audio signal Ś(j, k).

The Mode 2 module 812 receives the audio signals of the audio streams (e.g., s_{ESD}(i,j)) and the audio source selection indication m_{C}(j) from the position pre-processing module 804. The Mode 2 module 812 performs time domain interpolation to generate an interpolated output signal S(j). In a particular implementation, the Mode 2 module 812 includes or corresponds to the time domain interpolator 510B of FIG. 5.

The rotator/renderer/combiner module 814 receives the source orientation information oi, the listener orientation information oi, the HRTFs, the Mode 2 interpolated output signal S(j) (if generated), and the Mode 1 interpolated audio signal Ŝ(j,k) and interpolated orientation and energy parameters (if generated) from the Mode 1 signal interpolation module 810 and the Mode 1 spatial metadata interpolation module 808, respectively. The rotator/renderer/combiner module 814 is configured to configured to apply one or more rotation operations based on an orientation of each interpolated signal and the listener's orientation; to binauralize the signals using the HRTFs; if multiple interpolated signals are received, to combine the signals (e.g., after binauralization); to perform one or more other operations; or any combination thereof, to generate the output audio signal Sₒᵤₜ(j). In a particular implementation, the rotator/renderer/combiner module 814 corresponds to the output generator 512 of FIG. 5.

FIG. 9 depicts an example 900 of operations that may be performed at a spatial data encoder and decoder, such as at the audio streaming device 102 and the audio playback device 104, respectively, and that illustrate a scenario in which the decoder may perform subgrouping of one or more audio source groups received from the encoder.

In the example 900, the encoder performs grouping based on which sounds are sampled by each audio source, such as described with respect to the sound type-based source grouping 224 of FIG. 2B and FIG. 2C. The encoder determines that four audio sources, labelled A, B, C, and D, each sample sounds of a campfire. The encoder generates a group data structure 902 for a group with GroupID=X that includes the sources A, B, C, and D. The encoder does not assign a rendering mode to group X. A group assignment data structure 908 (e.g., a table) illustrates that each of the sources A, B, C, and D is assigned to the group X.

The encoder sends group assignment data corresponding to group X to the decoder, such as via the bitstream 106. The decoder processes the group assignment data, at operation 910, and determines that sources A and B are to be rendered using a low-complexity (“LC”) rendering mode and that sources C and D are to be rendered using a baseline (“BL”) rendering mode. To illustrate, the operation 910 can correspond to the audio playback device 104 performing the spacing-based source grouping 154 to determine that sources A and B satisfy the source spacing condition 156 (and can therefore be rendered using the second mode 174), and that sources C and D do not satisfy the source spacing condition 156 (and should therefore be rendered using the first mode 172).

The decoder regroups the sources A-D from group X by generating two subgroups, group Y and group Z, assigns the sources A, B and the low-complexity rendering mode to group Y, and assigns the sources C, D and the baseline rendering mode to group Y. The decoder may generate group data structures 914, 916 showing results of the regrouping based on the updated group assignment information 160 and the rendering mode information 164 resulting from the spacing-based source grouping 154 and the group-based rendering mode assignment 162, respectively, of FIG. 2A. In some implementations the decoder also updates the received group assignment information to indicate that group Y and group Z are subgroups of group X, illustrated as subgroup identifiers, pointers, links, or other references to group Y and group Z inserted into an updated group data structure 912 for group X. In other implementations, the decoder updates the received group assignment information by removing group X and adding groups Y and Z to the group assignment information 160.

In some implementations, the decoder generates an updated group assignment data structure 918 indicating that sources A and B are in group Y and assigned to the low-complexity rendering mode and that sources C and D are in group Z and assigned to the baseline rendering mode.

FIG. 10 depicts another example 1000 of operations that may be performed at a spatial data encoder and decoder, such as at the audio streaming device 102 and the audio playback device 104, respectively, and that illustrate a scenario in which the decoder may perform subgrouping of one or more audio source groups received from the encoder.

In the example 1000, the encoder performs audio source grouping as described with respect to spacing-based source grouping 124 of FIG. 1 and FIG. 2A. The encoder may perform the spacing-based source grouping 124 using a source spacing condition 126 that corresponds to a first threshold, such as a distance of 1.5 meters. The encoder determines that, using the first threshold, sources A, B, C, and D should be rendered using a baseline rendering mode. The encoder generates a group data structure 1002 for a group with GroupID=X that includes sources A, B, C, and D and is assigned the baseline rendering mode. A group assignment data structure 1008 illustrates that each of sources A, B, C, and D is assigned to the group X and the baseline rendering mode.

The encoder sends group assignment data corresponding to group X to the decoder, such as via the bitstream 106. The decoder processes the group assignment data, at operation 1010, using a second threshold (e.g., 2 meters) that is different than the first threshold used by the encoder (e.g.. 1.5 meters) and determines that sources A and B are to be rendered using the low-complexity rendering mode and that sources C and D are to be rendered using the baseline rendering mode.

The decoder regroups sources A, B, C, and D from group X by generating two subgroups, group Y and group Z, assigns the sources A, B and the low-complexity rendering mode to group Y, and assigns the sources C, D and the baseline rendering mode to group Z. The decoder may generate group data structures 1014, 1016 showing results of the regrouping based on the updated group assignment information 160 and the rendering mode information 164 resulting from performing the spacing-based source grouping 154 (using the second threshold) and the group-based rendering mode assignment 162, respectively, of FIG. 2A. In some implementations the decoder also updates the received group assignment information to include subgroup references to group Y and group Z into an updated group data structure 1012 for group X. In other implementations, the decoder updates the received group assignment information by removing group X and adding groups Y and Z to the group assignment information 160.

In some implementations, the decoder generates an updated group assignment data structure 1018 indicating that sources A and B are in group Y and assigned to the low-complexity rendering mode and that sources C and D are in group Z and assigned to the baseline rendering mode.

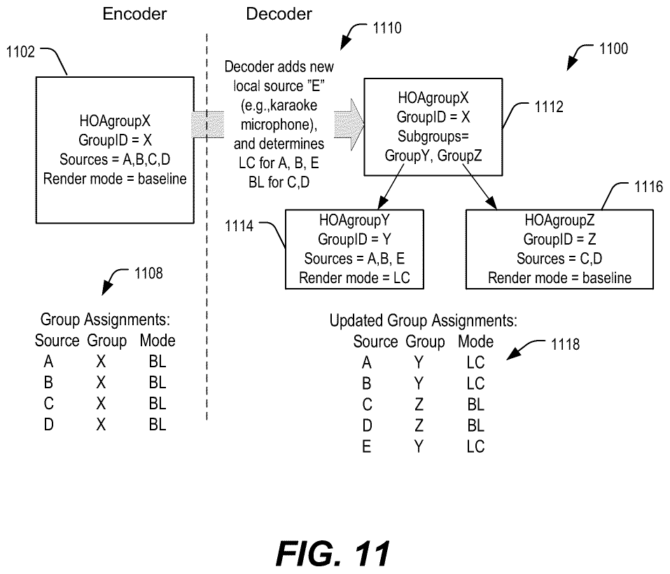

FIG. 11 depicts another example 1100 of operations that may be performed at a spatial data encoder and decoder, such as at the audio streaming device 102 and the audio playback device 104, respectively, and that illustrate a scenario in which the decoder may perform subgrouping of one or more audio source groups received from the encoder.

In the example 1100, the encoder performs grouping of audio sources A, B, C, and D, such as described with respect to spacing-based source grouping 124 of FIG. 1 and FIG. 2A. The encoder may perform the spacing-based source grouping 124 and determine that sources A, B, C, and D should be rendered using a baseline rendering mode. The encoder generates a group data structure 1102 for a group with GroupID=X that includes sources A, B, C, and D and that is assigned the baseline rendering mode. A group assignment data structure 1108 illustrates that each of the sources A, B, C, and D is assigned to the group X and the baseline rendering mode.

The encoder sends group assignment data corresponding to group X to the decoder, such as via the bitstream 106. The decoder also receives an audio stream and source metadata for another source E that was not known to the encoder, such as the additional audio stream 214 of FIG. 2A. The decoder performs the spacing-based source grouping 154 of the sources A-E and determines that sources A, B, and E are to be rendered using a low-complexity rendering mode and that sources C and D are to be rendered using a baseline rendering mode. For example, the source E may be located between sources A and B, which reduces the distance between source A and its nearest neighbor (source E) and the distance between source B and its nearest neighbor (source E) so that sources A, B, and E now satisfy the distance threshold used to assign the low-complexity rendering mode.

The decoder regroups the sources A-D from group X by generating two subgroups, group Y and group Z, assigns the sources A, B, E, and the low-complexity rendering mode to group Y, and assigns the sources C, D and the baseline rendering mode to group Z. The decoder may generate group data structures 1114, 1116 showing results of the regrouping and based on the updated group assignment information 160 and the rendering mode information 164. In some implementations the decoder also updates the received group assignment information to include subgroup references to group Y and group Z into an updated group data structure 1112 for group X. In other implementations, the decoder updates the received group assignment information by removing group X and adding groups Y and Z to the group assignment information 160.

In some implementations, the decoder generates an updated group assignment data structure 1118 indicating that sources A, B, and E are in group Y and assigned to the low-complexity rendering mode and that sources C and D are in group Z and assigned to the baseline rendering mode.

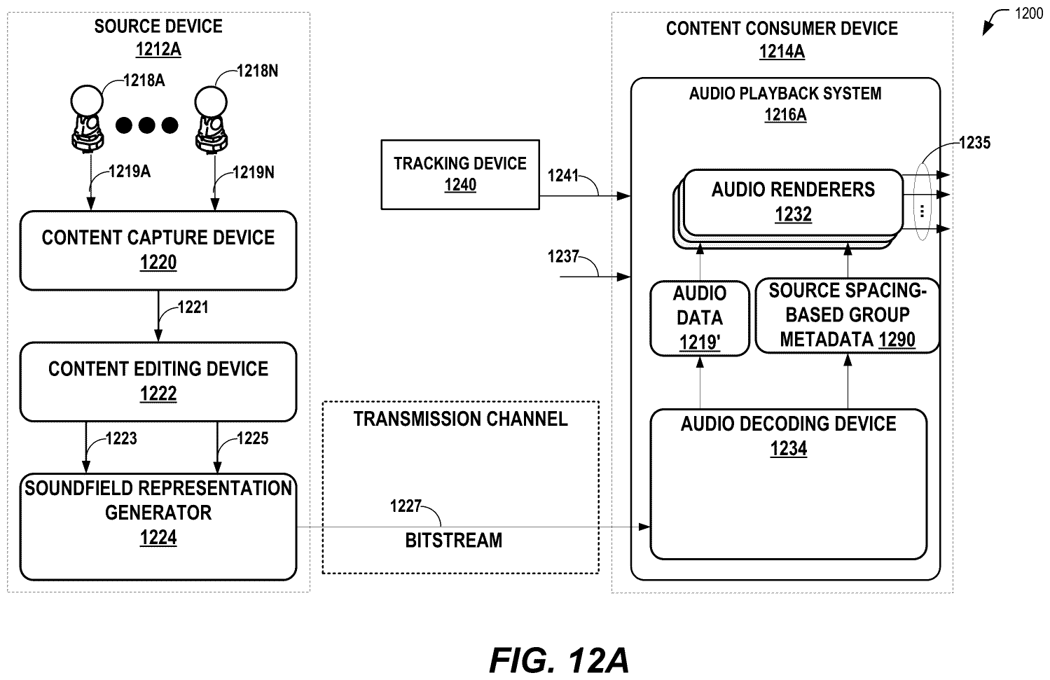

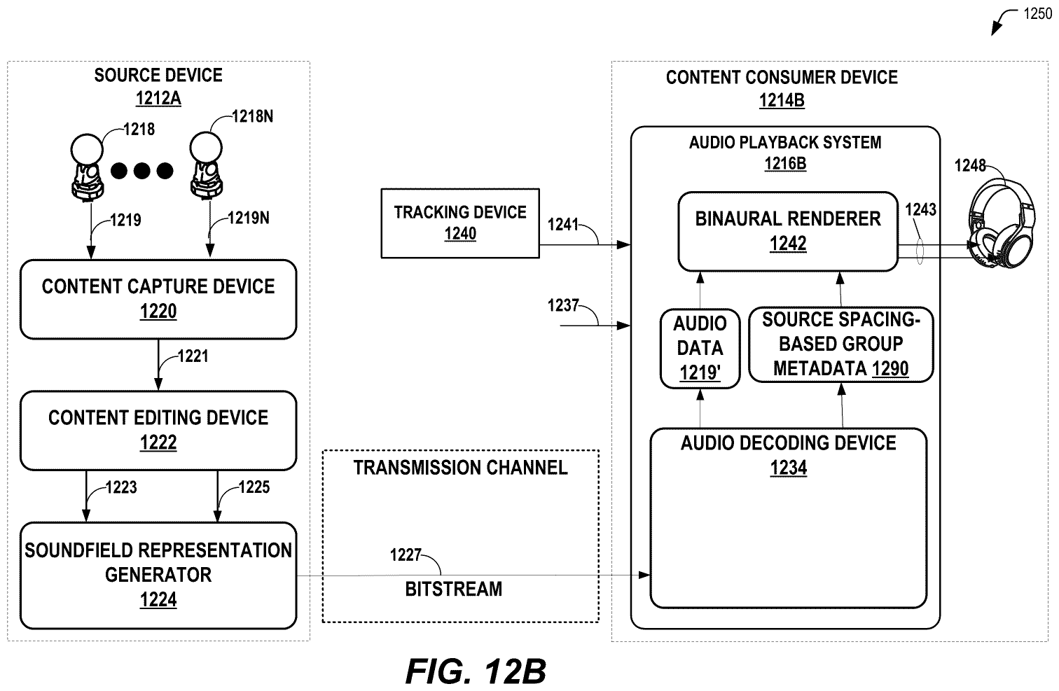

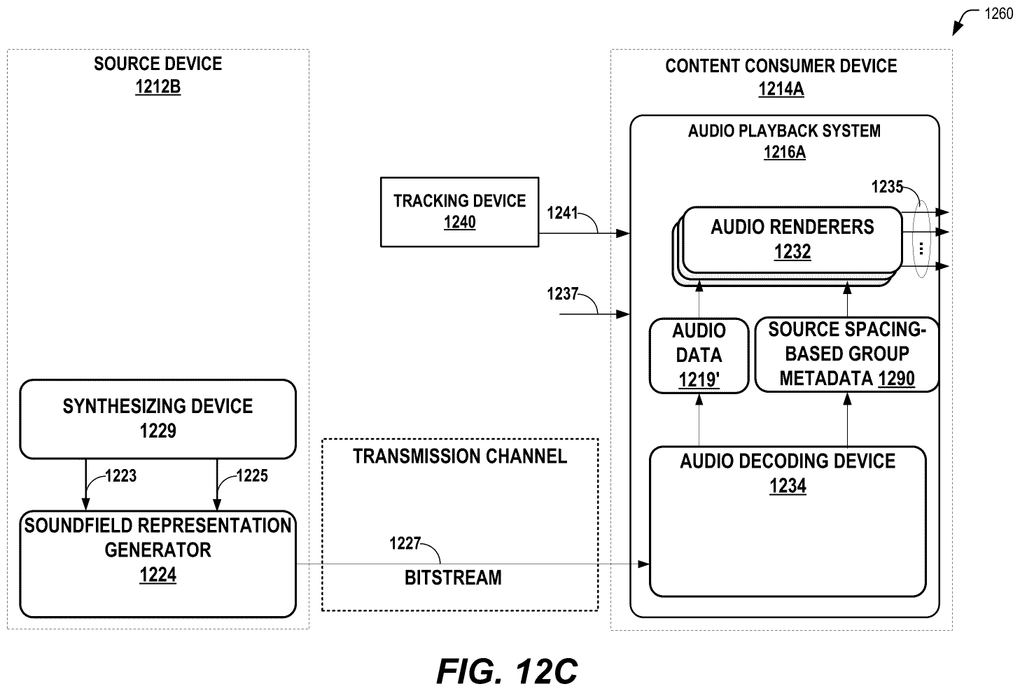

FIGS. 12A-12C are diagrams illustrating systems that may perform various aspects of the techniques described in this disclosure. As shown in the example of FIG. 12A, system 1200 includes a source device 1212A and a content consumer device 1214A. While described in the context of the source device 1212A and the content consumer device 1214A, the techniques may be implemented in any context in which any representation of a soundfield is encoded to form a bitstream representative of the audio data. Moreover, the source device 1212A may represent any form of computing device capable of generating the representation of a soundfield, and is generally described herein in the context of being a VR content creator device. Likewise, the content consumer device 1214A may represent any form of computing device capable of implementing rendering techniques described in this disclosure as well as audio playback, and is generally described herein in the context of being a VR client device.

The source device 1212A may be operated by an entertainment company or other entity that may generate multi-channel audio content for consumption by operators of content consumer devices, such as the content consumer device 1214A. In some VR scenarios, the source device 1212A generates audio content in conjunction with video content. The source device 1212A includes a content capture device 1220, a content editing device 1222, and a soundfield representation generator 1224. The content capture device 1220 may be configured to interface or otherwise communicate with one or more microphones 1218A-1218N.

The microphones 1218 may represent an Eigenmike® or other type of 3D audio microphone capable of capturing and representing the soundfield as audio data 1219A-1219N, which may refer to one or more of the above noted scene-based audio data (such as ambisonic coefficients), object-based audio data, and channel-based audio data. Although described as being 3D audio microphones, the microphones 1218 may also represent other types of microphones (such as omni-directional microphones, spot microphones, unidirectional microphones, etc.) configured to capture the audio data 1219. In the context of scene-based audio data 1219 (which is another way to refer to the ambisonic coefficients), each of the microphones 1218 may represent a cluster of microphones arranged within a single housing according to set geometries that facilitate generation of the ambisonic coefficients. As such, the term microphone may refer to a cluster of microphones (which are actually geometrically arranged transducers) or a single microphone (which may be referred to as a spot microphone).

The content capture device 1220 may, in some examples, include one or more integrated microphones 1218 that is integrated into the housing of the content capture device 1220. The content capture device 1220 may interface wirelessly or via a wired connection with the microphones 1218. Rather than capture, or in conjunction with capturing, the audio data 1219 via the microphones 1218, the content capture device 1220 may process the audio data 1219 after the audio data 1219 is input via some type of removable storage, wirelessly and/or via wired input processes. As such, various combinations of the content capture device 1220 and the microphones 1218 are possible in accordance with this disclosure.

The content capture device 1220 may also be configured to interface or otherwise communicate with the content editing device 1222. In some instances, the content capture device 1220 may include the content editing device 1222 (which in some instances may represent software or a combination of software and hardware, including the software executed by the content capture device 1220 to configure the content capture device 1220 to perform a specific form of content editing). The content editing device 1222 may represent a unit configured to edit or otherwise alter the content 1221 received from the content capture device 1220, including the audio data 1219. The content editing device 1222 may output edited content 1223 and associated audio information 1225, such as metadata, to the soundfield representation generator 1224.

The soundfield representation generator 1224 may include any type of hardware device capable of interfacing with the content editing device 1222 (or the content capture device 1220). Although not shown in the example of FIG. 12A, the soundfield representation generator 1224 may use the edited content 1223, including the audio data 1219 and the audio information 1225, provided by the content editing device 1222 to generate one or more bitstreams 1227. In the example of FIG. 12A, which focuses on the audio data 1219, the soundfield representation generator 1224 may generate one or more representations of the same soundfield represented by the audio data 1219 to obtain a bitstream 1227 that includes the representations of the edited content 1223 and the audio information 1225. In a particular implementation, the source device 1212A corresponds to the audio streaming device 102 and performs the spacing-based source grouping 124 (and optionally the group-based rendering mode assignment 132), such as at the soundfield representation generator 1224, to generate source spacing-based group metadata 1290 (e.g., the group assignment information 130 and optionally the rendering mode information 134). The spacing-based group metadata 1290 may be sent to the content consumer device 1214A via the bitstream 1227 (which may correspond to the bitstream 106).

In an example, to generate the different representations of the soundfield using ambisonic coefficients (which again is one example of the audio data 1219), the soundfield representation generator 1224 may use a coding scheme for ambisonic representations of a soundfield, referred to as Mixed Order Ambisonics (MOA) as discussed in more detail in U.S. application Ser. No. 15/672,058, entitled “MIXED-ORDER AMBISONICS (MOA) AUDIO DATA FOR COMPUTER-MEDIATED REALITY SYSTEMS,” filed Aug. 8, 2017, and published as U.S. patent publication no. 20190007781 on Jan. 3, 2019.

To generate a particular MOA representation of the soundfield, the soundfield representation generator 1224 may generate a partial subset of the full set of ambisonic coefficients. For instance, each MOA representation generated by the soundfield representation generator 1224 may provide precision with respect to some areas of the soundfield, but less precision in other areas. In one example, an MOA representation of the soundfield may include eight (8) uncompressed ambisonic coefficients, while the third order ambisonic representation of the same soundfield may include sixteen (16) uncompressed ambisonic coefficients. As such, each MOA representation of the soundfield that is generated as a partial subset of the ambisonic coefficients may be less storage-intensive and less bandwidth intensive (if and when transmitted as part of the bitstream 1227 over the illustrated transmission channel) than the corresponding third order ambisonic representation of the same soundfield generated from the ambisonic coefficients.

Although described with respect to MOA representations, the techniques of this disclosure may also be performed with respect to first-order ambisonic (FOA) representations in which all of the ambisonic coefficients associated with a first order spherical basis function and a zero order spherical basis function are used to represent the soundfield. In other words, rather than represent the soundfield using a partial, non-zero subset of the ambisonic coefficients, the soundfield representation generator 1224 may represent the soundfield using all of the ambisonic coefficients for a given order N, resulting in a total of ambisonic coefficients equaling (N+1)².

In this respect, the ambisonic audio data (which is another way to refer to the ambisonic coefficients in either MOA representations or full order representation, such as the first-order representation noted above) may include ambisonic coefficients associated with spherical basis functions having an order of one or less (which may be referred to as “1^{st} order ambisonic audio data” or “FoA audio data”), ambisonic coefficients associated with spherical basis functions having a mixed order and suborder (which may be referred to as the “MOA representation” discussed above), or ambisonic coefficients associated with spherical basis functions having an order greater than one (which is referred to above as the “full order representation”).

In some examples, the soundfield representation generator 1224 may represent an audio encoder configured to compress or otherwise reduce a device 1220 of bits used to represent the content 1221 in the bitstream 1227. Although, while not shown, in some examples soundfield representation generator may include a psychoacoustic audio encoding device that conforms to any of the various standards discussed herein.

In this example, the soundfield representation generator 1224 may apply singular value decomposition (SVD) to the ambisonic coefficients to determine a decomposed version of the ambisonic coefficients. The decomposed version of the ambisonic coefficients may include one or more of predominant audio signals and one or more corresponding spatial components describing spatial characteristics, e.g., a direction, shape, and width, of the associated predominant audio signals. As such, the soundfield representation generator 1224 may apply the decomposition to the ambisonic coefficients to decouple energy (as represented by the predominant audio signals) from the spatial characteristics (as represented by the spatial components).

The soundfield representation generator 1224 may analyze the decomposed version of the ambisonic coefficients to identify various parameters, which may facilitate reordering of the decomposed version of the ambisonic coefficients. The soundfield representation generator 1224 may reorder the decomposed version of the ambisonic coefficients based on the identified parameters, where such reordering may improve coding efficiency given that the transformation may reorder the ambisonic coefficients across frames of the ambisonic coefficients (where a frame commonly includes M samples of the decomposed version of the ambisonic coefficients).

After reordering the decomposed version of the ambisonic coefficients, the soundfield representation generator 1224 may select one or more of the decomposed versions of the ambisonic coefficients as representative of foreground (or, in other words, distinct, predominant or salient) components of the soundfield. The soundfield representation generator 1224 may specify the decomposed version of the ambisonic coefficients representative of the foreground components (which may also be referred to as a “predominant sound signal,” a “predominant audio signal,” or a “predominant sound component”) and associated directional information (which may also be referred to as a “spatial component” or, in some instances, as a so-called “V-vector” that identifies spatial characteristics of the corresponding audio object). The spatial component may represent a vector with multiple different elements (which in terms of a vector may be referred to as “coefficients”) and thereby may be referred to as a “multidimensional vector.”

The soundfield representation generator 1224 may next perform a soundfield analysis with respect to the ambisonic coefficients in order to, at least in part, identify the ambisonic coefficients representative of one or more background (or, in other words, ambient) components of the soundfield. The background components may also be referred to as a “background audio signal” or an “ambient audio signal.” The soundfield representation generator 1224 may perform energy compensation with respect to the background audio signal given that, in some examples, the background audio signal may only include a subset of any given sample of the ambisonic coefficients (e.g., such as those corresponding to zero and first order spherical basis functions and not those corresponding to second or higher order spherical basis functions). When order-reduction is performed, in other words, the soundfield representation generator 1224 may augment (e.g., add/subtract energy to/from) the remaining background ambisonic coefficients of the ambisonic coefficients to compensate for the change in overall energy that results from performing the order reduction.

The soundfield representation generator 1224 may next perform a form of interpolation with respect to the foreground directional information (which is another way of referring to the spatial components) and then perform an order reduction with respect to the interpolated foreground directional information to generate order reduced foreground directional information. The soundfield representation generator 1224 may further perform, in some examples, a quantization with respect to the order reduced foreground directional information, outputting coded foreground directional information. In some instances, this quantization may comprise a scalar/entropy quantization possibly in the form of vector quantization. The soundfield representation generator 1224 may then output the intermediately formatted audio data as the background audio signals, the foreground audio signals, and the quantized foreground directional information, to in some examples a psychoacoustic audio encoding device.

In any event, the background audio signals and the foreground audio signals may comprise transport channels in some examples. That is, the soundfield representation generator 1224 may output a transport channel for each frame of the ambisonic coefficients that includes a respective one of the background audio signals (e.g., M samples of one of the ambisonic coefficients corresponding to the zero or first order spherical basis function) and for each frame of the foreground audio signals (e.g., M samples of the audio objects decomposed from the ambisonic coefficients). The soundfield representation generator 1224 may further output side information (which may also be referred to as “sideband information”) that includes the quantized spatial components corresponding to each of the foreground audio signals.

Collectively, the transport channels and the side information may be represented in the example of FIG. 12A as ambisonic transport format (ATF) audio data (which is another way to refer to the intermediately formatted audio data). In other words, the AFT audio data may include the transport channels and the side information (which may also be referred to as “metadata”). The ATF audio data may conform to, as one example, an HOA (Higher Order Ambisonic) Transport Format (HTF). More information regarding the HTF can be found in a Technical Specification (TS) by the European Telecommunications Standards Institute (ETSI) entitled “Higher Order Ambisonics (HOA) Transport Format,” ETSI TS 103 589 V1.1.1, dated June 2018 (2018-06). As such, the ATF audio data may be referred to as HTF audio data.

In the example where the soundfield representation generator 1224 does not include a psychoacoustic audio encoding device, the soundfield representation generator 1224 may then transmit or otherwise output the ATF audio data to a psychoacoustic audio encoding device (not shown). The psychoacoustic audio encoding device may perform psychoacoustic audio encoding with respect to the ATF audio data to generate a bitstream 1227. The psychoacoustic audio encoding device may operate according to standardized, open-source, or proprietary audio coding processes. For example, the psychoacoustic audio encoding device may perform psychoacoustic audio encoding (such as a unified speech and audio coder denoted as “USAC” set forth by the Moving Picture Experts Group (MPEG), the MPEG-H 3D audio coding standard, the MPEG-I Immersive Audio standard, or proprietary standards, such as AptX™ (including various versions of AptX such as enhanced AptX—E-AptX, AptX live, AptX stereo, and AptX high definition—AptX-HD), advanced audio coding (AAC), Audio Codec 3 (AC-3), Apple Lossless Audio Codec (ALAC), MPEG-4 Audio Lossless Streaming (ALS), enhanced AC-3, Free Lossless Audio Codec (FLAC), Monkey's Audio, MPEG-1 Audio Layer II (MP2), MPEG-1 Audio Layer III (MP3), Opus, and Windows Media Audio (WMA). The source device 1212A may then transmit the bitstream 1227 via a transmission channel to the content consumer device 1214.

The content capture device 1220 or the content editing device 1222 may, in some examples, be configured to wirelessly communicate with the soundfield representation generator 1224. In some examples, the content capture device 1220 or the content editing device 1222 may communicate, via one or both of a wireless connection or a wired connection, with the soundfield representation generator 1224. Via the connection between the content capture device 1220 and the soundfield representation generator 1224, the content capture device 1220 may provide content in various forms of content, which, for purposes of discussion, are described herein as being portions of the audio data 1219.

In some examples, the content capture device 1220 may leverage various aspects of the soundfield representation generator 1224 (in terms of hardware or software capabilities of the soundfield representation generator 1224). For example, the soundfield representation generator 1224 may include dedicated hardware configured to (or specialized software that when executed causes one or more processors to) perform psychoacoustic audio encoding.

In some examples, the content capture device 1220 may not include the psychoacoustic audio encoder dedicated hardware or specialized software and instead may provide audio aspects of the content 1221 in a non-psychoacoustic-audio-coded form. The soundfield representation generator 1224 may assist in the capture of content 1221 by, at least in part, performing psychoacoustic audio encoding with respect to the audio aspects of the content 1221.

The soundfield representation generator 1224 may also assist in content capture and transmission by generating one or more bitstreams 1227 based, at least in part, on the audio content (e.g., MOA representations and/or third order ambisonic representations) generated from the audio data 1219 (in the case where the audio data 1219 includes scene-based audio data). The bitstream 1227 may represent a compressed version of the audio data 1219 and any other different types of the content 1221 (such as a compressed version of spherical video data, image data, or text data).

The soundfield representation generator 1224 may generate the bitstream 1227 for transmission, as one example, across a transmission channel, which may be a wired or wireless channel, a data storage device, or the like. The bitstream 1227 may represent an encoded version of the audio data 1219, and may include a primary bitstream and another side bitstream, which may be referred to as side channel information or metadata. In some instances, the bitstream 1227 representing the compressed version of the audio data 1219 (which again may represent scene-based audio data, object-based audio data, channel-based audio data, or combinations thereof) may conform to bitstreams produced in accordance with the MPEG-H 3D audio coding standard and/or the MPEG-I Immersive Audio standard.

The content consumer device 1214A may be operated by an individual, and may represent a VR client device. Although described with respect to a VR client device, the content consumer device 1214A may represent other types of devices, such as an augmented reality (AR) client device, a mixed reality (MR) client device (or other XR client device), a standard computer, a headset, headphones, a mobile device (including a so-called smartphone), or any other device capable of tracking head movements and/or general translational movements of the individual operating the content consumer device 1214A. As shown in the example of FIG. 12A, the content consumer device 1214A includes an audio playback system 1216A, which may refer to any form of audio playback system capable of rendering the audio data for playback as multi-channel audio content.

While shown in FIG. 12A as being directly transmitted to the content consumer device 1214A, the source device 1212A may output the bitstream 1227 to an intermediate device positioned between the source device 1212A and the content consumer device 1214A. The intermediate device may store the bitstream 1227 for later delivery to the content consumer device 1214A, which may request the bitstream 1227. The intermediate device may comprise a file server, a web server, a desktop computer, a laptop computer, a tablet computer, a mobile phone, a smart phone, or any other device capable of storing the bitstream 1227 for later retrieval by an audio decoder. The intermediate device may reside in a content delivery network capable of streaming the bitstream 1227 (and possibly in conjunction with transmitting a corresponding video data bitstream) to subscribers, such as the content consumer device 1214A, requesting the bitstream 1227.

Alternatively, the source device 1212A may store the bitstream 1227 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to the channels by which content (e.g., in the form of one or more bitstreams 1227) stored to the mediums are transmitted (and may include retail stores and other store-based delivery mechanisms). In any event, the techniques of this disclosure should not therefore be limited in this respect to the example of FIG. 12A.

As noted above, the content consumer device 1214A includes the audio playback system 1216A. The audio playback system 1216A may represent any system capable of playing back multi-channel audio data. The audio playback system 1216A may include a number of different renderers 1232. The renderers 1232 may each provide for a different form of rendering, where the different forms of rendering may include one or more of the various ways of performing vector-base amplitude panning (VBAP), and/or one or more of the various ways of performing soundfield synthesis. As used herein, “A and/or B” means “A or B”, or both “A and B”.

The audio playback system 1216A may further include an audio decoding device 1234. The audio decoding device 1234 may represent a device configured to decode bitstream 1227 to output audio data 1219′ (where the prime notation may denote that the audio data 1219′ differs from the audio data 1219 due to lossy compression, such as quantization, of the audio data 1219). Again, the audio data 1219′ may include scene-based audio data that in some examples, may form the full first (or higher) order ambisonic representation or a subset thereof that forms an MOA representation of the same soundfield, decompositions thereof, such as a predominant audio signal, ambient ambisonic coefficients, and the vector based signal described in the MPEG-H 3D Audio Coding Standard, or other forms of scene-based audio data.

Other forms of scene-based audio data include audio data defined in accordance with an HOA Transport Format (HTF). More information regarding the HTF can be found in, as noted above, a Technical Specification (TS) by the European Telecommunications Standards Institute (ETSI) entitled “Higher Order Ambisonics (HOA) Transport Format,” ETSI TS 103 589 V1.1.1, dated June 2018 (2018-06), and also in U.S. Patent Publication No. 2019/0918028, entitled “PRIORITY INFORMATION FOR HIGHER ORDER AMBISONIC AUDIO DATA,” filed Dec. 20, 2018. In any event, the audio data 1219′ may be similar to a full set or a partial subset of the audio data 1219′, but may differ due to lossy operations (e.g., quantization) and/or transmission via the transmission channel.

The audio data 1219′ may include, as an alternative to, or in conjunction with the scene-based audio data, channel-based audio data. The audio data 1219′ may include, as an alternative to, or in conjunction with the scene-based audio data, object-based audio data. As such, the audio data 1219′ may include any combination of scene-based audio data, object-based audio data, and channel-based audio data.

The audio renderers 1232 of audio playback system 1216A may, after audio decoding device 1234 has decoded the bitstream 1227 to obtain the audio data 1219′, render the audio data 1219′ to output speaker feeds 1235. The speaker feeds 1235 may drive one or more speakers (which are not shown in the example of FIG. 12A for case of illustration purposes). Various audio representations, including scene-based audio data (and possibly channel-based audio data and/or object-based audio data) of a soundfield may be normalized in a number of ways, including N3D, SN3D, FuMa, N2D, or SN2D.

To select the appropriate renderer or, in some instances, generate an appropriate renderer, the audio playback system 1216A may obtain speaker information 1237 indicative of a number of speakers (e.g., loudspeakers or headphone speakers) and/or a spatial geometry of the speakers. In some instances, the audio playback system 1216A may obtain the speaker information 1237 using a reference microphone and may drive the speakers (which may refer to the output of electrical signals to cause a transducer to vibrate) in such a manner as to dynamically determine the speaker information 1237. In other instances, or in conjunction with the dynamic determination of the speaker information 1237, the audio playback system 1216A may prompt a user to interface with the audio playback system 1216A and input the speaker information 1237.

The audio playback system 1216A may select one of the audio renderers 1232 based on the speaker information 1237. In some instances, the audio playback system 1216A may, when none of the audio renderers 1232 are within some threshold similarity measure (in terms of the speaker geometry) to the speaker geometry specified in the speaker information 1237, generate the one of audio renderers 1232 based on the speaker information 1237. The audio playback system 1216A may, in some instances, generate one of the audio renderers 1232 based on the speaker information 1237 without first attempting to select an existing one of the audio renderers 1232.

In a particular implementation, the content consumer device 1214A corresponds to the audio playback device 104 and one or more of the audio renderers 1232 includes the renderer 170, the components illustrated in FIG. 5, the components illustrated in FIG. 8, or a combination thereof, which are responsive to a rendering mode selection 152 based on the source spacing-based group metadata 1290. In a particular implementation, the content consumer device 1214A receives the source spacing-based group metadata 1290 via the bitstream 1227, or performs the spacing-based source grouping 154 (and optionally the group-based rendering mode assignment 162), such as at the audio decoding device 1234, to generate the source spacing-based group metadata 1290 (e.g., the group assignment information 160 and optionally the rendering mode information 164), or both.

When outputting the speaker feeds 1235 to headphones, the audio playback system 1216A may utilize one of the renderers 1232 that provides for binaural rendering using head-related transfer functions (HRTF) or other functions capable of rendering to left and right speaker feeds 1235 for headphone speaker playback, such as binaural room impulse response renderers. The terms “speakers” or “transducer” may generally refer to any speaker, including loudspeakers, headphone speakers, bone-conducting speakers, earbud speakers, wireless headphone speakers, etc. One or more speakers may then playback the rendered speaker feeds 1235 to reproduce a soundfield.

Although described as rendering the speaker feeds 1235 from the audio data 1219′, reference to rendering of the speaker feeds 1235 may refer to other types of rendering, such as rendering incorporated directly into the decoding of the audio data 1219 from the bitstream 1227. An example of the alternative rendering can be found in Annex G of the MPEG-H 3D Audio standard, where rendering occurs during the predominant signal formulation and the background signal formation prior to composition of the soundfield. As such, reference to rendering of the audio data 1219′ should be understood to refer to both rendering of the actual audio data 1219′ or decompositions or representations thereof of the audio data 1219′ (such as the above noted predominant audio signal, the ambient ambisonic coefficients, and/or the vector-based signal—which may also be referred to as a V-vector or as a multi-dimensional ambisonic spatial vector).

The audio playback system 1216A may also adapt the audio renderers 1232 based on tracking information 1241. That is, the audio playback system 1216A may interface with a tracking information 1241 configured to track head movements and possibly translational movements of a user of the VR device. The tracking device 1240 may represent one or more sensors (e.g., a camera—including a depth camera, a gyroscope, a magnetometer, an accelerometer, light emitting diodes—LEDs, etc.) configured to track the head movements and possibly translation movements of a user of the VR device. The audio playback system 1216A may adapt, based on the tracking information 1241, the audio renderers 1232 such that the speaker feeds 1235 reflect changes in the head and possibly translational movements of the user to correct reproduce the soundfield that is responsive to such movements.

Content consumer device 1214A may represent an example device configured to process one or more audio streams, the device including a memory configured to store the one or more audio streams, and one or more processors implemented in circuitry coupled to the memory, to perform the operations described herein.

FIG. 12B is a block diagram illustrating another example system 1250 configured to perform various aspects of the techniques described in this disclosure. The system 1250 is similar to the system 1200 shown in FIG. 12A, except that the audio renderers 1232 shown in FIG. 12A are replaced with a binaural renderer 1242 (in audio playback system 1216B of content consumer device 1214B) capable of performing binaural rendering using one or more head-related transfer functions (HRTFs) or the other functions capable of rendering to left and right speaker feeds 1243. The binaural renderer 1242 may include the renderer 170 and/or the components of FIG. 5 or FIG. 7 to enable selection of one or more rendering modes based on the source spacing-based group metadata 1290.

The audio playback system 1216B may output the left and right speaker feeds 1243 to headphones 1248, which may represent another example of a wearable device and which may be coupled to additional wearable devices to facilitate reproduction of the soundfield, such as a watch, the VR headset noted above, smart glasses, smart clothing, smart rings, smart bracelets or any other types of smart jewelry (including smart necklaces), and the like. The headphones 1248 may couple wirelessly or via wired connection to the additional wearable devices.

Additionally, the headphones 1248 may couple to the audio playback system 1216B via a wired connection (such as a standard 3.5 mm audio jack, a universal system bus (USB) connection, an optical audio jack, or other forms of wired connection) or wirelessly (such as by way of a Bluetooth™ connection, a wireless network connection, and the like). The headphones 1248 may recreate, based on the left and right speaker feeds 1243, the soundfield represented by the audio data 1219′. The headphones 1248 may include a left headphone speaker and a right headphone speaker which are powered (or, in other words, driven) by the corresponding left and right speaker feeds 1243.

Content consumer device 1214B may represent an example device configured to process one or more audio streams, the device including a memory configured to store the one or more audio streams, and one or more processors implemented in circuitry coupled to the memory, the one or more processors being configured to perform the operations described herein.

FIG. 12C is a block diagram illustrating another example system 1260. The example system 1260 is similar to the example system 1200 of FIG. 12A, however source device 1212B of system 1260 does not include a content capture device. Source device 1212B contains synthesizing device 1229. Synthesizing device 1229 may be used by a content developer to generate synthesized audio streams. The synthesized audio streams may have location information associated therewith that may identifying a location of the audio stream relative to a listener or other point of reference in the soundfield, such that the audio stream may be rendered to one or more speaker channels for playback in an effort to recreate the soundfield. In some examples, synthesizing device 1229 may also synthesize visual or video data.

For example, a content developer may generate synthesized audio streams for a video game. While the example of FIG. 12C is shown with the content consumer device 1214A of the example of FIG. 12A, the source device 1212B of the example of FIG. 12C may be used with the content consumer device 1214B of FIG. 12B. In some examples, the source device 1212B of FIG. 12C may also include a content capture device, such that bitstream 1227 may contain both captured audio stream(s) and synthesized audio stream(s).

As described above, the content consumer device 1214A or 1214B (for simplicity purposes, either of which may hereinafter be referred to as content consumer device 1214) may represent a VR device in which a human wearable display (which may also be referred to a “head mounted display”) is mounted in front of the eyes of the user operating the VR device. (An example of a VR device worn by a user is depicted in FIG. 23.) The VR device is coupled to, or otherwise includes, headphones, which may reproduce a soundfield represented by the audio data 1219′ through playback of the speaker feeds 1235. The speaker feeds 1235 may represent an analog or digital signal capable of causing a membrane within the transducers of headphones to vibrate at various frequencies, where such process is commonly referred to as driving the headphones.

Video, audio, and other sensory data may play important roles in the VR experience. To participate in a VR experience, the user may wear the VR device (which may also be referred to as a VR headset) or other wearable electronic device. The VR client device (such as the VR headset) may include a tracking device (e.g., the tracking device 1240) that is configured to track head movement of the user, and adapt the video data shown via the VR headset to account for the head movements, providing an immersive experience in which the user may experience a displayed world shown in the video data in visual three dimensions. The displayed world may refer to a virtual world (in which all of the world is simulated), an augmented world (in which portions of the world are augmented by virtual objects), or a physical world (in which a real world image is virtually navigated).

While VR (and other forms of AR and/or MR) may allow the user to reside in the virtual world visually, often the VR headset may lack the capability to place the user in the displayed world audibly. In other words, the VR system (which includes a VR headset and may also include a computer responsible for rendering the video data and audio data) may be unable to support full three-dimension immersion audibly (and in some instances realistically in a manner that reflects the displayed scene presented to the user via the VR headset).

While described in this disclosure with respect to the VR device, various aspects of the techniques of this disclosure may be performed in the context of other devices, such as a mobile device. In this instance, the mobile device (such as a so-called smartphone) may present the displayed world via a display, which may be mounted to the head of the user or viewed as would be done when normally using the mobile device. As such, any information on the screen can be part of the mobile device. The mobile device may be able to provide tracking information 1241 and thereby allow for both a VR experience (when head mounted) and a normal experience to view the displayed world, where the normal experience may still allow the user to view the displayed world proving a VR-lite-type experience (e.g., holding up the device and rotating or translating the device to view different portions of the displayed world).

In any event, returning to the VR device context, the audio aspects of VR have been classified into three separate categories of immersion. The first category provides the lowest level of immersion, and is referred to as three degrees of freedom (3DOF). 3DOF refers to audio rendering that accounts for movement of the head in the three degrees of freedom (yaw, pitch, and roll), thereby allowing the user to freely look around in any direction. 3DOF, however, cannot account for translational head movements in which the head is not centered on the optical and acoustical center of the soundfield.

The second category, referred to 3DOF plus (3DOF+), provides for the three degrees of freedom (yaw, pitch, and roll) in addition to limited spatial translational movements due to the head movements away from the optical center and acoustical center within the soundfield. 3DOF+ may provide support for perceptual effects such as motion parallax, which may strengthen the sense of immersion.

The third category, referred to as six degrees of freedom (6DOF), renders audio data in a manner that accounts for the three degrees of freedom in term of head movements (yaw, pitch, and roll) but also accounts for translation of the user in space (x, y, and z translations). The spatial translations may be induced by sensors tracking the location of the user in the physical world or by way of an input controller.

3DOF rendering is the current state of the art for the audio aspects of VR. As such, the audio aspects of VR are less immersive than the video aspects, thereby potentially reducing the overall immersion experienced by the user. However, VR is rapidly transitioning and may develop quickly to supporting both 3DOF+ and 6DOF that may expose opportunities for additional use cases.

For example, interactive gaming application may utilize 6DOF to facilitate fully immersive gaming in which the users themselves move within the VR world and may interact with virtual objects by walking over to the virtual objects. Furthermore, an interactive live streaming application may utilize 6DOF to allow VR client devices to experience a live stream of a concert or sporting event as if present at the concert themselves, allowing the users to move within the concert or sporting event.

There are a number of difficulties associated with these use cases. In the instance of fully immersive gaming, latency may need to remain low to enable gameplay that does not result in nausea or motion sickness. Moreover, from an audio perspective, latency in audio playback that results in loss of synchronization with video data may reduce the immersion. Furthermore, for certain types of gaming applications, spatial accuracy may be important to allow for accurate responses, including with respect to how sound is perceived by the users as that allows users to anticipate actions that are not currently in view.

In the context of live streaming applications, a large number of source devices 1212A or 1212B (either of which, for simplicity purposes, is hereinafter referred to as source device 1212) may stream content 1221, where the source devices 1212 may have widely different capabilities. For example, one source device may be a smartphone with a digital fixed-lens camera and one or more microphones, while another source device may be production level television equipment capable of obtaining video of a much higher resolution and quality than the smartphone. However, all of the source devices, in the context of the live streaming applications, may offer streams of varying quality from which the VR device may attempt to select an appropriate one to provide an intended experience.

As mentioned above, in order to provide an immersive audio experience for an XR system, an appropriate audio rendering mode should be used. However, the rendering mode may be highly dependent on the audio receiver (also referred to herein as an audio stream) placement. In some examples, audio receiver placement may be unevenly spaced. Thus, it may be very difficult to determine the appropriate rendering mode that would offer an immersive audio experience. Accordingly, hybrid rendering techniques may be utilized to provide sufficient immersion through dynamically adapting the rendering mode based on the listener proximity to appropriate clusters or regions.

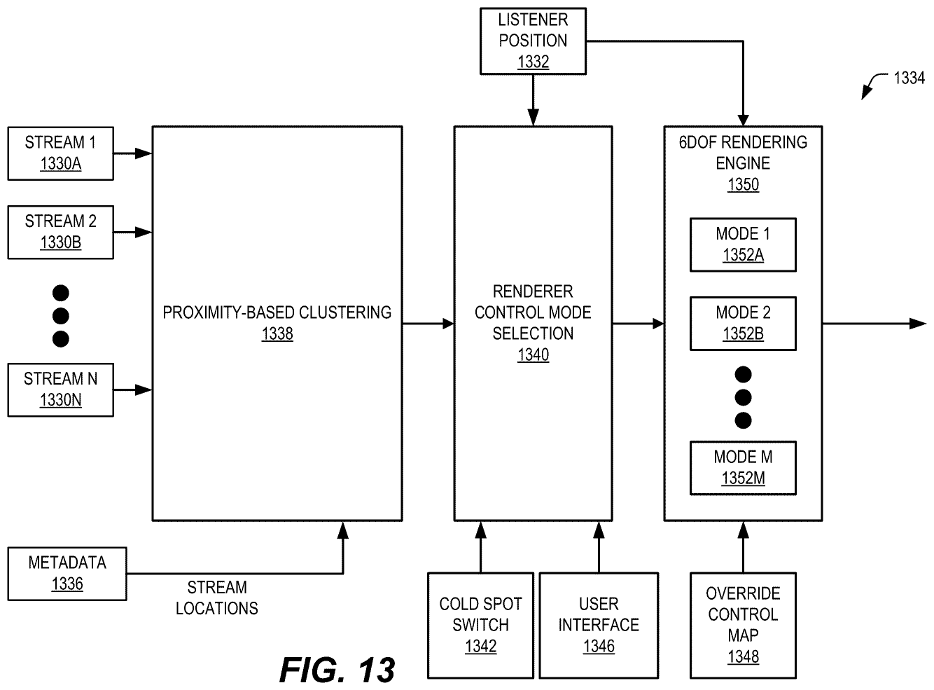

FIG. 13 is a block diagram illustrating an example content consumer device in accordance with some examples of the present disclosure. Content consumer device 1334 may be an example of any audio playback device 104 disclosed herein. For example, the consumer device 1334 obtains a number N of audio streams, such as an audio stream 1 1330A, an audio stream 2 1330B, through an audio stream N 1330N. The audio streams 1330 may represent audio receivers. In some examples, the audio streams 1330 correspond to the audio streams 114 of FIG. 1. Along with the audio streams, the content consumer device 1334 can obtain metadata 1336. The metadata 1336 includes information about the location of the audio streams 1330A-1330N. In some examples, rather than being separately provided as shown, the metadata 1336 may be included in the audio streams 1330A-1330N. One or more processors of the content consumer device 1334 may apply proximity-based clustering 1338 to the audio streams 1330A-1330N based on the audio stream location information indicated by the metadata 1336. One or more processors of the content consumer device 1334 may determine a rendering mode through a renderer control mode selection 1340. For example, one or more processors of the content consumer device 1334 may receive an indication of a listener position 1332 and may determine a rendering mode with which to render at least one of the audio streams 1330A-1330N based on the output of the proximity-based clustering 1338 and the listener position 1332. In some implementations, selection of the rendering mode is based on spacing-based source grouping and associated render mode information, such as described with reference to the source spacing-based group metadata 1290.

In some examples, a user may input, through a user interface 1346, a rendering mode that is preferred by the user rather than the rendering mode determined by the renderer control mode selection 1340. In some examples, one or more processors of the content consumer device 1334 may apply cold spot switch (discussed in further detail below) to determine a rendering mode. The content consumer device includes a 6DOF rendering engine 1350 that may select a rendering mode from a number M of different rendering modes, such as a rendering mode 1 1352A, a rendering mode 2 1352B through a rendering mode M 1352M. In some examples, the 6DOF rendering engine 1350 may use an override control map 1348 to override the selected mode. For example, a user may want to control the rendering experience and may override the automatic selection of a rendering mode.

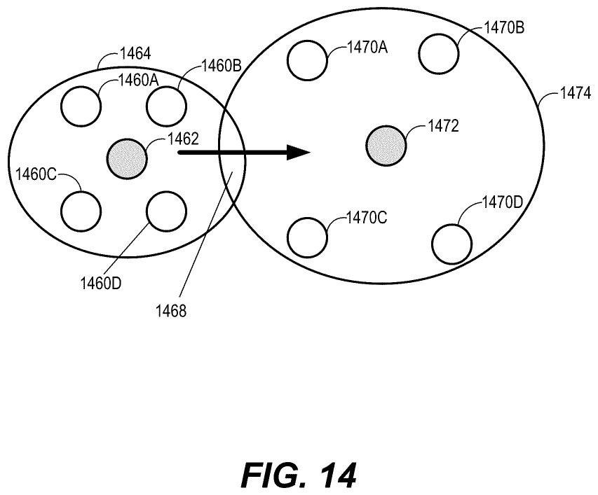

FIG. 14 is a conceptual diagram illustrating example rendering modes in accordance with some examples of the present disclosure. For example, two clusters of audio receivers are depicted. A first cluster 1464 contains audio receivers 1460A-1460D. A second cluster 1474 of audio receivers contains audio receivers 1470A-1470D. In some examples, when a listener positioned at a listener position 1462 moves toward a listener position 1472, one or more processors of the content consumer device 1334 may snap to the cluster 1474 such that the cluster 1474 is rendered rather than (or in some cases, in addition to) the cluster 1464. In other words, when a listener is positioned at the listener position 1462, the 6DOF rendering engine 1350 may render the audio receivers 1460A-1460D within the cluster 1464. When the listener is at the listener position 1472, the 6DOF rendering engine 1350 may render the audio receivers 1470A-1470D within the cluster 1474. In some examples, when the listener is at a position of overlap 1468 between the cluster 1464 and the cluster 1474, the 6DOF rendering engine 1350 may render both audio receivers 1460A-1460D and audio receivers 1470A-1470D.

In some examples, one or more processors of the content consumer device 1334 may utilize a predefined criterion for distance between the audio receivers when performing proximity-based clustering. In some examples, the decision criteria may be fixed to a cluster such that certain clustered regions may just switch between the receivers, such as by snapping. In other examples, when switching between clusters, the content consumer device 1334 may use interpolation or crossfading or other advanced rendering modes when the receiver proximity within the regions would otherwise not provide for appropriate immersion. More information on snapping may be found in U.S. patent application Ser. No. 16/918,441, filed on Jul. 1, 2020 and claiming priority to U.S. Provisional Patent Application 62/870,573, filed on Jul. 3, 2020, and U.S. Provisional Patent Application 62/992,635, filed on Mar. 20, 2020.

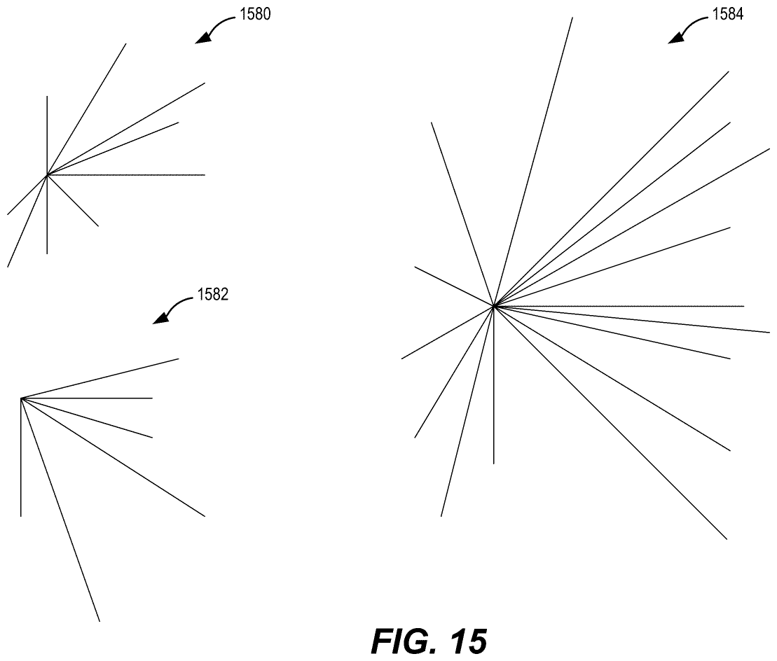

FIG. 15 is a conceptual diagram illustrating an example of k-means clustering techniques in accordance with some examples of the present disclosure. A k-means algorithm is an iterative clustering algorithm that aims to find local maxima in each iteration. For example, one or more processors of the content consumer device 1334 may choose a number of clusters k. In this example, there are three clusters depicted, a cluster 1580, a cluster 1582, and a cluster 1584. One or more processors of the content consumer device 1334 may select k random points as centroids. One or more processors of the content consumer device 1334 may then assign all the points (e.g., the audio receivers) to the closest cluster centroid. One or more processors of the content consumer device 1334 may then iterate by recomputing the centroids of newly formed clusters.

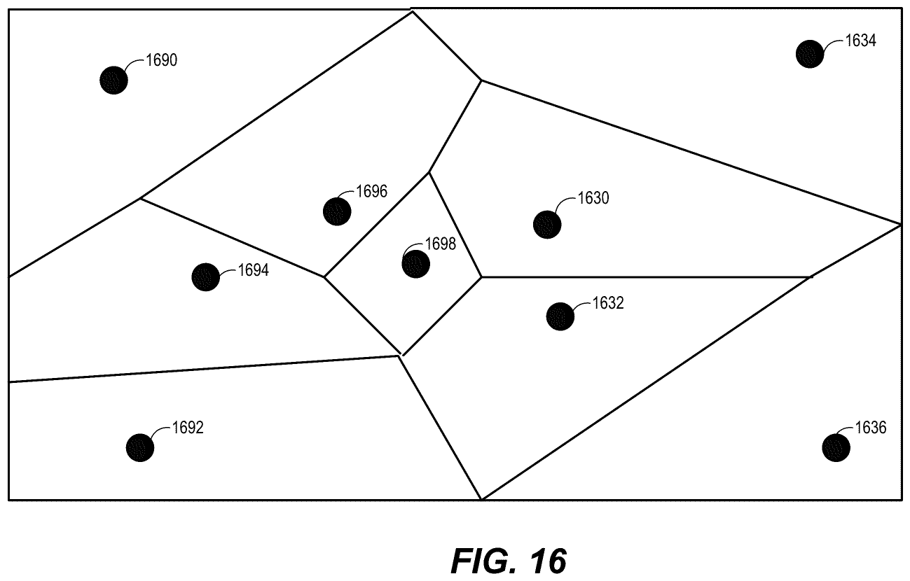

FIG. 16 is a conceptual diagram illustrating an example of Voronoi distance clustering in accordance with some examples of the present disclosure. For example, one or more processors of the content consumer device 1334 may partition a plane with N generating points (generating points 1690, 1692, 1694, 1696, 1698, 1630, 1632, 1634 and 1636) into convex polygons such that each polygon contains exactly one generating point (e.g., the generating point 1690) and every point in each polygon is closer to the generating point in that polygon than to any other generating point. For example, if one thinks of the Voronoi regions as defined by expanding a circle from the generating point, an edge of a polygon occurs when two neighboring circles reach each other. Each determined polygon may be a separate cluster.

While the examples of a fixed distance, k-means clustering and Voronoi distance clustering have been disclosed, other clustering techniques may be used and still be within the scope of the present disclosure. For example, volumetric (3 dimensional) clustering may be used.

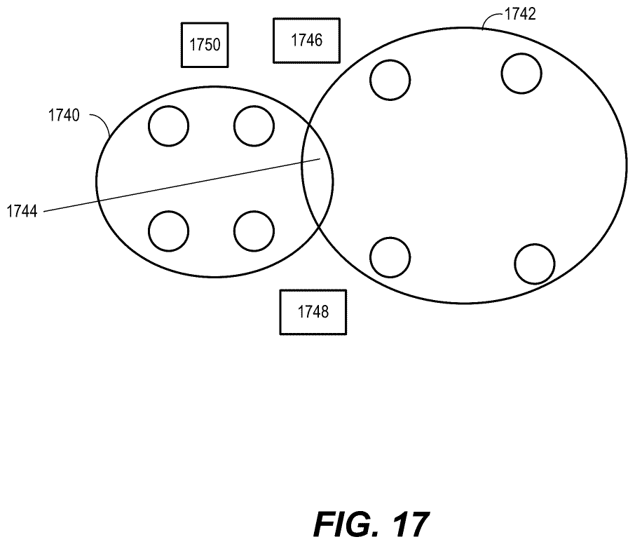

FIG. 17 is a conceptual diagram illustrating example renderer control mode selection techniques according to this disclosure. Two clusters, a cluster 1740 and a cluster 1742, of audio receivers are depicted. When a listener is positioned in the non-overlapping area of the cluster 1740, the 6DOF rendering engine 1350 may render the audio receivers within the cluster 1740. When a listener is positioned in the non-overlapping area of the cluster 1742, the 6DOF rendering engine 1350 may render the audio receivers within the cluster 1742. When a listener is positioned in an overlapping region 1744 of the cluster 1740 and the cluster 1742, the 6DOF rendering engine 1350 may render the audio receivers in both the cluster 1740 and the cluster 1742 or may interpolate or cross fade between the audio receivers of the cluster 1740 and the audio receivers of the cluster 1742.

In some examples, when a listener is positioned in a “cold spot”, such as a region 1750 outside of both the cluster 1740 and the cluster 1742, the 6DOF rendering engine 1350 may not render any audio receivers. If cold spot switching is enabled, the 6DOF rendering engine 1350 may render audio receivers. For example, when a listener is positioned in a cold spot, such as the region 1750, the 6DOF rendering engine 1350 may render one or more audio receivers of a closest cluster. For example, the 6DOF rendering engine 1350 may render the audio receivers of the cluster 1740 if a listener is positioned in the region 1750. In some examples, when a listener is positioned in a cold spot near more than one cluster, such as in a region 1746 or a region 1748 and cold spot switching is enabled, the 6DOF rendering engine 1350 may render the audio receivers in both the cluster 1740 and the cluster 1742 or may interpolate or cross fade between the audio receivers of the cluster 1740 and the audio receivers of the cluster 1742.

For example, once the proximity-based clustering is completed, one or more processors of the content consumer device 1334 may generate a renderer control map encompassing the appropriate rendering modes. There may be roll off (e.g., interpolation or crossfading) when switching between different modes such as when the clusters overlap (e.g., the overlapping region 1744). The roll off criteria may also be used to fill the cold spots, such as the regions 1746 and 1748.

In some examples, rather than render nothing when a listener is positioned in a cold spot such as the region 1750, the content consumer device 1334 may play commentary, such as, “You are exiting the audio experience” or “You have entered a cold spot. Please move back to experience your audio.” In some examples, the content consumer device 1334 may play static audio when a listener is positioned in a cold spot. In some examples, a switch (whether physical or virtual (such as on a touch screen)) on the content consumer device 1334 or a flag in a bitstream may be set to inform the content consumer device 1334 whether to fill the cold spots or how to fill the cold spots. In some example, the cold spot switch may be enabled or disabled with a single bit (e.g., 1 or 0).

Referring back to FIG. 13, the renderer control mode selection may generate the renderer control map. The 6DOF rendering engine 1350 may perform the mode switching based upon the generated renderer control map. In some examples, where hybrid rendering is not desirable or viable, the rendering control map may contain only one rendering mode. However, when a listener moves to a different position, the rendering control map may be refreshed or flushed and regenerated at runtime to change the rendering mode. In some examples, the user interface 1346 (which in some examples, includes the cold spot switch 1342), may facilitate a listener unselecting a given rendering mode selected by the content consumer device 1334 and select a user preferred mode instead.

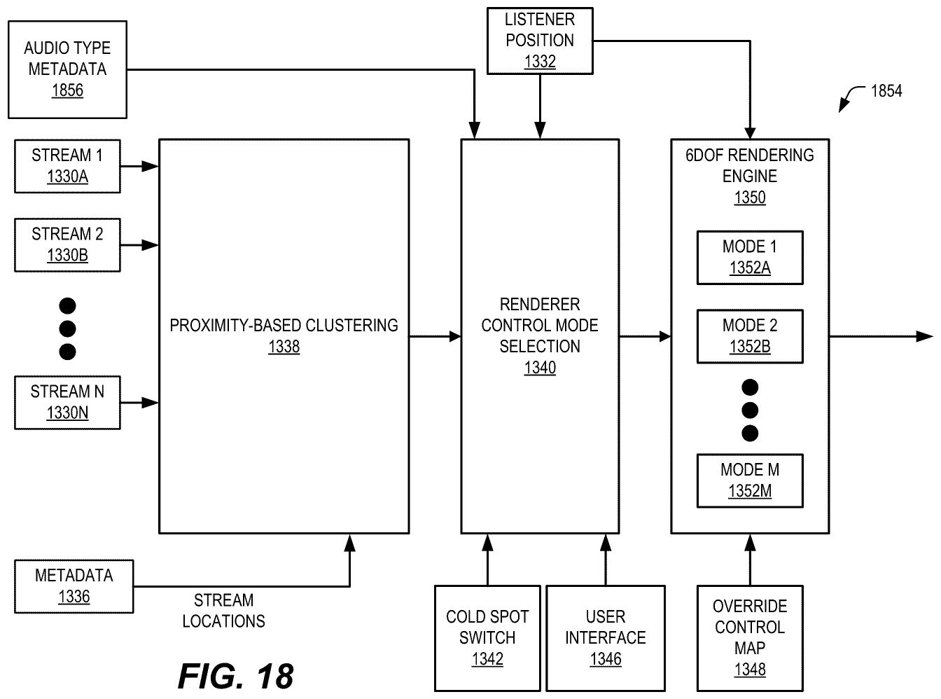

FIG. 18 is a block diagram illustrating another example of a content consumer device in accordance with some examples of the present disclosure. A content consumer device 1854 is similar to the content consumer device 1334 of FIG. 13, however, the content consumer device 1854 receives audio type metadata 1856 (e.g., from a bitstream) and one or more processors of the content consumer device 1854 further base the renderer control map or the selection of the rendering mode on the audio type metadata 1856. For example, the rendering mode may be highly dependent on the type of data in the audio streams 1330, as well as the location of the audio streams 1330. For example, some audio receivers may only contain ambience data or an ambience embedding (e.g., audio data that contains only ambience with no directional audio source). In such cases, a different renderer may be used. In other examples, an audio stream may include both directional audio and ambience audio together. In other examples, there may be audio objects and the ambisonics stream from different audio receivers may include only ambient audio. In other examples, a contextual scene, such as “indoor,” “outdoor,” “underwater,” “synthetic,” etc. may also lead to the selection of a different rendering mode. For each of these examples, the selection of the rendering mode may be based on the type of content of the audio streams 1330 as indicated by the audio type metadata 1856.

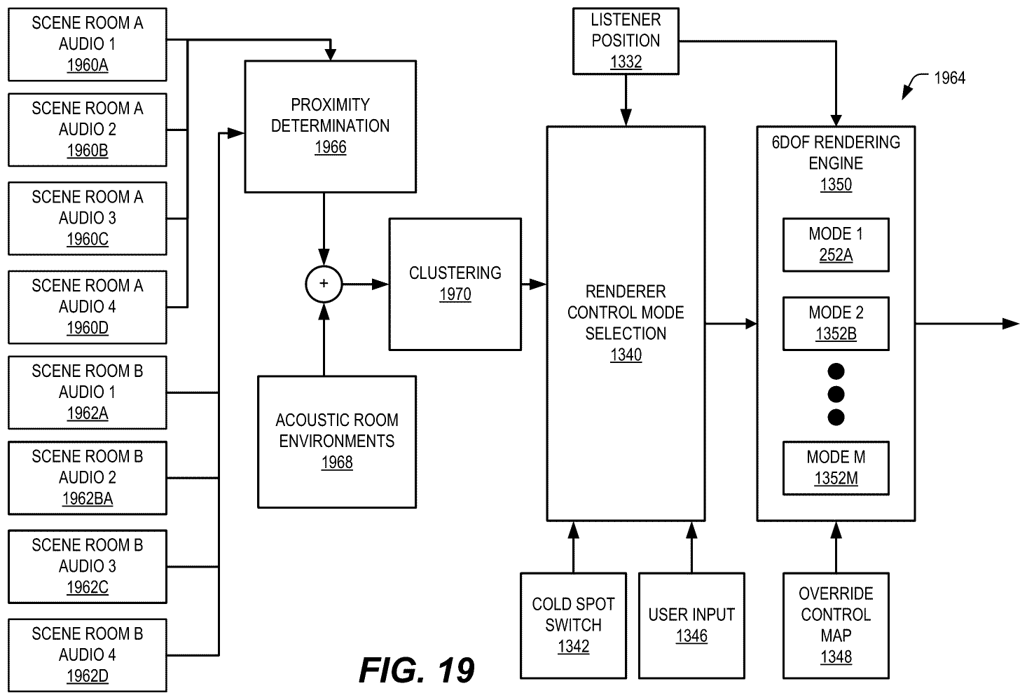

The techniques of the present disclosure are also applicable to the use of scene graphs. For example, the techniques may be applicable with scene graphs that are or will be implanted for extended reality (XR) frameworks which use semantic path trees. For example: OpenSceneGraph or OpenXR. In such cases, both scene graph hierarchy and proximity may be taken into account in the clustering process, as further described with reference to FIG. 19. A content consumer device may use different acoustic environments (rooms, for example) to assist, drive, or guide the clustering process.

FIG. 19 is a block diagram of another example of a content consumer device in accordance with some examples of the present disclosure. A content consumer device 1964 is similar to the content consumer device 1854 of FIG. 18 and the content consumer device 1334 of FIG. 13, except the content consumer device 1964 is configured to use scene graphs.

For example, audio streams from four audio receivers in a scene room A are depicted as scene room A audio 1 1960A, scene room A audio 2 1960B, scene room A audio 3 1960C, and scene room A audio 4 1960D. Additionally, audio streams from four audio receivers in a scene room B (which may be different than scene room A) are depicted as scene room B audio 1 1962A, scene room B audio 2 1962B, scene room B audio 3 1962C, and scene room B audio 4 1962D. One or more processors of the content consumer device 1964 may perform a proximity determination 1966, such as determining the location of each of the audio receivers in the scene room A and each of the audio receivers in the scene room B.

Acoustic room environments 1968, such as a concert hall, a classroom, a sporting arena, associated with the scene room A and the scene room B, along with the scene room A audio data and the scene room B audio data and the proximity determination information may be received by clustering 1970. One or more processors of the content consumer device 1964 may perform the clustering 1970 based on scene graphs associated with the scene room A and the scene room B, the acoustic room environments 1968, and the proximity determination 1966. The renderer control mode selection 1340 may be performed as described with respect to the content consumer device 1334 of FIG. 13.

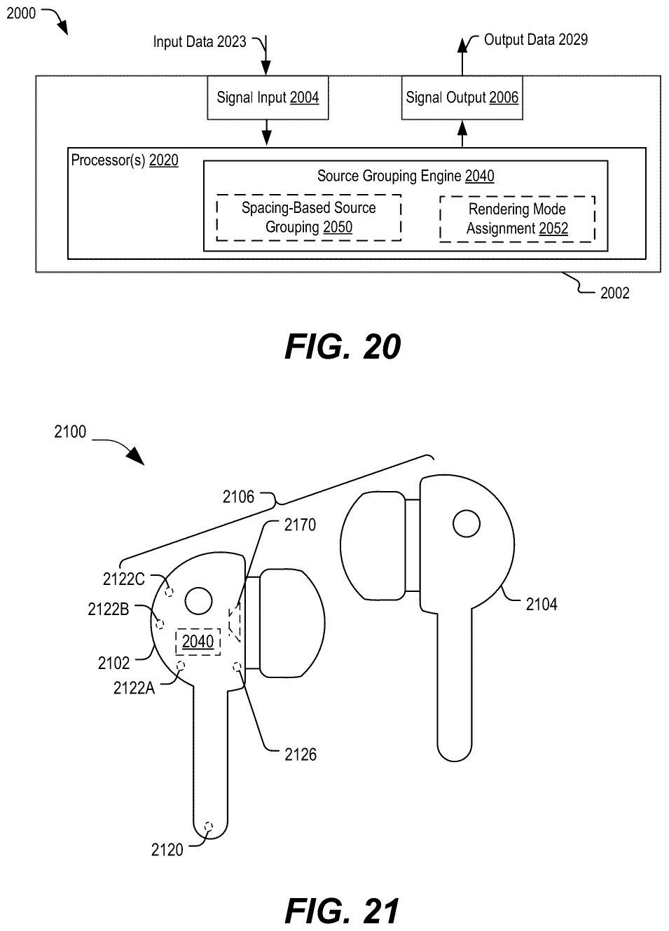

FIG. 20 depicts an implementation 2000 of the audio streaming device 102, the audio playback device 104, or both, as an integrated circuit 2002 that includes one or more processors 2020. In a particular aspect, the audio streaming device 102 includes a first version of the integrated circuit 2002, the audio playback device 104 includes a second version of the integrated circuit 2002, or both.

The processor(s) 2020 include a source grouping engine 2040. In some implementations, the source grouping engine 2040 is configured to perform spacing-based source grouping 2050, rendering mode assignment 2052, or both. In some aspects, the spacing-based source grouping 2050 includes the spacing-based source grouping 124 of FIG. 1 or the spacing-based source grouping 154 of FIG. 2A. In some aspects, the rendering mode assignment 2052 includes the group-based rendering mode assignment 132 of FIG. 1 or the group-based rendering mode assignment 162 of FIG. 2A.

The integrated circuit 2002 also includes signal input circuitry 2004, such as one or more bus interfaces, to enable input data 2023 to be received for processing. The integrated circuit 2002 also includes signal output circuitry 2006, such as a bus interface, to enable sending output data 2029 from the integrated circuit 2002. For example, the input data 2023 can correspond to the audio streams 114, the source position information 122, the group assignment information 130, the rendering mode information 134, the bitstream 106, the listener position 196, the one or more additional audio streams 214, the additional source position information 222, or a combination thereof, as illustrative, non-limiting examples. In an example, the output data 2029 can include the bitstream 106, the group assignment information 130, the rendering mode information 134, the group assignment information 160, the rendering mode information 164, the rendering mode selection 152, the output audio signal 180, or a combination thereof, as illustrative, non-limiting examples.

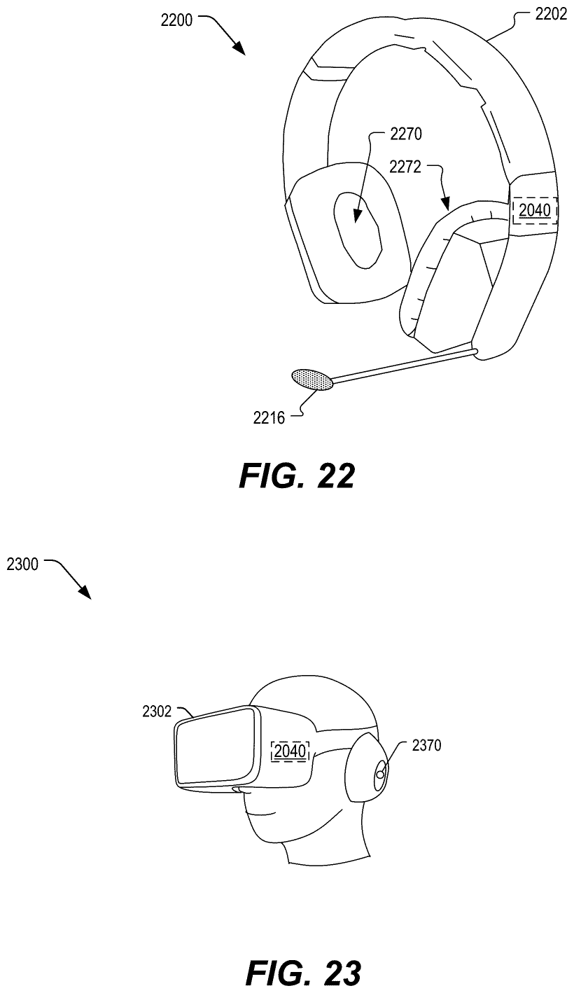

The integrated circuit 2002 enables implementation of spacing-based audio source group processing as a component in a system that includes audio playback, such as a pair of earbuds as depicted in FIG. 21, a headset as depicted in FIG. 22, or an extended reality (e.g., a virtual reality, mixed reality, or augmented reality) headset as depicted in FIG. 23. The integrated circuit 2002 also enables implementation of spacing-based audio source group processing as a component in a system that transmits audio to an earphone for playout, such as a mobile phone or tablet as depicted in FIG. 24, a wearable electronic device as depicted in FIG. 25, a voice assistant device as depicted in FIG. 26, or a vehicle as depicted in FIG. 27.

FIG. 21 depicts an implementation 2100 of the audio streaming device 102, the audio playback device 104, or both, as an in-ear style earphone, illustrated as a pair of earbuds 2106 including a first earbud 2102 and a second earbud 2104. Although earbuds are depicted, it should be understood that the present technology can be applied to other in-ear, on-ear, or over-ear playback devices. Various components, such as the source grouping engine 2040, are illustrated using dashed lines to indicate internal components that are not generally visible to a user.

The first earbud 2102 includes the source grouping engine 2040, a speaker 2170, a first microphone 2120, such as a microphone positioned to capture the voice of a wearer of the first earbud 2102, an array of one or more other microphones configured to detect ambient sounds and that may be spatially distributed to support beamforming, illustrated as microphones 2122A, 2122B, and 2122C, and a self-speech microphone 2126, such as a bone conduction microphone configured to convert sound vibrations of the wearer's ear bone or skull into an audio signal. In a particular implementation, audio signals generated by the microphones 2120 and 2122A, 2122B, and 2122C are used as the audio streams 114.

The source grouping engine 2040 is coupled to the speaker 2170 and is configured to perform spacing-based audio source group processing, as described above. The second earbud 2104 can be configured in a substantially similar manner as the first earbud 2102 or may be configured to receive one signal of the output audio signal 180 from the first earbud 2102 for playout while another signal of the output audio signal 180 is played out at the first earbud 2102.

In some implementations, the earbuds 2102, 2104 are configured to automatically switch between various operating modes, such as a passthrough mode in which ambient sound is played via the speaker 2170, a playback mode in which non-ambient sound (e.g., streaming audio corresponding to a phone conversation, media playback, a video game, etc.) is played back through the speaker 2170, and an audio zoom mode or beamforming mode in which one or more ambient sounds are emphasized and/or other ambient sounds are suppressed for playback at the speaker 2170. In other implementations, the earbuds 2102, 2104 may support fewer modes or may support one or more other modes in place of, or in addition to, the described modes.

In an illustrative example, the earbuds 2102, 2104 can automatically transition from the playback mode to the passthrough mode in response to detecting the wearer's voice, and may automatically transition back to the playback mode after the wearer has ceased speaking. In some examples, the earbuds 2102, 2104 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music. Spacing-based audio source group processing can be performed by the source grouping engine 2040 in one or more of the modes. For example, the audio played out at the speaker 2170 during the playback mode can be processed based on spacing-based audio source groups.

FIG. 22 depicts an implementation 2200 in which the audio streaming device 102, the audio playback device 104, or both, are a headset device 2202. The headset device 2202 includes speakers 2070, 2072 and a microphone 2216, and the source grouping engine 2040 is integrated in the headset device 2202 and configured to perform spacing-based audio source group processing as described above.

The source grouping engine 2040 is coupled to the microphone 2216, the speakers 2070, 2072, or a combination thereof. In some examples, an audio signal from the microphone 2216 corresponds to an audio stream 114 or the one or more additional audio streams 214. In some examples, an audio signal provided to the speakers 2070, 2072 corresponds to the output audio signal 180. For example, one signal of the output audio signal 180 output via the speaker 2070, and another signal of the output audio signal 180 is output via the speaker 2072.

FIG. 23 depicts an implementation 2300 in which the audio streaming device 102, the audio playback device 104, or both, include a portable electronic device that corresponds to an extended reality (e.g., a virtual reality, mixed reality, or augmented reality) headset 2302. The headset 2302 includes a visual interface device and earphone devices, illustrated as over-ear earphone cups that each include one of a speaker 2370. The visual interface device is positioned in front of the user's eyes to enable display of augmented reality, mixed reality, or virtual reality images or scenes to the user while the headset 2302 is worn.

The source grouping engine 2040 is integrated in the headset 2302 and configured to perform spacing-based audio source group processing as described above. For example, the source grouping engine 2040 may perform spacing-based audio source group processing during playback of sound data associated with audio sources in a virtual audio scene, spatial audio associated with a gaming session, voice audio such as from other participants in a video conferencing session or a multiplayer online gaming session, or a combination thereof.

FIG. 24 depicts an implementation 2400 in which the audio streaming device 102, the audio playback device 104, or both, include a mobile device 2402, such as a phone or tablet, coupled to earphones 2490, such as a pair of earbuds, as illustrative, non-limiting examples. The source grouping engine 2040 is integrated in the mobile device 2402 and configured to perform spacing-based audio source group processing as described above. Each of the earphones 2490 includes a speaker, such as speakers 2470 and 2472. Each earphone 2490 is configured to wirelessly receive audio data from the mobile device 2402 for playout.

In some implementations, the mobile device 2402 generates the bitstream 106 and provides the bitstream 106 to the earphones 2490 and the earphones 2490 generate the output audio signal 180 for playout. In some examples, the mobile device 2402 receives the bitstream 106 from another device, generates the output audio signal 180, and provides the output audio signal 180 to the earphones 2490 for playback. In some implementations, the mobile device 2402 provides the output audio signal 180 to speakers integrated in the mobile device 2402. For example, the mobile device 2402 provides one signal of the output audio signal 180 to a first speaker and another signal of the output audio signal 180 to another speaker for playback.

In some implementations, the mobile device 2402 is configured to provide a user interface via a display screen 2404 that enables a user of the mobile device 2402 to adjust one or more parameters associated with performing the spacing-based audio source group processing, such as a distance threshold, a density threshold, an interpolation weight, or a combination thereof, to generate a customized audio experience.

FIG. 25 depicts an implementation 2500 in which the audio streaming device 102, the audio playback device 104, or both, include a wearable device 2502, illustrated as a “smart watch,” coupled to the earphones 2590, such as a pair of earbuds, as illustrative, non-limiting examples. The source grouping engine 2040 is integrated in the wearable device 2502 and configured to perform spacing-based audio source group processing as described above. The earphones 2590 each include a speaker, such as speakers 2570 and 2572. Each earphone 2590 is configured to wirelessly receive audio data from the wearable device 2502 for playout.

In some implementations, the wearable device 2502 generates the output audio signal 180 and transmits audio data representing the output audio signal 180 to the earphones 2590 for playout. In some implementations, the earphones 2590 perform at least a portion of the audio processing associated with spacing-based audio source group processing. For example, the wearable device 2502 generates the bitstream 106, and the earphones 2590 generate the output audio signal 180.

In some implementations, the wearable device 2502 provides the output audio signal 180 to speakers integrated in the wearable device 2502. For example, the wearable device 2502 provides one signal of the output audio signal 180 to a first speaker and another signal of the output audio signal 180 to another speaker for playback.

In some implementations, the wearable device 2502 is configured to provide a user interface via a display screen 2504 that enables a user of the wearable device 2502 to adjust one or more parameters associated with spacing-based audio source group processing, such as a distance threshold, a density threshold, an interpolation weight, or a combination thereof, to generate a customized audio experience.

FIG. 26 is an implementation 2600 in which the audio streaming device 102, the audio playback device 104, or both, include a wireless speaker and voice activated device 2602 coupled to earphones 2690. The wireless speaker and voice activated device 2602 can have wireless network connectivity and is configured to execute an assistant operation, such as adjusting a temperature, playing music, turning on lights, etc. For example, assistant operations can be performed responsive to receiving a command after a keyword or key phrase (e.g., “hello assistant”).

One or more processors 2620 including the source grouping engine 2040 are integrated in the wireless speaker and voice activated device 2602 and configured to perform spacing-based audio source group processing as described above. The wireless speaker and voice activated device 2602 also includes a microphone 2626 and a speaker 2642 that can be used to support voice assistant sessions with users that are not wearing earphones.

In some implementations, the wireless speaker and voice activated device 2602 generates the output audio signal 180 and transmits audio data representing the output audio signal 180 to the earphones 2690 for playout. In some implementations, the earphones 2690 perform at least a portion of the audio processing associated with performing the spacing-based audio source group processing. For example, the wireless speaker and voice activated device 2602 generates the bitstream 106, and the earphones 2690 generate the output audio signal 180.

In some implementations, the wireless speaker and voice activated device 2602 provides the output audio signal 180 to speakers integrated in the wireless speaker and voice activated device 2602. For example, the wireless speaker and voice activated device 2602 provides one signal of the output audio signal 180 to the speaker 2642 and another signal of the output audio signal 180 to another speaker for playback.

In some implementations, the wireless speaker and voice activated device 2602 is configured to provide a user interface, such as a speech interface or via a display screen, that enables a user of the wireless speaker and voice activated device 2602 to adjust one or more parameters associated with spacing-based audio source group processing, such as one or more of a distance threshold, a density threshold, an interpolation weight, or a combination thereof, to generate a customized audio experience.

FIG. 27 depicts an implementation 2700 in which the audio streaming device 102, the audio playback device 104, or both, includes a vehicle 2702, illustrated as a car. Although a car is depicted, the vehicle 2702 can be any type of vehicle, such as an aircraft (e.g., an air taxi). The source grouping engine 2040 is integrated in the vehicle 2702 and configured to perform spacing-based audio source group processing for one or more occupants (e.g., passenger(s) and/or operator(s)) of the vehicle 2702 that are wearing earphones (not shown). For example, the vehicle 2702 is configured to support multiple independent wireless or wired audio sessions with multiple occupants that are each wearing earphones, such as by enabling each of the occupants to independently stream audio, engage in a voice call or voice assistant session, etc., via their respective earphones, during which spacing-based audio source group processing may be performed, enabling each occupant to experience an individualized virtual audio scene. The vehicle 2702 also includes multiple microphones 2726, one or more speakers 2742, and a display 2746. The microphones 2726 and the speakers 2742 can be used to support, for example, voice calls, voice assistant sessions, in-vehicle entertainment, etc., with users that are not wearing earphones.

In some implementations, the vehicle 2702 provides the output audio signal 180 to the speakers 2742. For example, the vehicle 2702 provides one signal of the output audio signal 180 to one of the speakers 2742 and another signal of the output audio signal 180 to another of the speakers 2742 for playback.

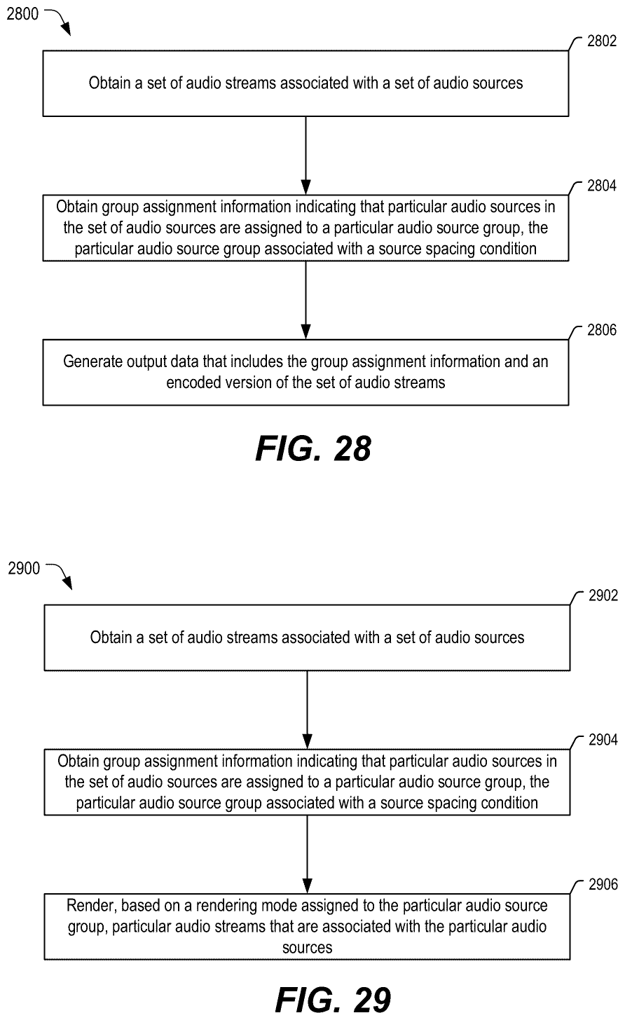

FIG. 28 illustrates an example of a method 2800 of performing spacing-based audio source group processing. The method 2800 may be performed by an electronic device, such as the audio streaming device 102 (e.g., buy the one or more processors 120 during an encoding operation, as an illustrative, non-limiting example.

In a particular aspect, the method 2800 includes, at block 2802, obtaining a set of audio streams associated with a set of audio sources. For example, the audio streaming device 102 of FIG. 1 obtains the audio streams 114, as described with reference to FIG. 1.

The method 2800 also includes, at block 2804, obtaining group assignment information indicating that particular audio sources in the set of audio sources are assigned to a particular audio source group, the particular audio source group associated with a source spacing condition. For example, the audio streaming device 102 generates the group assignment information 130 indicating that particular audio sources in the set of audio sources 112 are assigned to a particular audio source group, as described with reference to FIG. 1.

The method 2800 further includes, at block 2806, generating output data that includes the group assignment information and an encoded version of the set of audio streams. For example, the audio streaming device 102 generates output data (e.g., the bitstream 106) including the group assignment information 130 and an encoded version of the audio streams 114, as described with reference to FIG. 1.

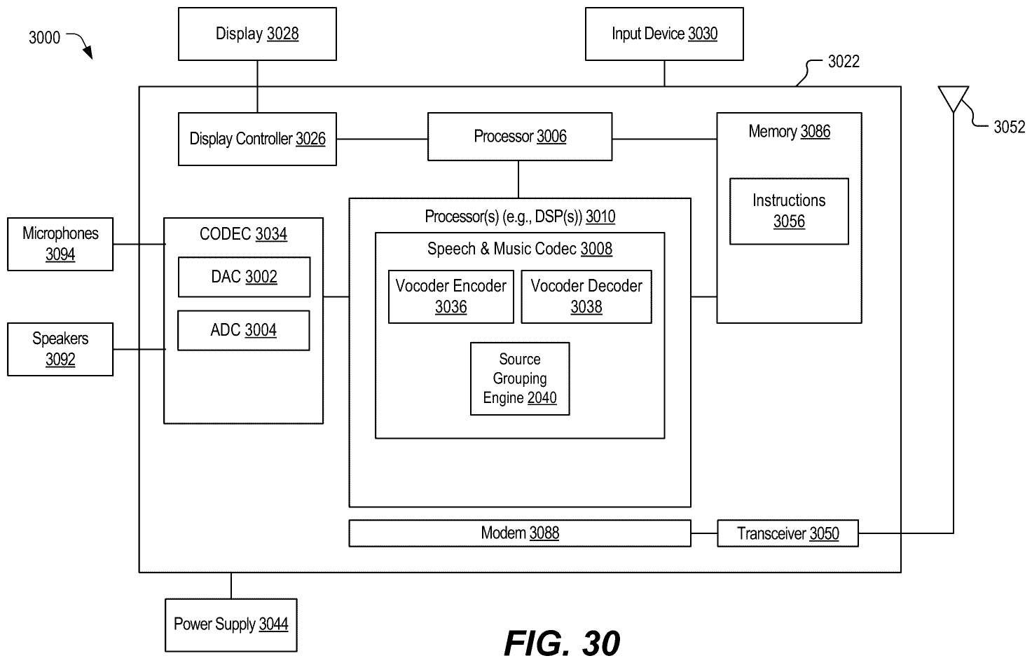

The method 2800 of FIG. 28 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 2800 of FIG. 28 may be performed by a processor that executes instructions, such as described with reference to FIG. 30.

FIG. 29 illustrates an example of a method 2900 of performing spacing-based audio source group processing. The method 2900 may be performed by an electronic device, such as the audio playback device 104 (e.g., the one or more processors 150 during a decoding operation) as an illustrative, non-limiting example.

In a particular aspect, the method 2900 includes, at block 2902, obtaining a set of audio streams associated with a set of audio sources. For example, the audio playback device 104 of FIG. 1 decodes the encoded version of the audio streams 114 to generate a decoded version of the audio streams 114, as described with reference to FIG. 1. In some examples, the audio playback device 104 of FIG. 2A or FIG. 2C also receives the one or more additional audio streams 214.

The method 2900 also includes, at block 2904, obtaining group assignment information indicating that particular audio sources in the set of audio sources are assigned to a particular audio source group, the particular audio source group associated with a source spacing condition. In some examples, the audio playback device 104 receives the group assignment information 130 from the audio streaming device 102. in some examples, the audio playback device 104 generates the group assignment information 160 indicating that particular audio sources in the set of audio sources 112 (and/or audio sources of the one or more additional audio streams 214) are assigned to a particular audio source group, as described with reference to FIGS. 2A-2C.

The method 2900 further includes, at block 2906, rendering, based on a rendering mode assigned to the particular audio source group, particular audio streams that are associated with the particular audio sources. For example, the rendering mode selection 152 causes the renderer 170 to render, based on a rendering mode assigned to a particular audio source group, particular audio streams that are associated with the particular audio sources, as described with reference to FIG. 1.

The method 2900 of FIG. 29 may be implemented by a FPGA device, an ASIC, a processing unit such as a CPU, a DSP, a controller, another hardware device, firmware device, or any combination thereof. As an example, the method 2900 of FIG. 29 may be performed by a processor that executes instructions, such as described with reference to FIG. 30.

Referring to FIG. 30, a block diagram of a particular illustrative implementation of a device is depicted and generally designated 3000. In various implementations, the device 3000 may have more or fewer components than illustrated in FIG. 30. In an illustrative implementation, the device 3000 may correspond to the audio streaming device 102, the audio playback device 104, or both, of FIG. 1. In an illustrative implementation, the device 3000 may perform one or more operations described with reference to FIGS. 1-29.

In a particular implementation, the device 3000 includes a processor 3006 (e.g., a CPU). The device 3000 may include one or more additional processors 3010 (e.g., one or more DSPs). In a particular aspect, the processor 3006, the additional processors 3010, or a combination thereof, include the one or more processors 120, the one or more processors 150, or a combination thereof. The processors 3010 may include a speech and music coder-decoder (CODEC) 3008 that includes a voice coder (“vocoder”) encoder 3036, a vocoder decoder 3038, the source grouping engine 2040, or a combination thereof.

The device 3000 may include a memory 3086 and a CODEC 3034. The memory 3086 may include instructions 3056, that are executable by the one or more additional processors 3010 (or the processor 3006) to implement the functionality described with reference to the source grouping engine 2040. The device 3000 may include a modem 3088 coupled, via a transceiver 3050, to an antenna 3052.

The device 3000 may include a display 3028 coupled to a display controller 3026. One or more speakers 3092 and one or more microphones 3094 may be coupled to the CODEC 3034. The CODEC 3034 may include a digital-to-analog converter (DAC) 3002, an analog-to-digital converter (ADC) 3004, or both. In a particular implementation, the CODEC 3034 may receive analog signals from the microphone(s) 3004, convert the analog signals to digital signals using the analog-to-digital converter 3004, and provide the digital signals to the speech and music codec 3008. The digital signals may include the audio streams 114. The speech and music codec 3008 may process the digital signals, and the digital signals may further be processed by the source grouping engine 2040. In a particular implementation, the speech and music codec 3008 may provide digital signals to the CODEC 3034. In an example, the digital signals may include the output audio signal 180. The CODEC 3034 may convert the digital signals to analog signals using the digital-to-analog converter 3002 and may provide the analog signals to the speaker(s) 3092.

In a particular implementation, the device 3000 may be included in a system-in-package or system-on-chip device 3022. In a particular implementation, the memory 3086, the processor 3006, the processors 3010, the display controller 3026, the CODEC 3034, and the modem 3088 are included in the system-in-package or system-on-chip device 3022. In a particular implementation, an input device 3030 and a power supply 3044 are coupled to the system-in-package or the system-on-chip device 3022. Moreover, in a particular implementation, as illustrated in FIG. 30, the display 3028, the input device 3030, the speaker(s) 3092, the microphone(s) 3094, the antenna 3052, and the power supply 3044 are external to the system-in-package or the system-on-chip device 3022. In a particular implementation, each of the display 3028, the input device 3030, the speaker 3092, the microphone(s) 3094, and the power supply 3044 may be coupled to a component of the system-in-package or the system-on-chip device 3022, such as an interface or a controller.

The device 3000 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described techniques and implementations, an apparatus includes means for obtaining a set of audio streams associated with a set of audio sources. For example, the means for obtaining a set of audio streams associated with a set of audio sources can correspond to the one or more processors 120, the audio streaming device 102, the microphones 1218, the source grouping engine 2040, the microphone(s) 3094, the processor 3006, the processor(s) 3010, the modem 3088, the transceiver 3050, the antenna 3052, one or more other circuits or components configured to obtain a set of audio streams associated with a set of audio sources, or any combination thereof.

The apparatus also includes means for obtaining group assignment information indicating that particular audio sources in the set of audio sources are assigned to a particular audio source group, the particular audio source group associated with a source spacing condition. For example, the means for obtaining group assignment information indicating that particular audio sources in the set of audio sources are assigned to a particular audio source group can correspond to the one or more processors 120, the audio streaming device 102, the source grouping engine 2040, the processor 3006, the processor(s) 3010, one or more other circuits or components configured to obtain the group assignment information, or any combination thereof.

The apparatus further includes means for generating output data that includes the group assignment information and an encoded version of the set of audio streams. For example, the means for generating output data that includes the group assignment information and an encoded version of the set of audio streams can correspond to the one or more processors 120, the audio streaming device 102, the first codec 280A, the metadata encoder 282, the second codec 290A, the audio encoder 292, the source grouping engine 2040, the processor 3006, the processor(s) 3010, one or more other circuits or components configured to generate the output data, or any combination thereof.

Also in conjunction with the described techniques and implementations, an apparatus includes means for obtaining a set of audio streams associated with a set of audio sources. For example, the means for obtaining a set of audio streams associated with a set of audio sources can correspond to the one or more processors 150, the audio playback device 104, the second codec 290B, the content consumer device 1214, the audio playback system 1216, the audio decoding device 1234, the source grouping engine 2040, the microphone(s) 3094, the processor 3006, the processor(s) 3010, the modem 3088, the transceiver 3050, the antenna 3052, one or more other circuits or components configured to obtain a set of audio streams associated with a set of audio sources, or any combination thereof.

The apparatus also includes means for obtaining group assignment information indicating that particular audio sources in the set of audio sources are assigned to a particular audio source group, the particular audio source group associated with a source spacing condition. For example, the means for obtaining group assignment information indicating that particular audio sources in the set of audio sources are assigned to a particular audio source group can correspond to the one or more processors 150, the audio playback device 104, the first codec 280B, the source grouping engine 2040, the processor 3006, the processor(s) 3010, one or more other circuits or components configured to obtain the group assignment information, or any combination thereof.

The apparatus further includes means for rendering, based on a rendering mode assigned to the particular audio source group, particular audio streams that are associated with the particular audio sources. For example, the means for rendering can correspond to the one or more processors 150, the audio playback device 104, the renderer 170, one or more of the components 502-512, one or more of the modules 802-814, one or more of the audio renderers 1232, the binaural renderer 1242, the 6DOF rendering engine 1350, the source grouping engine 2040, the processor 3006, the processor(s) 3010, one or more other circuits or components configured to render the particular audio streams, or any combination thereof.

In some implementations, a non-transitory computer-readable medium (e.g., a computer-readable storage device, such as the memory 3086) includes instructions (e.g., the instructions 3056) that, when executed by one or more processors (e.g., the one or more processors 120, the one or more processors 150, the processor 3006, or the one or more processors 3010), cause the one or more processors to perform operations corresponding to at least a portion of any of the techniques or methods described with reference to FIGS. 1-29 or any combination thereof.

Particular aspects of the disclosure are described below in sets of interrelated examples:

According to Example 1, a device includes one or more processors configured, during an audio decoding operation, to: obtain a set of audio streams associated with a set of audio sources; obtain group assignment information indicating that particular audio sources in the set of audio sources are assigned to a particular audio source group, the particular audio source group associated with a source spacing condition; and render, based on a rendering mode assigned to the particular audio source group, particular audio streams that are associated with the particular audio sources.

Example 2 includes the device of Example 1, wherein at least one of the set of audio streams is received via a bitstream from an encoder device.

Example 3 includes the device of Example 1 or Example 2, wherein the group assignment information is received via the bitstream.

Example 4 includes the device of Example 3, wherein the one or more processors are configured to update the received group assignment information.

Example 5 includes the device of any of Examples 1 to 4, wherein at least one of the set of audio streams is obtained from a storage device coupled to the one or more processors or from a game engine included in the one or more processors.

Example 6 includes the device of any of Examples 1 to 5, wherein the group assignment information is determined at least partially based on comparisons of one or more source spacing metrics to a threshold.

Example 7 includes the device of Example 6, wherein the one or more source spacing metrics include distances between the particular audio sources.

Example 8 includes the device of Example 6 or Example 7, wherein the one or more source spacing metrics include a source position density of the particular audio sources.

Example 9 includes the device of any of Examples 6 to 8, wherein the threshold includes a dynamic threshold.

Example 10 includes the device of Example 9, wherein the dynamic threshold is at least partially based a type of sound associated with the particular audio sources.

Example 11 includes the device of any of Examples 1 to 10, wherein the rendering mode assigned to the particular audio source group is one of multiple rendering modes that are supported by the one or more processors.

Example 12 includes the device of Example 11, wherein the multiple rendering modes include a baseline rendering mode in which signal processing, source direction analysis, and source interpolation are performed in a frequency domain.

Example 13 includes the device of Example 11 or Example 12, wherein the multiple rendering modes include a low-complexity rendering mode in which distance-weighted time domain interpolation is performed.

Example 14 includes the device of any of Examples 1 to 13, wherein the one or more processors are further configured to combine a first rendered audio signal associated with the set of audio sources with a second rendered audio signal associated with a microphone input to generate a combined signal.

Example 15 includes the device of Example 14, wherein the one or more processors are further configured to binauralize the combined signal to generate a binaural output signal.

Example 16 includes the device of Example 15 and further includes one or more speakers coupled to the one or more processors and configured to play out the binaural output signal.

Example 17 includes the device of any of Examples 1 to 16 and further includes a modem coupled to the one or more processors, the modem configured to receive at least one audio stream of the set of audio streams via a bitstream from an encoder device.

Example 18 includes the device of any of Examples 1 to 17, wherein the one or more processors are integrated in a headset device.

Example 19 includes the device of Example 18, wherein the headset device corresponds to at least one of a virtual reality headset, a mixed reality headset, or an augmented reality headset.

Example 20 includes the device of any of Examples 1 to 17, wherein the one or more processors are integrated in at least one of a mobile phone, a tablet computer device, or a wearable electronic device.

Example 21 includes the device of any of Examples 1 to 17, wherein the one or more processors are integrated in a vehicle.

According to Example 22, a method includes, during an audio decoding operation: obtaining, at a device, a set of audio streams associated with a set of audio sources; obtaining, at the device, group assignment information indicating that particular audio sources in the set of audio sources are assigned to a particular audio source group, the particular audio source group associated with a source spacing condition; and rendering, based on a rendering mode assigned to the particular audio source group, particular audio streams that are associated with the particular audio sources.

Example 23 includes the method of Example 22, wherein at least one of the set of audio streams is received via a bitstream from an encoder device.

Example 24 includes the method of Example 22 or Example 23, wherein the group assignment information is received via the bitstream.

Example 25 includes the method of Example 24 and further includes updating the received group assignment information.

Example 26 includes the method of any of Examples 22 to 25, wherein at least one of the set of audio streams is obtained from a storage device coupled to the device or from a game engine included in the device.

Example 27 includes the method of any of Examples 22 to 26, wherein the group assignment information is determined at least partially based on comparisons of one or more source spacing metrics to a threshold.

Example 28 includes the method of Example 27, wherein the one or more source spacing metrics include distances between the particular audio sources.

Example 29 includes the method of Example 27 or Example 28, wherein the one or more source spacing metrics include a source position density of the particular audio sources.

Example 30 includes the method of any of Examples 27 to 29, wherein the threshold includes a dynamic threshold.

Example 31 includes the method of Example 30, wherein the dynamic threshold is at least partially based a type of sound associated with the particular audio sources.

Example 32 includes the method of any of Examples 22 to 31, wherein the rendering mode assigned to the particular audio source group is one of multiple rendering modes that are supported by the device.

Example 33 includes the method of Example 32, wherein the multiple rendering modes include a baseline rendering mode in which signal processing, source direction analysis, and source interpolation are performed in a frequency domain.

Example 34 includes the method of Example 32 or Example 33, wherein the multiple rendering modes include a low-complexity rendering mode in which distance-weighted time domain interpolation is performed.

Example 35 includes the method of any of Examples 22 to 34 and further includes combining a first rendered audio signal associated with the set of audio sources with a second rendered audio signal associated with a microphone input to generate a combined signal.

Example 36 includes the method of Example 35 and further includes binauralizing the combined signal to generate a binaural output signal.

Example 37 includes the method of Example 36 and further includes playing out the binaural output signal via one or more speakers.

Example 38 includes the method of any of Examples 22 to 37 and further includes receiving, via a modem, at least one audio stream of the set of audio streams via a bitstream from an encoder device.

Example 39 includes the method of any of Examples 22 to 38, wherein a headset device includes the device.

Example 40 includes the method of Example 39, wherein the headset device corresponds to at least one of a virtual reality headset, a mixed reality headset, or an augmented reality headset.

Example 41 includes the method of any of Examples 22 to 38, wherein the device is included in at least one of a mobile phone, a tablet computer device, or a wearable electronic device.

Example 42 includes the method of any of Examples 22 to 38, wherein the device is included in a vehicle.

According to Example 43, a non-transitory computer-readable medium storing instructions that, when executed by one or more processors, cause the one or more processors to, during an audio decoding operation: obtain a set of audio streams associated with a set of audio sources; obtain group assignment information indicating that particular audio sources in the set of audio sources are assigned to a particular audio source group, the particular audio source group associated with a source spacing condition; and render, based on a rendering mode assigned to the particular audio source group, particular audio streams that are associated with the particular audio sources.

Example 44 includes the non-transitory computer-readable medium of Example 43, wherein at least one of the set of audio streams is received via a bitstream from an encoder device.

Example 45 includes the non-transitory computer-readable medium of Example 43 or Example 44, wherein the group assignment information is received via the bitstream.

Example 46 includes the non-transitory computer-readable medium of Example 45, wherein the instructions, when executed by the one or more processors, cause the one or more processors to update the received group assignment information.

Example 47 includes the non-transitory computer-readable medium of any of Examples 43 to 46, wherein at least one of the set of audio streams is obtained from a storage device coupled to the one or more processors or from a game engine included in the one or more processors.

Example 48 includes the non-transitory computer-readable medium of any of Examples 43 to 47, wherein the group assignment information is determined at least partially based on comparisons of one or more source spacing metrics to a threshold.

Example 49 includes the non-transitory computer-readable medium of Example 48, wherein the one or more source spacing metrics include distances between the particular audio sources.

Example 50 includes the non-transitory computer-readable medium of Example 48 or Example 49, wherein the one or more source spacing metrics include a source position density of the particular audio sources.

Example 51 includes the non-transitory computer-readable medium of any of Examples 48 to 50, wherein the threshold includes a dynamic threshold.

Example 52 includes the non-transitory computer-readable medium of Example 51, wherein the dynamic threshold is at least partially based a type of sound associated with the particular audio sources.

Example 53 includes the non-transitory computer-readable medium of any of Examples 43 to 52, wherein the rendering mode assigned to the particular audio source group is one of multiple rendering modes that are supported by the one or more processors.

Example 54 includes the non-transitory computer-readable medium of Example 53, wherein the multiple rendering modes include a baseline rendering mode in which signal processing, source direction analysis, and source interpolation are performed in a frequency domain.

Example 55 includes the non-transitory computer-readable medium of Example 53 or Example 54, wherein the multiple rendering modes include a low-complexity rendering mode in which distance-weighted time domain interpolation is performed.

Example 56 includes the non-transitory computer-readable medium of any of Examples 43 to 55, wherein the instructions, when executed by the one or more processors, cause the one or more processors to combine a first rendered audio signal associated with the set of audio sources with a second rendered audio signal associated with a microphone input to generate a combined signal.

Example 57 includes the non-transitory computer-readable medium of Example 56, wherein the instructions, when executed by the one or more processors, cause the one or more processors to binauralize the combined signal to generate a binaural output signal.

Example 58 includes the non-transitory computer-readable medium of Example 57, wherein the instructions, when executed by the one or more processors, cause the one or more processors to play out the binaural output signal via one or more speakers.

Example 59 includes the non-transitory computer-readable medium of any of Examples 43 to 58, wherein the instructions, when executed by the one or more processors, cause the one or more processors to receive, via a modem, at least one audio stream of the set of audio streams via a bitstream from an encoder device.

Example 60 includes the non-transitory computer-readable medium of any of Examples 43 to 59, wherein the one or more processors are integrated in a headset device.

Example 61 includes the non-transitory computer-readable medium of Example 60, wherein the headset device corresponds to at least one of a virtual reality headset, a mixed reality headset, or an augmented reality headset.

Example 62 includes the non-transitory computer-readable medium of any of Examples 43 to 59, wherein the one or more processors are integrated in at least one of a mobile phone, a tablet computer device, or a wearable electronic device.

Example 63 includes the non-transitory computer-readable medium of any of Examples 43 to 59, wherein the one or more processors are integrated in a vehicle.

According to Example 64, an apparatus includes means for obtaining a set of audio streams associated with a set of audio sources; means for obtaining group assignment information indicating that particular audio sources in the set of audio sources are assigned to a particular audio source group, the particular audio source group associated with a source spacing condition; and means for rendering, based on a rendering mode assigned to the particular audio source group, particular audio streams that are associated with the particular audio sources.

Example 65 includes the apparatus of Example 64, wherein at least one of the set of audio streams is received via a bitstream from an encoder device.

Example 66 includes the apparatus of Example 64 or Example 65, wherein the group assignment information is received via the bitstream.

Example 67 includes the apparatus of Example 66 and further includes means for updating the received group assignment information.

Example 68 includes the apparatus of any of Examples 64 to 67, wherein at least one of the set of audio streams is obtained from a storage device or from a game engine.

Example 69 includes the apparatus of any of Examples 64 to 68, wherein the group assignment information is determined at least partially based on comparisons of one or more source spacing metrics to a threshold.

Example 70 includes the apparatus of Example 69, wherein the one or more source spacing metrics include distances between the particular audio sources.

Example 71 includes the apparatus of Examples 69, wherein the one or more source spacing metrics include a source position density of the particular audio sources.

Example 72 includes the apparatus of any of Examples 69 to 71, wherein the threshold includes a dynamic threshold.

Example 73 includes the apparatus of Example 72, wherein the dynamic threshold is at least partially based a type of sound associated with the particular audio sources.

Example 74 includes the apparatus of any of Examples 64 to 73, wherein the rendering mode assigned to the particular audio source group is one of multiple rendering modes.

Example 75 includes the apparatus of Example 74, wherein the multiple rendering modes include a baseline rendering mode in which signal processing, source direction analysis, and source interpolation are performed in a frequency domain.

Example 76 includes the apparatus of Example 74 or Example 75, wherein the multiple rendering modes include a low-complexity rendering mode in which distance-weighted time domain interpolation is performed.

Example 77 includes the apparatus of any of Examples 64 to 76 and further includes means for combining a first rendered audio signal associated with the set of audio sources with a second rendered audio signal associated with a microphone input to generate a combined signal.

Example 78 includes the apparatus of Example 77 and further includes means for binauralizing the combined signal to generate a binaural output signal.

Example 79 includes the apparatus of Example 78 and further includes means for playing out the binaural output signal via one or more speakers.

Example 80 includes the apparatus of any of Examples 64 to 79 and further includes means for receiving at least one audio stream of the set of audio streams via a bitstream from an encoder device.

Example 81 includes the apparatus of any of Examples 64 to 80, wherein the means for obtaining the set of audio streams, the means for obtaining the group assignment information, and the means for rendering the particular audio streams are integrated in a headset device.

Example 82 includes the apparatus of Example 81, wherein the headset device corresponds to at least one of a virtual reality headset, a mixed reality headset, or an augmented reality headset.

Example 83 includes the apparatus of any of Examples 64 to 80, wherein the means for obtaining the set of audio streams, the means for obtaining the group assignment information, and the means for rendering the particular audio streams are integrated in at least one of a mobile phone, a tablet computer device, or a wearable electronic device.

Example 84 includes the apparatus of any of Examples 64 to 80, wherein the means for obtaining the set of audio streams, the means for obtaining the group assignment information, and the means for rendering the particular audio streams are integrated in a vehicle.

According to Example 85, a device includes one or more processors configured, during an audio encoding operation, to: obtain a set of audio streams associated with a set of audio sources; obtain group assignment information indicating that particular audio sources in the set of audio sources are assigned to a particular audio source group, the particular audio source group associated with a source spacing condition; and generate output data that includes the group assignment information and an encoded version of the set of audio streams.

Example 86 includes the device of Example 85, wherein the one or more processors are configured to determine a rendering mode for the particular audio source group and include an indication of the rendering mode in the output data.

Example 87 includes the device of Example 85 or Example 86, wherein the one or more processors are configured to select the rendering mode from multiple rendering modes that are supported by a decoder device.

Example 88 includes the device of Example 87, wherein the multiple rendering modes include a baseline rendering mode in which signal processing, source direction analysis, and source interpolation are performed in a frequency domain.

Example 89 includes the device of Example 87 or Example 88, wherein the multiple rendering modes include a low-complexity rendering mode in which distance-weighted time domain interpolation is performed.

Example 90 includes the device of any of Examples 85 to 89, wherein the one or more processors are configured to generate the group assignment information at least partially based on comparisons of one or more source spacing metrics to a threshold.

Example 91 includes the device of Example 90, wherein the one or more source spacing metrics include distances between the particular audio sources.

Example 92 includes the device of Example 90 or Example 91, wherein the one or more source spacing metrics include a source position density of the particular audio sources.

Example 93 includes the device of any of Examples 90 to 92, wherein the threshold includes a dynamic threshold.

Example 94 includes the device of Example 93, wherein the dynamic threshold is at least partially based a type of sound associated with the particular audio sources.

Example 95 includes the device of any of Examples 85 to 94, wherein the group assignment information is included in a metadata output of a first encoder and wherein the encoded version of the set of audio streams is included in a bitstream output of a second encoder.

Example 96 includes the device of Example 95, wherein the metadata output further includes the group assignment information.

Example 97 includes the device of Example 95 or Example 96, wherein the metadata output further includes an indication a rendering mode for the particular audio source group.

Example 98 includes the device of any of Examples 85 to 97 and further includes one or more microphones coupled to the one or more processors and configured to provide microphone data representing sound of at least one audio source of the set of audio sources.

Example 99 includes the device of any of Examples 85 to 98 and further includes a modem coupled to the one or more processors and configured to send the output data to a decoder device.

Example 100 includes the device of any of Examples 85 to 99, wherein the one or more processors are integrated in a headset device.

Example 101 includes the device of Example 100, wherein the headset device corresponds to at least one of a virtual reality headset, a mixed reality headset, or an augmented reality headset.

Example 102 includes the device of any of Examples 85 to 99, wherein the one or more processors are integrated in at least one of a mobile phone, a tablet computer device, a wearable electronic device, or a camera device.

Example 103 includes the device of any of Examples 85 to 99, wherein the one or more processors are integrated in a vehicle.

According to Example 104, a method comprising, during an audio encoding operation: obtaining, at a device, a set of audio streams associated with a set of audio sources; obtaining, at the device, group assignment information indicating that particular audio sources in the set of audio sources are assigned to a particular audio source group, the particular audio source group associated with a source spacing condition; and generating, at the device, output data that includes the group assignment information and an encoded version of the set of audio streams.

Example 105 includes the method of Example 104, further comprising determining a rendering mode for the particular audio source group and including an indication of the rendering mode in the output data.

Example 106 includes the method of Example 104 or Example 105, further comprising selecting the rendering mode from multiple rendering modes that are supported by a decoder device.

Example 107 includes the method of Example 106, wherein the multiple rendering modes include a baseline rendering mode in which signal processing, source direction analysis, and source interpolation are performed in a frequency domain.

Example 108 includes the method of Example 106 or Example 107, wherein the multiple rendering modes include a low-complexity rendering mode in which distance-weighted time domain interpolation is performed.

Example 109 includes the method of any of Examples 104 to 108 and further includes generating the group assignment information at least partially based on comparisons of one or more source spacing metrics to a threshold.

Example 110 includes the method of Example 109, wherein the one or more source spacing metrics include distances between the particular audio sources.

Example 111 includes the method of Example 109 or Example 110, wherein the one or more source spacing metrics include a source position density of the particular audio sources.

Example 112 includes the method of any of Examples 109 to 111, wherein the threshold includes a dynamic threshold.

Example 113 includes the method of Example 112, wherein the dynamic threshold is at least partially based a type of sound associated with the particular audio sources.

Example 114 includes the method of any of Examples 104 to 113, wherein the group assignment information is included in a metadata output of a first encoder and wherein the encoded version of the set of audio streams is included in a bitstream output of a second encoder.

Example 115 includes the method of Example 114, wherein the metadata output further includes the group assignment information.

Example 116 includes the method of any of Example 114 or Example 115, wherein the metadata output further includes an indication a rendering mode for the particular audio source group.

Example 117 includes the method of any of Examples 104 to 116 and further includes receiving, one or more microphones, microphone data representing sound of at least one audio source of the set of audio sources.

Example 118 includes the method of any of Examples 104 to 117 and further includes sending, via a modem, the output data to a decoder device.

Example 119 includes the method of any of Examples 104 to 118, wherein a headset device includes the device.

Example 120 includes the method of Example 119, wherein the headset device corresponds to at least one of a virtual reality headset, a mixed reality headset, or an augmented reality headset.

Example 121 includes the method of any of Examples 104 to 118, wherein the device is included in at least one of a mobile phone, a tablet computer device, a wearable electronic device, or a camera device.

Example 122 includes the method of any of Examples 104 to 118, wherein the device is included in a vehicle.

According to Example 123, a non-transitory computer-readable medium storing instructions that, when executed by one or more processors, cause the one or more processors to, during an audio encoding operation: obtain a set of audio streams associated with a set of audio sources; obtain group assignment information indicating that particular audio sources in the set of audio sources are assigned to a particular audio source group, the particular audio source group associated with a source spacing condition; and generate output data that includes the group assignment information and an encoded version of the set of audio streams.

Example 124 includes the non-transitory computer-readable medium of Example 123, wherein the instructions, when executed by the one or more processors, cause the one or more processors to determine a rendering mode for the particular audio source group and include an indication of the rendering mode in the output data.

Example 125 includes the non-transitory computer-readable medium of Example 123 or Example 124, wherein the instructions, when executed by the one or more processors, cause the one or more processors to select the rendering mode from multiple rendering modes that are supported by a decoder device.

Example 126 includes the non-transitory computer-readable medium of Example 125, wherein the multiple rendering modes include a baseline rendering mode in which signal processing, source direction analysis, and source interpolation are performed in a frequency domain.

Example 127 includes the non-transitory computer-readable medium of Example 125 or Example 126, wherein the multiple rendering modes include a low-complexity rendering mode in which distance-weighted time domain interpolation is performed.

Example 128 includes the non-transitory computer-readable medium of any of Examples 123 to 127, wherein the instructions, when executed by the one or more processors, cause the one or more processors to generate the group assignment information at least partially based on comparisons of one or more source spacing metrics to a threshold.

Example 129 includes the non-transitory computer-readable medium of Example 128, wherein the one or more source spacing metrics include distances between the particular audio sources.

Example 130 includes the non-transitory computer-readable medium of Example 128 or Example 129, wherein the one or more source spacing metrics include a source position density of the particular audio sources.

Example 131 includes the non-transitory computer-readable medium of any of Examples 128 to 130, wherein the threshold includes a dynamic threshold.

Example 132 includes the non-transitory computer-readable medium of Example 131, wherein the dynamic threshold is at least partially based a type of sound associated with the particular audio sources.

Example 133 includes the non-transitory computer-readable medium of any of Examples 123 to 132, wherein the group assignment information is included in a metadata output of a first encoder and wherein the encoded version of the set of audio streams is included in a bitstream output of a second encoder.

Example 134 includes the non-transitory computer-readable medium of Example 133, wherein the metadata output further includes the group assignment information.

Example 135 includes the non-transitory computer-readable medium of Example 133 or Example 134, wherein the metadata output further includes an indication a rendering mode for the particular audio source group.

Example 136 includes the non-transitory computer-readable medium of any of Examples 123 to 135, the instructions, when executed by the one or more processors, cause the one or more processors to receive, from one or more microphones, microphone data representing sound of at least one audio source of the set of audio sources.

Example 137 includes the non-transitory computer-readable medium of any of Examples 123 to 136, wherein the instructions, when executed by the one or more processors, cause the one or more processors to send, via a modem, the output data to a decoder device.

Example 138 includes the non-transitory computer-readable medium of any of Examples 123 to 137, wherein the one or more processors are integrated in a headset device.

Example 139 includes the non-transitory computer-readable medium of Example 138, wherein the headset device corresponds to at least one of a virtual reality headset, a mixed reality headset, or an augmented reality headset.

Example 140 includes the non-transitory computer-readable medium of any of Examples 123 to 137, wherein the one or more processors are integrated in at least one of a mobile phone, a tablet computer device, a wearable electronic device, or a camera device.

Example 141 includes the non-transitory computer-readable medium of any of Examples 123 to 137, wherein the one or more processors are integrated in a vehicle.

According to Example 142, an apparatus includes means for obtaining a set of audio streams associated with a set of audio sources; means for obtaining group assignment information indicating that particular audio sources in the set of audio sources are assigned to a particular audio source group, the particular audio source group associated with a source spacing condition; and means for generating output data that includes the group assignment information and an encoded version of the set of audio streams.

Example 143 includes the apparatus of Example 142, further comprising means for determining a rendering mode for the particular audio source group and including an indication of the rendering mode in the output data.

Example 144 includes the apparatus of Example 142 or Example 143, further comprising means for selecting the rendering mode from multiple rendering modes that are supported by a decoder device.

Example 145 includes the apparatus of Example 144, wherein the multiple rendering modes include a baseline rendering mode in which signal processing, source direction analysis, and source interpolation are performed in a frequency domain.

Example 146 includes the apparatus of Example 144 or Example 145, wherein the multiple rendering modes include a low-complexity rendering mode in which distance-weighted time domain interpolation is performed.

Example 147 includes the apparatus of any of Examples 142 to 146 and further includes means for generating the group assignment information at least partially based on comparisons of one or more source spacing metrics to a threshold.

Example 148 includes the apparatus of Example 147, wherein the one or more source spacing metrics include distances between the particular audio sources.

Example 149 includes the apparatus of Example 147 or Example 148, wherein the one or more source spacing metrics include a source position density of the particular audio sources.

Example 150 includes the apparatus of any of Examples 147 to 149, wherein the threshold includes a dynamic threshold.

Example 151 includes the apparatus of Example 150, wherein the dynamic threshold is at least partially based a type of sound associated with the particular audio sources.

Example 152 includes the apparatus of any of Examples 142 to 151, wherein the group assignment information is included in a metadata output of a first encoder and wherein the encoded version of the set of audio streams is included in a bitstream output of a second encoder.

Example 153 includes the apparatus of Example 152, wherein the metadata output further includes the group assignment information.

Example 154 includes the apparatus of Example 152 or Example 153, wherein the metadata output further includes an indication a rendering mode for the particular audio source group.

Example 155 includes the apparatus of any of Examples 142 to 154 and further includes means for receiving, from one or more microphones, microphone data representing sound of at least one audio source of the set of audio sources.

Example 156 includes the apparatus of any of Examples 142 to 155 and further includes means for sending the output data to a decoder device.

Example 157 includes the apparatus of any of Examples 142 to 156, wherein the means for obtaining the set of audio streams, the means for obtaining the group assignment information, and the means for generating the output data are integrated in a headset device.

Example 158 includes the apparatus of Example 157, wherein the headset device corresponds to at least one of a virtual reality headset, a mixed reality headset, or an augmented reality headset.

Example 159 includes the apparatus of any of Examples 142 to 156, wherein the means for obtaining the set of audio streams, the means for obtaining the group assignment information, and the means for generating the output data are integrated in at least one of a mobile phone, a tablet computer device, a wearable electronic device, or a camera device.

Example 160 includes the apparatus of any of Examples 142 to 156, wherein the means for obtaining the set of audio streams, the means for obtaining the group assignment information, and the means for generating the output data are integrated in a vehicle.

The foregoing techniques may be performed with respect to any number of different contexts and audio ecosystems. A number of example contexts are described below, although the techniques should not be limited to the example contexts. One example audio ecosystem may include audio content, movie studios, music studios, gaming audio studios, channel based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel based audio content (e.g., in 2.0, 5.1, and 7.1) such as by using a digital audio workstation (DAW). The music studios may output channel based audio content (e.g., in 2.0, and 5.1) such as by using a DAW. In either case, the coding engines may receive and encode the channel based audio content based on one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel based audio content for output by the delivery systems. Another example context in which the techniques may be performed includes an audio ecosystem that may include broadcast recording audio objects, professional audio systems, consumer on-device capture, ambisonics audio data format, on-device rendering, consumer audio, TV, and accessories, and car audio systems.

The broadcast recording audio objects, the professional audio systems, and the consumer on-device capture may all code their output using ambisonics audio format. In this way, the audio content may be coded using the ambisonics audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.).

Other examples of context in which the techniques may be performed include an audio ecosystem that may include acquisition elements, and playback elements. The acquisition elements may include wired and/or wireless acquisition devices (e.g., Eigen microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a sound field. For instance, the mobile device may acquire a sound field via the wired and/or wireless acquisition devices and/or the on-device surround sound capture (e.g., a plurality of microphones integrated into the mobile device). The mobile device may then code the acquired sound field into the ambisonics coefficients for playback by one or more of the playback elements. For instance, a user of the mobile device may record (acquire a sound field of) a live event (e.g., a meeting, a conference, a play, a concert, etc.), and code the recording into ambisonics coefficients.

The mobile device may also utilize one or more of the playback elements to playback the ambisonics coded sound field. For instance, the mobile device may decode the ambisonics coded sound field and output a signal to one or more of the playback elements that causes the one or more of the playback elements to recreate the sound field. As one example, the mobile device may utilize the wired and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a set of headphones, e.g., to create realistic binaural sound.

In some examples, a particular mobile device may both acquire a 3D sound field and playback the same 3D sound field at a later time. In some examples, the mobile device may acquire a 3D sound field, encode the 3D sound field into ambisonics, and transmit the encoded 3D sound field to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of ambisonics signals. For instance, the one or more DAWs may include ambisonics plugins and/or tools which may be configured to operate with (e.g., work with) one or more game audio systems. In some examples, the game studios may output new stem formats that support ambisonics audio data. In any case, the game studios may output coded audio content to the rendering engines which may render a sound field for playback by the delivery systems.

The techniques may also be performed with respect to exemplary audio acquisition devices. For example, the techniques may be performed with respect to an Eigen microphone which may include a plurality of microphones that are collectively configured to record a 3D sound field. In some examples, the plurality of microphones of the Eigen microphone may be located on the surface of a substantially spherical ball with a radius of approximately 4 cm.

Another exemplary audio acquisition context may include a production truck which may be configured to receive a signal from one or more microphones, such as one or more Eigen microphones. The production truck may also include an audio encoder.

The mobile device may also, in some instances, include a plurality of microphones that are collectively configured to record a 3D sound field. In other words, the plurality of microphones may have X, Y, Z diversity. In some examples, the mobile device may include a microphone which may be rotated to provide X, Y, Z diversity with respect to one or more other microphones of the mobile device. The mobile device may also include an audio encoder.

Example audio playback devices that may perform various aspects of the techniques described in this disclosure are further discussed below. In accordance with one or more techniques of this disclosure, speakers and/or sound bars may be arranged in any arbitrary configuration while still playing back a 3D sound field. Moreover, in some examples, headphone playback devices may be coupled to a decoder via either a wired or a wireless connection. In accordance with one or more techniques of this disclosure, a single generic representation of a sound field may be utilized to render the sound field on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a sound field may be utilized to render the sound field on any of the foregoing playback environments. Additionally, the techniques of this disclosure enable a renderer to render a sound field from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a renderer to compensate with the other 6 speakers such that playback may be achieved on a 6.1 speaker playback environment.

Moreover, a user may watch a sports game while wearing headphones. In accordance with one or more techniques of this disclosure, the 3D sound field of the sports game may be acquired (e.g., one or more Eigen microphones may be placed in and/or around the baseball stadium), HOA coefficients corresponding to the 3D sound field may be obtained and transmitted to a decoder, the decoder may reconstruct the 3D sound field based on the HOA coefficients and output the reconstructed 3D sound field to a renderer, the renderer may obtain an indication as to the type of playback environment (e.g., headphones), and render the reconstructed 3D sound field into signals that cause the headphones to output a representation of the 3D sound field of the sports game.

It should be noted that various functions performed by the one or more components of the systems and devices disclosed herein are described as being performed by certain components. This division of components is for illustration only. In an alternate implementation, a function performed by a particular component may be divided amongst multiple components. Moreover, in an alternate implementation, two or more components may be integrated into a single component or module. Each component may be implemented using hardware (e.g., a field-programmable gate array (FPGA) device, an application-specific integrated circuit (ASIC), a DSP, a controller, etc.), software (e.g., instructions executable by a processor), or any combination thereof.

Those of skill would further appreciate that the various illustrative logical blocks, configurations, circuits, and algorithm steps described in connection with the implementations disclosed herein may be implemented as electronic hardware, computer software executed by a processing device such as a hardware processor, or combinations of both. Various illustrative components, blocks, configurations, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary memory device is coupled to the processor such that the processor can read information from, and write information to, the memory device. In the alternative, the memory device may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A device comprising:
one or more processors configured, during an audio decoding operation, to:
obtain a set of audio streams associated with a set of audio sources;
obtain group assignment information indicating that particular audio sources in the set of audio sources are assigned to a particular audio source group, the particular audio source group associated with a source spacing condition; and
render, based on a rendering mode assigned to the particular audio source group, particular audio streams that are associated with the particular audio sources.

2. The device of claim 1, wherein at least one of the set of audio streams is received via a bitstream from an encoder device.

3. The device of claim 2, wherein the group assignment information is received via the bitstream.

4. The device of claim 3, wherein the one or more processors are configured to update the received group assignment information.

5. The device of claim 1, wherein the group assignment information is determined at least partially based on comparisons of one or more source spacing metrics to a threshold.

6. The device of claim 5, wherein the threshold includes a dynamic threshold.

7. The device of claim 1, wherein the rendering mode assigned to the particular audio source group is one of multiple rendering modes that are supported by the one or more processors.

8. The device of claim 7, wherein the multiple rendering modes include:
a baseline rendering mode in which signal processing, source direction analysis, and source interpolation are performed in a frequency domain; and
a low-complexity rendering mode in which distance-weighted time domain interpolation is performed.

9. The device of claim 1, wherein the one or more processors are further configured to combine a first rendered audio signal associated with the set of audio sources with a second rendered audio signal associated with a microphone input to generate a combined signal.

10. The device of claim 9, wherein the one or more processors are further configured to binauralize the combined signal to generate a binaural output signal, and further comprising one or more speakers coupled to the one or more processors and configured to play out the binaural output signal.

11. The device of claim 1, further comprising a modem coupled to the one or more processors, the modem configured to receive at least one audio stream of the set of audio streams via a bitstream from an encoder device.

12. The device of claim 1, wherein the one or more processors are integrated in a headset device.

13. The device of claim 1, wherein the one or more processors are integrated in at least one of a mobile phone, a tablet computer device, or a wearable electronic device.

14. The device of claim 1, wherein the one or more processors are integrated in a vehicle.

15. A method comprising, during an audio decoding operation:
obtaining, at a device, a set of audio streams associated with a set of audio sources;
obtaining, at the device, group assignment information indicating that particular audio sources in the set of audio sources are assigned to a particular audio source group, the particular audio source group associated with a source spacing condition; and
rendering, based on a rendering mode assigned to the particular audio source group, particular audio streams that are associated with the particular audio sources.

16. A device comprising:
one or more processors configured, during an audio encoding operation, to:
obtain a set of audio streams associated with a set of audio sources;
obtain group assignment information indicating that particular audio sources in the set of audio sources are assigned to a particular audio source group, the particular audio source group associated with a source spacing condition; and
generate output data that includes the group assignment information and an encoded version of the set of audio streams.

17. The device of claim 16, wherein the one or more processors are configured to determine a rendering mode for the particular audio source group and include an indication of the rendering mode in the output data.

18. The device of claim 17, wherein the one or more processors are configured to select the rendering mode from multiple rendering modes that are supported by a decoder device.

19. The device of claim 18, wherein the multiple rendering modes include a baseline rendering mode in which signal processing, source direction analysis, and source interpolation are performed in a frequency domain.

20. The device of claim 18, wherein the multiple rendering modes include a low-complexity rendering mode in which distance-weighted time domain interpolation is performed.

21. The device of claim 16, wherein the one or more processors are configured to generate the group assignment information at least partially based on comparisons of one or more source spacing metrics to a threshold.

22. The device of claim 21, wherein the threshold includes a dynamic threshold.

23. The device of claim 22, wherein the dynamic threshold is at least partially based a type of sound associated with the particular audio sources.

24. The device of claim 16, wherein the group assignment information is included in a metadata output of a first encoder and wherein the encoded version of the set of audio streams is included in a bitstream output of a second encoder.

25. The device of claim 16, further comprising one or more microphones coupled to the one or more processors and configured to provide microphone data representing sound of at least one audio source of the set of audio sources.

26. The device of claim 16, further comprising a modem coupled to the one or more processors and configured to send the output data to a decoder device.

27. The device of claim 16 wherein the one or more processors are integrated in a headset device.

28. The device of claim 16, wherein the one or more processors are integrated in at least one of a mobile phone, a tablet computer device, a wearable electronic device, or a camera device.

29. The device of claim 16, wherein the one or more processors are integrated in a vehicle.

30. A method comprising, during an audio encoding operation:
obtaining, at a device, a set of audio streams associated with a set of audio sources;
obtaining, at the device, group assignment information indicating that particular audio sources in the set of audio sources are assigned to a particular audio source group, the particular audio source group associated with a source spacing condition; and
generating, at the device, output data that includes the group assignment information and an encoded version of the set of audio streams.
